(19) United States
(12) Patent Application Publication
(10) Pub. No.: US 2013/0008354 A1
(43) Pub. Date: Jan. 10, 2013

(54) METHODS AND SYSTEMS OF BICARBONATE SOLUTION

(76) Inventors: BRENT R. CONSTANTZ, Portola Valley, CA (US); William Randall Seeker, San Clemente, CA (US); Kyle Self, San Jose, CA (US); Ryan J. Gilliam, San Jose, CA (US)

(21) Appl. No.: 13/347,061

(22) Filed: Jan. 10, 2012

Related U.S. Application Data
(60) Provisional application No. 61/433,641, filed on Jan. 18, 2011.

(51) Int. Cl. C25B 1/00; C04B 28/00; C04B 28/30; C25B 1/20; B01J 19/08

(52) U.S. Cl. 106/801; 422/186.04; 106/401; 106/638

(57) ABSTRACT

Provided herein are methods and systems to produce a bicarbonate solution from one or more of natural substances and to contact the bicarbonate solution with cathode electrolyte in an electrochemical system to produce a product containing carbonate or combination of carbonate and bicarbonate.

### CROSS REFERENCE TO RELATED APPLICATION

This application claims priority to U.S. Provisional Application No. 61/433,641, filed Jan. 18, 2011, which is incorporated herein by reference in its entirety.

### BACKGROUND OF THE INVENTION

In many chemical processes an alkaline solution is required to achieve a chemical reaction, e.g., to neutralize an acid, or buffer the pH of a solution, or precipitate an insoluble hydroxide and/or carbonate and/or bicarbonate from a solution. One method by which the alkaline solution may be produced is by an electrochemical system. In producing an alkaline solution electrochemically, a large amount of energy, salt and water may be used. Consequently, lowering the energy and material used in the electrochemical process may be desired.

### SUMMARY OF THE INVENTION

In one aspect, there is provided a method including contacting an anode with an anode electrolyte, contacting a cathode with a cathode electrolyte, contacting a bicarbonate solution with the cathode electrolyte, and applying a voltage across the anode and the cathode. In some embodiments, the method further includes producing the bicarbonate solution. In some embodiments, the bicarbonate solution is produced from subterranean brine. In some embodiments, the subterranean brine includes, but not limited to, bicarbonate brine, carbonate brine, alkaline brine, and combination thereof. In some embodiments, the bicarbonate solution is produced from an evaporite including bicarbonate, carbonate, or combination thereof. In some embodiments, the bicarbonate solution is further produced by mixing bicarbonate ions in freshwater, brine, or brackish water. In some embodiments, the bicarbonate solution is produced by contacting carbon dioxide with a carbonate brine. In some embodiments, the carbonate brine comprises trona brine. In some embodiments, the bicarbonate solution is produced by dissolving carbon dioxide into an alkaline brine. In some embodiments, the bicarbonate solution is produced by contacting the carbon dioxide with the alkaline brine in presence of a natural base. In some embodiments, the carbon dioxide is an industrial waste stream including, but not limited to, flue gas from combustion; a flue gas from a chemical processing plant; a flue gas from a plant that produces CO₂ as a byproduct; or combination thereof. In some embodiments, the natural base includes, but not limited to, mineral, microorganism, waste stream, coal ash, and combination thereof. In some embodiments, the bicarbonate solution is naturally occurring bicarbonate brine. In some embodiments, the bicarbonate solution is produced by reacting bicarbonate hard brine with sodium carbonate and separating out a carbonate precipitate from the bicarbonate hard brine.

In some embodiments, the cathode and the cathode electrolyte are inside a cathode chamber and the contacting of the bicarbonate solution with the cathode electrolyte is outside the cathode chamber. In some embodiments, the cathode and the cathode electrolyte are inside a cathode chamber and the contacting of the bicarbonate solution with the cathode electrolyte is inside the cathode chamber.

In some embodiments, the bicarbonate solution includes at least 1% w/w bicarbonate. In some embodiments, the bicarbonate solution includes between 1%-95% w/w bicarbonate.

In some embodiments, the method produces carbonate ions by contacting the bicarbonate solution with the cathode electrolyte. In some embodiments, the cathode electrolyte includes seawater, freshwater, brine, brackish water, sodium hydroxide, or combination thereof. In some embodiments, the cathode electrolyte includes less than 1% w/w divalent cations. In some embodiments, the divalent cations include, but not limited to, calcium, magnesium, and combination thereof. In some embodiments, the cathode electrolyte does not include carbon dioxide gas. In some embodiments, the anode electrolyte includes an acid. In some embodiments, the acid is hydrochloric acid or sulfuric acid. In some embodiments, an oxygen gas is not formed at the anode. In some embodiments, chlorine gas is not formed at the anode.

In some embodiments, the cathode electrolyte and the anode electrolyte are separated by an ion exchange membrane. In some embodiments, the ion exchange membrane is an anion exchange membrane or a cation exchange membrane.

In some embodiments, the cathode forms hydrogen gas and the hydrogen gas is directed from the cathode to the anode.

In some embodiments, the method further includes producing hydroxide ions at the cathode without forming a gas at the anode on applying the voltage across the anode and the cathode. In some embodiments, the method further includes producing hydroxide ions in the cathode electrolyte and hydrochloric acid or sulfuric acid in the anode electrolyte on applying the voltage across the anode and the cathode. In some embodiments, the method further includes producing carbonate in the cathode electrolyte by contacting the bicarbonate solution with the hydroxide ions in the cathode electrolyte.

In some embodiments, the voltage is between 0.05-1V across the anode and the cathode.

In some embodiments, the method further includes producing a pH difference of at least 4 pH units between the anode electrolyte and the cathode electrolyte. In some embodiments, the method further includes producing a pH difference of between 4-12 pH units between the anode electrolyte and the cathode electrolyte when a voltage of 0.05-1V is applied between the anode and the cathode.

In some embodiments, the method further includes treating bicarbonate and/or carbonate ions produced by contacting the bicarbonate solution with the cathode electrolyte with a divalent cation including, but not limited to, calcium, magnesium, and combination thereof. In some embodiments, the cathode and the cathode electrolyte are inside a cathode chamber and the anode and the anode electrolyte are inside an anode chamber. In some embodiments, the method further includes treating bicarbonate and/or carbonate ions with a divalent cation including, but not limited to, calcium, magnesium, and combination thereof wherein the treatment is outside the cathode chamber. In some embodiments, the method further includes treating bicarbonate and/or carbonate ions with a divalent cation including, but not limited to, calcium, magnesium, and combination thereof wherein the treatment is inside the cathode chamber.

In some embodiments, the method further includes disposing a third electrolyte between the anode electrolyte and the cathode electrolyte. In some embodiments, the third electrolyte is separated from the anode electrolyte by an anion exchange membrane. In some embodiments, the anion exchange membrane is permeable to chloride ions. In some embodiments, the third electrolyte is separated from the cathode electrolyte by a cation exchange membrane. In some embodiments, the cation exchange membrane is permeable to sodium ions. In some embodiments, the third electrolyte comprises sodium chloride.

In some embodiments, the method further includes migrating chloride ions to the anode electrolyte from the third electrolyte and migrating sodium ions to the cathode electrolyte from the third electrolyte upon application of the voltage between the anode and the cathode.

In some embodiments, the anode is a gas diffusion electrode.

In another aspect, there is provided a method including producing a bicarbonate solution from a subterranean brine, subsurface brine, or surface brine and treating the bicarbonate solution with an alkaline solution to produce a composition including carbonate or a combination of bicarbonate or carbonate. In some embodiments, the alkaline solution is a hydroxide obtained from an electrochemical cell. In some embodiments, the subterranean brine, subsurface brine, or surface brine includes, but not limited to, bicarbonate brine, carbonate brine, alkaline brine, and combination thereof.

In another aspect, there is provided a method including producing a bicarbonate solution from an evaporite and treating the bicarbonate solution with an alkaline solution to produce a composition including carbonate or a combination of bicarbonate or carbonate. In some embodiments, the evaporite is trona. In some embodiments, the alkaline solution is hydroxide obtained from an electrochemical cell.

In another aspect, there is provided a method including producing a bicarbonate solution by contacting carbon dioxide with a carbonate brine and treating the bicarbonate solution with an alkaline solution to produce a composition including carbonate or a combination of bicarbonate or carbonate. In some embodiments, the carbonate brine is trona. In some embodiments, the carbon dioxide is an industrial waste stream including, but not limited to, flue gas from combustion; a flue gas from a chemical processing plant; a flue gas from a plant that produces CO₂ as a byproduct; or combination thereof. In some embodiments, the alkaline solution is hydroxide obtained from an electrochemical cell.

In another aspect, there is provided a method including producing a bicarbonate solution by contacting carbon dioxide with an alkaline brine and treating the bicarbonate solution with an alkaline solution to produce a composition including carbonate or a combination of bicarbonate or carbonate. In some embodiments, the alkaline solution is hydroxide obtained from an electrochemical cell. In some embodiments, the carbon dioxide is an industrial waste stream including, but not limited to, flue gas from combustion; a flue gas from a chemical processing plant; a flue gas from a plant that produces CO₂ as a byproduct; or combination thereof.

In another aspect, there is provided a method including reacting bicarbonate hard brine with sodium carbonate to form a carbonate precipitate; separating the carbonate precipitate from the bicarbonate hard brine to give a bicarbonate solution; and treating the bicarbonate solution with an alkaline solution to produce a composition including carbonate or a combination of bicarbonate or carbonate. In some embodiments, the alkaline solution is hydroxide obtained from an electrochemical cell.

In another aspect, there is provided a method including contacting bicarbonate solution derived from one or more of natural substances with an alkaline solution to produce a product including carbonate or mixture of carbonate and bicarbonate.

In some embodiments, the product is a cement composition.

In some embodiments, the one or more of natural substances include, but are not limited to, naturally occurring brines including subterranean, subsurface and surface brines, crystalline shoreline or bottom crusts, shallow lake bottom crusts, surface efflorescence, minerals, solutions obtained after the mining of the ores, evaporite, and lakes.

In another aspect, there is provided a system including an anode electrolyte in contact with an anode; a cathode electrolyte in contact with a cathode; and a contact system operably connected to the cathode electrolyte configured to contact a bicarbonate solution with the cathode electrolyte. In another aspect, there is provided a system including a reactor system configured to produce a bicarbonate solution; a contact system operably connected to the reactor system configured to contact the bicarbonate solution with an alkaline solution; and a precipitator operably connected to the contact system configured to produce a carbonate or a combination of the carbonate and bicarbonate product from the bicarbonate solution.

In some embodiments, the system further includes a reactor system operably connected to the contact system configured to produce the bicarbonate solution. In some embodiments, the reactor system comprises a contactor configured to contact carbon dioxide with a carbonate brine to produce a bicarbonate solution.

In some embodiments, the cathode and the cathode electrolyte are inside a cathode chamber and the contact system is outside the cathode chamber. In some embodiments, the cathode and the cathode electrolyte are inside a cathode chamber and the contact system is inside the cathode chamber.

In some embodiments, the cathode electrolyte and the anode electrolyte are separated by an ion exchange membrane. In some embodiments, the ion exchange membrane is an anion exchange membrane or a cation exchange membrane. In some embodiments, the system is configured to direct hydrogen gas from the cathode to the anode. In some embodiments, the system comprises a duct that directs the hydrogen gas from the cathode to the anode.

In some embodiments, the system is configured to produce hydroxide ions at the cathode without forming a gas at the anode on applying a voltage across the anode and the cathode. In some embodiments, the system is configured to produce hydroxide ions in the cathode electrolyte and an acid in the anode electrolyte on applying a voltage across the anode and the cathode.

In some embodiments, the system further includes a device to apply a voltage across the anode and the cathode. In some embodiments, the voltage is between 0.05-1.5V.

In some embodiments, the system is configured to produce a pH difference of at least 4 pH units between the anode electrolyte and the cathode electrolyte. In some embodiments, the system is configured to produce a pH difference of between 4-12 pH units between the anode electrolyte and the cathode electrolyte when a voltage of 0.05-1V is applied between the anode and the cathode.

In some embodiments, the system is configured to produce carbonate ions by a reaction of the bicarbonate ions from the bicarbonate solution with sodium hydroxide from the cathode electrolyte.

In some embodiments, the system is configured to treat bicarbonate and/or carbonate ions with a divalent cation including, but not limited to, calcium, magnesium, and combination thereof.

In some embodiments, the system is a continuous flow operation.

In some embodiments, the contact system configured to contact the bicarbonate solution to the cathode electrolyte includes a duct that directs the bicarbonate solution to the cathode electrolyte.

In some embodiments, the system includes a third electrolyte disposed between the anode electrolyte and the cathode electrolyte. In some embodiments, the third electrolyte is separated from the anode electrolyte by an anion exchange membrane. In some embodiments, the anion exchange membrane is permeable to chloride ions. In some embodiments, the third electrolyte is separated from the cathode electrolyte by a cation exchange membrane. In some embodiments, the cation exchange membrane is permeable to sodium ions. In some embodiments, the third electrolyte includes sodium chloride.

In some embodiments, the system is configured to cause a migration of chloride ions to the anode electrolyte from the third electrolyte and to cause a migration of sodium ions to the cathode electrolyte from the third electrolyte upon application of a voltage between the anode and the cathode.

In some embodiments, the anode is a gas diffusion electrode.

### BRIEF DESCRIPTION OF THE DRAWINGS

The following drawings illustrate by way of examples and not by limitation some embodiments of the present system and method.

FIG. 1A is a flow chart of an embodiment of the invention.

FIG. 1B is a flow chart of an embodiment of the invention.

FIGS. 2A and 2B are an illustration of an embodiment of the invention.

FIGS. 3A and 3B are an illustration of an embodiment of the invention.

FIGS. 4A and 4B are an illustration of an embodiment of the invention.

FIGS. 5A and 5B are an illustration of an embodiment of the invention.

FIG. 6 is an illustration of an embodiment of the invention.

FIG. 7 is flow chart of an embodiment of the invention.

### DETAILED DESCRIPTION OF THE INVENTION

There are provided systems and methods for contacting a bicarbonate solution with an alkaline solution to produce carbonate and/or bicarbonate compositions. The bicarbonate solution may be derived from any natural substance. Various methods to produce bicarbonate solution are as described herein. In some embodiments, the alkaline solution is produced in an electrochemical cell. The electrochemical cell can be any electrochemical cell known in the art that produces an alkaline solution. Typically, an electrochemical cell comprises a cathode chamber comprising a cathode electrolyte and a cathode and an anode chamber comprising an anode electrolyte and an anode. As disclosed herein, on applying a voltage across the anode and the cathode, cations, e.g., sodium ions migrate to the cathode to produce an alkaline solution such as, sodium hydroxide. In some embodiments, upon reaction of the sodium hydroxide with the bicarbonate solution inside the cathode chamber or outside the cathode chamber, sodium carbonate and/or mixture of sodium carbonate and sodium bicarbonate is formed. In some embodiments, the electrochemical cell produces an alkaline solution in the cathode chamber and an acid, such as a hydrochloric acid or sulfuric acid in the anode chamber. Further, as described herein, hydrogen gas and hydroxide ions may be produced at the cathode, and in some embodiments, some or all of the hydrogen gas produced at the cathode may be directed to the anode where it may be oxidized to produce hydrogen ions. The anions in the anode electrolyte, e.g., chloride ions react with the hydrogen ions migrated from the anode to produce an acid, e.g., hydrochloric acid, sulfuric acid, etc. in the anode electrolyte. In some embodiments, a salt solution comprising, e.g., sodium chloride or sodium sulfate, is used as the anode electrolyte or the cathode electrolyte to produce the alkaline solution. In some embodiments, such salt solution is brine. The carbonate compositions produced by treating the bicarbonate solution with the hydroxide may be used to make cementitious compositions.

The methods and systems provided herein show surprising and unexpected results as the amount of alkaline solution required to convert the bicarbonate solution to the carbonate ions is less than the amount of alkaline solution required to convert carbonic acid to the carbonate ions, thereby reducing the energy consumption of the process. For example, the amount of alkaline solution required to remove one proton from the bicarbonate ion to form the carbonate ion is less than the amount of alkaline solution required to remove two protons from the carbonic acid to form the carbonate ion. Further, in some embodiments, the addition of the bicarbonate solution to the cathode electrolyte may reduce the pH of the cathode electrolyte thereby reducing the overall cell potential and the energy consumption of the process. Further, the acid produced can be utilized in various ways including dissolving materials, e.g., minerals and biomass.

Typically, Ordinary Portland Cement (OPC) is made primarily from limestone, certain clay minerals, and gypsum, in a high temperature process that drives off carbon dioxide and chemically combines the primary ingredients into new compounds. The energy required to fire the mixture consumes about 4 GJ per ton of cement produced. Because the carbon dioxide is generated by both the cement production process itself, as well as by energy plants that generate power to run the production process, cement production is a leading source of current carbon dioxide atmospheric emissions. In addition to the pollution problems associated with Portland cement production, the structures produced with Portland cements may have a repair and maintenance expense because of the instability of the cured product produced from Portland cement.

The methods and systems provided herein reduce the carbon foot print by using the bicarbonate solution to make the carbonate compositions. In some embodiments, the production of such compositions may not require an energy intensive process and thereby reduce the carbon dioxide atmospheric emissions. In some embodiments, the production of cement products from the compositions, as described herein, may not emit as much carbon dioxide or may not emit carbon dioxide at all, as is emitted by Portland cement and thereby reduce the overall carbon dioxide atmospheric emissions. In still further embodiments, the cement compositions provided herein may partially or completely replace the carbon emitting cements, such as OPC thereby reducing the carbon dioxide atmospheric emissions and the carbon foot print. The compositions provided herein may be mixed with OPC to give the cement material with equal or higher strength, thereby reducing the amount of OPC to make cement.

As can be appreciated by one ordinarily skilled in the art, since the present system and method can be configured with an alternative, equivalent salt solution, e.g., a potassium sulfate solution or a sodium sulfate solution, to produce an equivalent alkaline solution, e.g., potassium hydroxide and/or potassium carbonate and/or potassium bicarbonate or sodium hydroxide and/or sodium carbonate and/or sodium bicarbonate in the cathode electrolyte, and an equivalent acid, e.g., sulfuric acid in the anode electrolyte, by applying the voltage as disclosed herein across the anode and cathode. The invention is not limited to the exemplary embodiments described herein, but is adaptable for use with an equivalent salt solution, e.g., potassium sulfate or sodium sulfate, to produce an alkaline solution in the cathode electrolyte and an acid, e.g., sulfuric acid in the anode electrolyte. Accordingly, to the extent that such equivalents are based on or suggested by the present system and method, these equivalents are within the scope of the appended claims.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a,” “an,” and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### A. Methods and Systems of Bicarbonate Solution

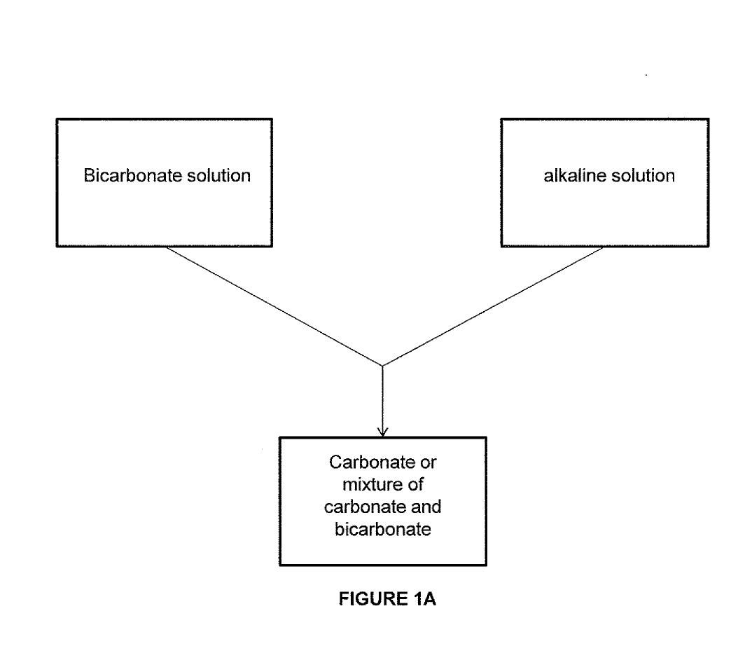

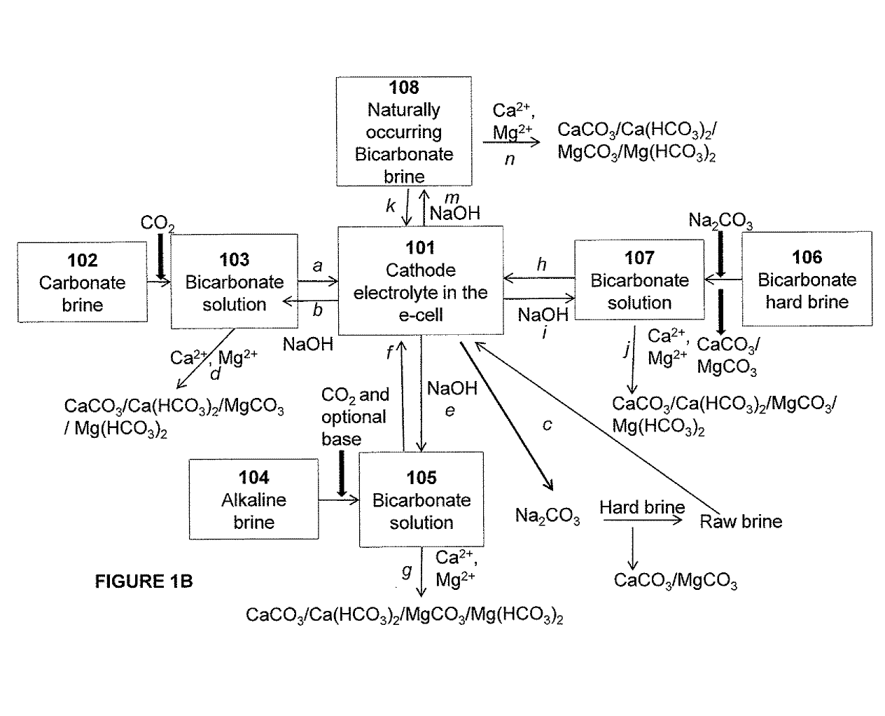

In one aspect, there is provided a method to contact bicarbonate solution with an alkaline solution to produce a product comprising carbonate or mixture of carbonate and bicarbonate. In some embodiments, the bicarbonate solution is derived from one or more natural substances. Accordingly, there is provided a method to contact bicarbonate solution derived from one or more of natural substances with an alkaline solution to produce a product comprising carbonate or mixture of carbonate and bicarbonate. As illustrated in FIG. 1A, the methods and systems provided herein include contacting the bicarbonate solution with an alkaline solution to produce carbonate or carbonate and bicarbonate solution or product. The systems provided herein are suitable for all the methods of the invention.

As used herein, the “bicarbonate solution” includes any bicarbonate solution derived from one or more natural substances. Examples of natural substances include, without limitation, naturally occurring brines including subterranean, subsurface and surface brines, crystalline shoreline or bottom crusts, shallow lake bottom crusts, surface efflorescence, minerals, solutions obtained after the mining of the ores, evaporite, and lakes. In some embodiments, the bicarbonate solution is derived from a naturally occurring brine, e.g., subterranean brine, subsurface brine, surface brine, or naturally occurring lake. In some embodiments, the bicarbonate solution is made from minerals where the minerals are crushed and dissolved in brine and optionally further processed. The minerals can be found under the surface, on the surface, or subsurface of the lakes. The bicarbonate solution can also be made from an evaporite. The bicarbonate solution may include other oxyanions of carbon in addition to bicarbonate (HCO₃⁻), such as, but not limited to, carbonic acid (H₂CO₃) and/or carbonate (CO₃²).

As used herein, the “alkaline solution” is any solution that possesses sufficient alkalinity or basicity to remove one or more protons from a proton-containing species in solution. The alkaline solution may be a synthetic or a naturally occurring base. Examples of base include, but not limited to, hydroxides, such as calcium hydroxide, sodium hydroxide, potassium hydroxide etc. In some embodiments, the base is obtained by an electrochemical process. Some examples of the electrochemical process are described herein. In some embodiments, the base is a naturally occurring base, mineral, microorganism, waste stream, coal ash, and combination thereof. Examples of the alkaline solution that may be used in the methods and systems of the invention include, but not limited to, organic bases, such as, formate, acetate, propionate, butyrate, and valerate, among others; and bacteria, among others. Examples of such microorganisms are fungi that produce alkaline protease (e.g., the deep-sea fungus Aspergillus ustus with an optimal pH of 9) and bacteria that create alkaline molecules (e.g., cyanobacteria such as Lyngbya sp. from the Atlin wetland in British Columbia, which increases pH from a byproduct of photosynthesis). In some embodiments, organisms are used to produce alkalinity, wherein the organisms (e.g., Bacillus pasteurii, which hydrolyzes urea to ammonia) metabolize a contaminant (e.g. urea) to produce alkaline solutions (e.g., ammonia, ammonium hydroxide). In addition, waste streams from various industrial processes may provide alkalinity. Such waste streams include, but are not limited to, mining wastes; fossil fuel burning ash (e.g., combustion ash such as fly ash, bottom ash, boiler slag); slag (e.g. iron slag, phosphorous slag); cement kiln waste; oil refinery/petrochemical refinery waste (e.g. oil field and methane seam brines); coal seam wastes (e.g. gas production brines and coal seam brine); paper processing waste; water softening waste brine (e.g., ion exchange effluent); silicon processing wastes; agricultural waste; metal finishing waste; high pH textile waste; and caustic sludge.

In some embodiments, the systems and methods provided herein include systems and methods to produce the bicarbonate solution. After the production of the bicarbonate solution by the methods and systems described herein, the bicarbonate solution may be contacted with the alkaline solution, such as, the cathode electrolyte, as described herein. The systems and methods to produce the bicarbonate solution, to optionally modify the bicarbonate solution and/or to store the bicarbonate solution, are as further described herein.

In some embodiments, the bicarbonate solution is derived from a subterranean brine. The subterranean brine that is employed in embodiments of the invention may be from any convenient subterranean brine source. “Subterranean brine” is employed in its conventional sense to include naturally occurring or anthropogenic saline compositions obtained from a geological location. The geological location of the subterranean brine may be found below ground (subterranean geological location). Examples of subterranean, subsurface and surface brines include, but not limited to, bicarbonate brine, carbonate brine, alkaline brine, and hard brine, such as, but not limited to, alkaline hard brine, carbonate hard brine, bicarbonate hard brine, or mixture thereof. Subterranean brines of the invention may be subterranean saline compositions and in some embodiments, may have circulated through crystal rocks and become enriched in substances leaching from the surrounding mineral. Saline composition includes an aqueous solution which has a salinity of 500 ppm total dissolved solids (TDS) or greater, 1,000 ppm total dissolved solids (TDS) or greater, 5,000 ppm total dissolved solids (TDS) or greater, 10,000 ppm total dissolved solids (TDS) or greater, such as 20,000 ppm TDS or greater and including 50,000 ppm TDS or greater or between 5,000 ppm to 100,000 ppm. Subterranean geological location includes a geological location which is located below ground level. The ground level includes a solid-fluid interface of the earth's surface, such as a solid-gas interface as found on dry land where dry land meets the earth's atmosphere, as well as a liquid-solid interface as found beneath a body of surface water (e.g., lack, ocean, stream, etc) where solid ground meets the body of water (where examples of this interface include lake beds, ocean floors, etc). As such, the subterranean location can be a location beneath land or a location beneath a body of water (e.g., oceanic ridge). For example, a subterranean location may be a deep geological aquifer or an underground well located in the sedimentary basins of a petroleum field, a subterranean metal ore, a geothermal field, or an oceanic ridge, among other underground locations.

In some embodiments, single brine may be employed or a mixture of two or more brines may be employed to produce the bicarbonate solution for the methods of the invention. A single brine includes a brine which has been obtained from a single, distinct geological location (e.g., underground well or a naturally occurring lake or deposit). A mixture of two or more brines includes mixing of two or more brines, where each brine is obtained from a distinct geological location or is a mixture of a synthetic brine (obtained by dissolving bicarbonate ions in fresh water or saline water) and a naturally occurring brine.

The subterranean geological location may be a location that is 100 m or deeper below ground level, or 200 m or deeper below ground level, or 300 m or deeper below ground level, or 400 m or deeper below ground level, or 500 m or deeper below ground level, or 600 m or deeper below ground level, or 700 m or deeper below ground level, or 800 m or deeper below ground level, or 900 m or deeper below ground level, or 1000 m or deeper below ground level, including 1500 m or deeper below ground level, 2000 m or deeper below ground level, 2500 m or deeper below ground level and 3000 m or deeper below ground level. In some embodiments, a subterranean location is a location that is between 100 m and 3500 m below ground level, such as between 200 m and 2500 m below ground level, such as between 200 m and 2000 m below ground level, such as between 200 m and 1500 m below ground level, such as between 200 m and 1000 m below ground level and including between 200 m and 800 m below ground level. Subterranean brines of the invention may include, but are not limited to, oil-field brines, basinal brines, basinal water, pore water, formation water, and deep sea hypersaline waters, among others.

In some embodiments of the methods and systems provided herein, the bicarbonate solution may contain bicarbonate in a concentration of 25 ppm or more; or 50 ppm or more; or 100 ppm or more; or 200 ppm or more; or 300 ppm or more; or 500 ppm or more; or 800 ppm or more; or 1000 ppm or more; or 1500 ppm or more; or 2000 ppm or more; or 3000 ppm or more; or 5000 ppm or more; or 8000 ppm or more; or 10,000 ppm or more; or 20,000 ppm or more; or 40,000 ppm or more; or 50,000 ppm or more; or 80,000 ppm or more; or 100,000 ppm or more; or 500,000 ppm or more; or 1,000,000 ppm or more; or between 25-1,000,000 ppm; or between 25-500,000 ppm; or between 25-100,000 ppm; or between 25-80,000 ppm; or between 25-50,000 ppm; or between 25-10,000 ppm; or between 25-5,000 ppm; or between 25-1,000 ppm; or between 25-500 ppm; or between 25-100 ppm; or between 50-1,000,000 ppm; or between 50-500,000 ppm; or between 50-100,000 ppm; or between 50-80,000 ppm; or between 50-50,000 ppm; or between 50-10,000 ppm; or between 50-5,000 ppm; or between 50-1,000 ppm; or between 50-500 ppm; or between 50-100 ppm; or between 100-1,000,000 ppm; or between 100-500,000 ppm; or between 100-100,000 ppm; or between 100-80,000 ppm; or between 100-50,000 ppm; or between 100-10,000 ppm; or between 100-5,000 ppm; or between 100-1,000 ppm; or between 100-500 ppm; or between 500-1,000,000 ppm; or between 500-500,000 ppm; or between 500-100,000 ppm; or between 500-80,000 ppm; or between 500-50,000 ppm; or between 500-10,000 ppm; or between 500-5,000 ppm; or between 500-1,000 ppm; or between 1000-1,000,000 ppm; or between 1000-500,000 ppm; or between 1000-100,000 ppm; or between 1000-80,000 ppm; or between 1000-50,000 ppm; or between 1000-10,000 ppm; or between 1000-5,000 ppm; or between 5000-1,000,000 ppm; or between 5000-500,000 ppm; or between 5000-100,000 ppm; or between 5000-80,000 ppm; or between 5000-50,000 ppm; or between 5000-10,000 ppm; or between 10,000-1,000,000 ppm; or between 10,000-500,000 ppm; or between 10,000-100,000 ppm; or between 10,000-80,000 ppm; or between 10,000-50,000 ppm; or between 50,000-1,000,000 ppm; or between 50,000-500,000 ppm; or between 50,000-100,000 ppm; or between 50,000-80,000 ppm; or between 100,000-1,000,000 ppm or between 100,000-500,000 ppm; or between 500,000-1,000,000 ppm.

In some embodiments of the methods and systems provided herein, the bicarbonate solution includes bicarbonate in a concentration of at least 1% w/w; or at least 2% w/w; or at least 3% w/w; or at least 4% w/w; or at least 5% w/w; or at least 6% w/w; or at least 8% w/w; or at least 10% w/w; or at least 20% w/w; or at least 30% w/w; or at least 40% w/w; or at least 50% w/w; or at least 75% w/w; or at least 90% w/w; or between 0.1%-95% w/w; or between 0.1%-90% w/w; or between 0.1%-80% w/w; or between 0.1%-70% w/w; or between 0.1%-60% w/w; or between 0.1%-50% w/w; or between 0.1%-40% w/w; or between 0.1%-30% w/w; or between 0.1%-20% w/w; or between 0.1%-10% w/w; or between 0.1%-5% w/w; or between 0.1%-3% w/w; or between 0.1%-2% w/w; or between 0.5%-95% w/w; or between 0.5%-90% w/w; or between 0.5%-80% w/w; or between 0.5%-70% w/w; or between 0.5%-60% w/w; or between 0.5%-50% w/w; or between 0.5%-40% w/w; or between 0.5%-30% w/w; or between 0.5%-20% w/w; or between 0.5%-10% w/w; or between 0.5%-5% w/w; or between 0.5%-3% w/w; or between 0.5%-2% w/w; or between 1%-95% w/w; or between 1%-90% w/w; or between 1%-80% w/w; or between 1%-70% w/w; or between 1%-60% w/w; or between 1%-50% w/w; or between 1%-40% w/w; or between 1%-30% w/w; or between 1%-20% w/w; or between 1%-10% w/w; or between 1%-5% w/w; or between 1%-3% w/w; or between 1%-2% w/w; or between 2%-95% w/w; or between 2%-90% w/w; or between 2%-80% w/w; or between 2%-70% w/w; or between 2%-60% w/w; or between 2%-50% w/w; or between 2%-40% w/w; or between 2%-30% w/w; or between 2%-20% w/w; or between 2%-10% w/w; or between 2%-5% w/w; or between 2%-3% w/w; or between 3%-95% w/w; or between 3%-90% w/w; or between 3%-80% w/w; or between 3%-70% w/w; or between 3%-60% w/w; or between 3%-50% w/w; or between 3%-40% w/w; or between 3%-30% w/w; or between 3%-20% w/w; or between 3%-10% w/w; or between 3%-5% w/w; or between 4%-95% w/w; or between 4%-90% w/w; or between 4%-80% w/w; or between 4%-70% w/w; or between 4%-60% w/w; or between 4%-50% w/w; or between 4%-40% w/w; or between 4%-30% w/w; or between 4%-20% w/w; or between 4%-10% w/w; or between 4%-5% w/w; or between 5%-95% w/w; or between 5%-90% w/w; or between 5%-80% w/w; or between 5%-70% w/w; or between 5%-60% w/w; or between 5%-50% w/w; or between 5%-40% w/w; or between 5%-30% w/w; or between 5%-20% w/w; or between 5%-10% w/w; or between 10%-95% w/w; or between 10%-90% w/w; or between 10%-80% w/w; or between 10%-70% w/w; or between 10%-60% w/w; or between 10%-50% w/w; or between 10%-40% w/w; or between 10%-30% w/w; or between 10%-20% w/w; or between 20%-95% w/w; or between 20%-90% w/w; or between 20%-80% w/w; or between 20%-70% w/w; or between 20%-60% w/w; or between 20%-50% w/w; or between 20%-40% w/w; or between 20%-30% w/w; or between 30%-95% w/w; or between 30%-90% w/w; or between 30%-80% w/w; or between 30%-70% w/w; or between 30%-60% w/w; or between 30%-50% w/w; or between 30%-40% w/w; or between 40%-95% w/w; or between 40%-90% w/w; or between 40%-80% w/w; or between 40%-70% w/w; or between 40%-60% w/w; or between 40%-50% w/w; or between 50%-95% w/w; or between 50%-90% w/w; or between 50%-80% w/w; or between 50%-70% w/w; or between 50%-60% w/w; or between 60%-95% w/w; or between 60%-90% w/w; or between 60%-80% w/w; or between 60%-70% w/w; or between 70%-95% w/w; or between 70%-90% w/w; or between 70%-80% w/w; or between 80%-95% w/w; or between 80%-90% w/w; or between 90%-95% w/w; or 1% w/w; or 2% w/w; or 3% w/w; or 4% w/w; or 5% w/w; or 6% w/w; or 8% w/w; or 10% w/w; or 20% w/w; or 30% w/w; or 40% w/w; or 50% w/w; or 75% w/w; or 90% w/w.

The concentration recited herein may also be in w/v or v/v ratios.

In some embodiments, the amount of bicarbonate recited above is present in the subterranean brine. In some embodiments, the amount of bicarbonate recited above is present in the ore above ground. In some embodiments, the amount of bicarbonate recited above is present in the underground ore. In some embodiments, the amount of bicarbonate recited above is present in the brine extracted from the ore to form the bicarbonate solution. In some embodiments, the amount of bicarbonate recited above is present in the brine after the processing of the ore. Some of the examples of the methods of processing are as described herein. In some embodiments, the amount of bicarbonate recited above is present in the bicarbonate solution produced in accordance with the embodiments of the invention. In some embodiments, the amount of bicarbonate recited above is present in the bicarbonate solution that is contacted with the alkaline solution, such as, cathode electrolyte.

Deposits of sodium carbonate/bicarbonate may be found in countries like United States, China, Botswana, Uganda, Kenya, Mexico, Peru, India, Egypt, South Africa and Turkey. It may be found both as extensive beds of sodium minerals and as sodium-rich waters (brines). The bicarbonate brines may include carbonate ions such that they may be called carbonate brines. Such carbonate brines have been described in U.S. Provisional Patent Application No. 61/371,620, filed 6 Aug. 2010, titled “Calcium carbonate compositions and methods thereof,” which is incorporated herein by reference in its entirety.

The origin of sodium carbonate and/or sodium bicarbonate in natural deposits can be due to various reasons, including (a) evaporation of sodium carbonate and/or sodium bicarbonate-rich thermal spring water; (b) carbonation of sodium sulfide to sodium carbonate and/or sodium bicarbonate; (c) ion-exchange in sodium bearing soils; (d) concentration dependent and temperature dependent equilibrium relationships among carbon dioxide and carbonate that converts carbonate solutions to sodium bicarbonate, or carbon dioxide removed from sodium bicarbonate solutions to form carbonates; and (e) leaching of alkaline carbonatites or basic ultra-basics rocks. The sodium may have been derived from the leaching of sodic feldspars or volcanic ash deposits, and the carbon dioxide may have been derived from the atmosphere. The groundwaters in metamorphic or igneous terrains produce alkaline solutions on evaporation. The absence of chloride and sulfate in these rocks permits solutions to become predominantly sodium and carbon dioxide bearing. The chemical fractionation of inflowing waters and brines within closed depositional basins can produce different minerals accumulating in separate areas.

Some types of carbonate and/or sodium bicarbonate bearing minerals that can be used to make bicarbonate brines are illustrated in Table I.

TABLE I

| Mineral name | Chemical composition | Na₂CO₃ %* |
|---|---|---|
| Thermonatrite | Na₂CO₃•H₂O | 85.5 |
| Wegscheiderite | Na₂CO₃•3NaHCO₃ | 74.0 |
| Trona (sesquicarbonate) | Na₂CO₃•NaHCO₃•2H₂O | 70.4 |
| Nahcolite | NaHCO₃ | 63.1 |
| Bradleyite | Na₂PO₄•MgCO₃ | 47.1 |
| Pirssonite | Na₂CO₃•CaCO₃•2H₂O | 43.8 |
| Tychite | 2MgCO₃•2Na₂CO₃•Na₂SO₄ | 42.6 |
| Northupite | Na₂CO₃•NaCl•MgCO₃ | 40.6 |
| Natron (washing soda) | Na₂CO₃•10H₂O | 37.1 |
| Dawsonite | NaAl(CO₃)(OH)₂ | 35.8 |
| Gaylussite | Na₂CO₃•CaCO₃•5H₂O | 35.8 |
| Shortite | Na₂CO₃•2CaCO₃ | 34.6 |
| Burkeite | Na₂CO₃•2Na₂SO₄ | 27.2 |
| Hanskite | 2Na₂CO₃•9Na₂SO₄•KCl | 13.6 |

*Includes bicarbonate converted to carbonate

It is to be understood that the carbonate and/or bicarbonate bearing minerals illustrated in Table I are for illustrative purposes only and that other carbonate and/or bicarbonate bearing minerals known in the art, are well within the scope of the invention. The carbonate and/or bicarbonate minerals illustrated in Table I may be present in separate deposits or may be present in the same deposit. Carbonate and/or bicarbonate brines useful to produce the bicarbonate solution used in the methods and systems of the invention, can be obtained from, for example, trona deposits located in Utah, California (such as, Searles Lake and Owens Lake); Green river formation in Wyoming; Colorado; and Railroad valley in Nevada; shallow-water limestones and dolostones of the Conococheague Limestone (Upper Cambrian) of western Maryland; lakes located in East African Rift Valley (e.g., Lake Bogoria, Lake Natron and Lake Magadi); lake Chad basin in Africa; lakes located in Libyan Desert in Egypt (Wadi Natrun system); and lakes located in central Asia (from south-east Siberia to north-east China) such as, Wucheng basin and Biyang basin in Henan province of China; Sambhar lake and Lonar lake in India; and Zabuye Caka, Bangkog Cuo, and Guogaling Cuo in Tibet. The carbonate and/or bicarbonate minerals include, but are not limited to, trona, minor nahcolite, and trace amounts of pirssonite and thermonatrite.

Some forms of carbonate and/or bicarbonate brines include, but are not limited to, buried, surface or subsurface brines, crystalline shoreline or bottom crusts, shallow lake bottom crusts, and surface efflorescence.

Trona and dolomite are associated throughout the trona zone. Calcite, zeolites, feldspar, and clay minerals are the typical minerals found within the associated rocks of the trona deposit. The trona crystals, which are generally white and/or gray due to impurities, occur in massive units and as disseminated crystals in claystone and shale. Crude trona (“trona ore”) may comprise 80-95% of sodium sesquicarbonate (Na₂CO₃.NaHCO₃.2H₂O) and, in lesser amounts, sodium chloride (NaCl), sodium sulfate (Na₂SO₄), organic matter, and insolubles such as clay and shales. In Wyoming, these deposits are located in 25 separate identified beds or zones ranging from 800 to 2800 feet below the earth's surface and are typically extracted by conventional mining techniques, such as, the room and pillar and longwall methods.

The ores may require processing in order to recover the carbonate and/or bicarbonate brines or the bicarbonate solution. Typically, most of the sodium carbonate from the Green River deposits is produced from the conventionally mined trona ore via the sesquicarbonate process or the monohydrate process. Both processes may use the same procedure but in different sequences. The “monohydrate” process involves crushing and screening the bulk trona ore which, as noted above, contains both sodium carbonate (Na₂CO₃) and sodium bicarbonate (NaHCO₃) as well as impurities such as silicates and organic matter. After the ore is screened, it may be calcined (i.e., heated) at temperatures greater than 150° C. to convert sodium bicarbonate to sodium carbonate. In some embodiments, the ore may not be calcined and the bicarbonate brine may be prepared from the ore. The crude soda ash may be dissolved in recycled liquor which may be then clarified and filtered to remove the insoluble solids. The liquor may be carbon treated to remove dissolved organic matter which may cause foaming and color problems in the final product, and may be again filtered to remove entrained carbon before going to a monohydrate crystallizer unit. This unit has a high temperature evaporator system generally having one or more effects (evaporators), where sodium carbonate monohydrate may be crystallized. The resulting slurry may then be centrifuged, and the separated monohydrate crystals may be sent to dryers to produce soda ash. The soluble impurities may be recycled with the centrate to the crystallizer where they may be further concentrated.

In some embodiments, the underground ore may be subjected to solution mining where water is injected (or an aqueous solution) into a deposit of soluble ore, the solution may be allowed to dissolve as much ore as possible, and the solution may be pumped to the surface. The solution may be evaporated to produce brines with higher alkalinity or higher concentration of carbonate and/or bicarbonate ions. Bulk trona (sodium sesquicarbonate), for example, may be dissolved above ground in an aqueous solvent at high temperatures which may be difficult to achieve underground. This may allow for a higher concentration to be achieved. After purification, these liquors may be cooled to recrystallize the carbonate or sesquicarbonate, which may be then calcined and converted to soda ash.

In some embodiments, the tailings and the spent solutions, obtained after the mining of the carbonate ores, may be used as carbonate and/or bicarbonate brines in the systems and methods of the present invention.

In some embodiments, the carbonate and/or bicarbonate brines of the invention are brine-bearing-evaporate or evaporite horizons in the lake. A system of wells (injection and production) and pipelines may be used to produce brine from the horizons. In some embodiments, an effluent may be injected into the evaporite horizon to manufacture brine by solution mining. In some embodiments, the carbonate and/or bicarbonate brines of the invention are made from the evaporite deposits exposed at the surface. For example, at Owens lake, Trona is exposed at the surface and is selectively mined with an excavator, stockpiled adjacent to the area of excavation, and later spread out on the surface to air dry.

Large deposits of lithium carbonate are found in Chile in Salar de Atacama in the Andes Mountains and in Antofagasta. In the United States, the lithium carbonate brines are in Nevada. There is also a lithium carbonate plant in Argentina on the Salar del Hombre Muerto. Other countries with deposits of lithium carbonate brines include China, Russia, Australia, Canada, and Zimbabwe. In some embodiments, one or more of the elements from the carbonate/bicarbonate brines are removed before using the carbonate/bicarbonate brines for the systems and methods of this invention. The one or more elements that may be removed before using the carbonate/bicarbonate brines include, but are not limited to, lithium, borate, iron, etc. These one or more elements may be used for other industrial applications. For example, the lithium carbonate brines may be pumped from the salt mine and may be evaporated in large shallow pools, where a sequential crystallization of the salts may be started. Since the brines of chlorides may be saturated with sodium chloride, the first salt to be precipitated may be halite, or if sulfates are present, halite and hydrated calcium sulfate. The precipitation may continue with silvinite (KClNaCl) and afterward silvite (KCl). The latter may be a product for industrial use so that toward the end of the precipitation of the silvite, the brine may be transferred to another pool and the precipitated salt thereof may be recovered for obtaining potassium chloride by differential floatation. After the precipitation, crystallization of carnalite (KClMgCl₂.6H₂O) and then bishoffite (MgCl₂.6H₂O) may take place. In this stage, the lithium may be increased to about 4.5-5.5%, with a magnesium content of about 4%. At that point, lithium carnalite (LiClMgCl₂.6H₂O) may get precipitated.

Other carbonate/bicarbonate brines include soda lakes, such as, mono lake, big soda lake, and soap lake. Mono Lake is situated on the eastern slope of the Sierra Nevada mountain range in California. It is a saline lake (˜90 g/l) with a pH around 10. Calcium carbonate is the principal precipitate and causes the formation of tufa towers which reach a height of almost one meter above the water. In addition to carbonate, mono lake also contains phosphate, sulfate and other ions, such as, arsenic and selenium. Soap Lake is another soda lake situated in central Washington State (USA), with increasing salinity and alkalinity. Characteristic of this lake are its sharp stratification and its high sulfide concentration (200 mM) in the monimolimnion, i.e., the bottom layer of the lake. The salinity goes from 15 g/l in the mixolimnion, i.e., the top layer of the lake, to 140 g/l in the monimolimnion and the pH is round 10.

In one aspect, there is provide a method to produce bicarbonate solution by the methods described herein and treat the bicarbonate solution with an alkaline solution to produce carbonate or carbonate and bicarbonate solution or product. In one aspect, there is provided a system including a reactor system configured to produce bicarbonate solution and a precipitator configured to produce a carbonate product from the bicarbonate solution. In one aspect, there is provided a system including a reactor system configured to produce bicarbonate solution; a contact system configured to contact the bicarbonate solution with an alkaline solution, and a precipitator configured to produce a carbonate product from the bicarbonate solution. In one aspect, there is provided a system including a contact system configured to contact the bicarbonate solution with an alkaline solution, and a precipitator configured to produce a carbonate product from the bicarbonate solution. In one aspect, there is provided a system including a reactor system configured to produce a bicarbonate solution; a contact system operably connected to the reactor system configured to contact the bicarbonate solution with an alkaline solution; and a precipitator operably connected to the contact system configured to produce a carbonate or a combination of the carbonate and bicarbonate product from the bicarbonate solution.

The reactor system may be any means suitable to produce the bicarbonate solution from suitable reagents. The reactor may be configured to include any number of different elements, such as gas mixer/gas absorber, gas/liquid contactor, temperature regulators (e.g., configured to heat the solution to a desired temperature), chemical additive elements, e.g., for introducing chemical pH elevating agents (such as natural bases) into the water, etc to produce the bicarbonate solution in accordance with the methods and systems of the invention. This reactor may operate as a batch process or a continuous process. The contact system and the precipitator are as described herein.

The contact system may be any means suitable to contact the bicarbonate solution with the alkaline solution. Examples of contact system configured to contact the bicarbonate solution with an alkaline solution include, but not limited to, duct, pipe, tank, or a conduit, or the like that directs the bicarbonate solution to the alkaline solution or vice versa. The contact system for contacting the bicarbonate solution with the alkaline solution may be equipped with inputs for other reagents for controlling the pH, stirrers, temperature sensor, and the like.

The precipitator may be any means suitable to produce the carbonate or the combination of the carbonate and bicarbonate product from the bicarbonate solution. Examples of precipitator include, but not limited to, duct, pipe, tank, or a conduit, or the like that produces the carbonate product or the combination of the carbonate and the bicarbonate product from the bicarbonate solution. The precipitator to produce the carbonate or the combination of the carbonate and bicarbonate product from the bicarbonate solution may be equipped with inputs for other reagents for controlling the pH, stirrers, temperature sensor, and the like.

FIG. 1B illustrates a flow chart for some embodiments of the methods and systems related to the production of the bicarbonate solution. In some embodiments, there is provided a method that includes producing a bicarbonate solution by contacting carbon dioxide with carbonate brine and treating the bicarbonate solution with an alkaline solution to produce a composition comprising carbonate or a combination of bicarbonate or carbonate. As illustrated in FIG. 1B, in some embodiments, the bicarbonate brine 103 may be produced from carbonate brine 102 by dissolving CO₂ into the carbonate brine 102. The reaction may be represented by the following equation:

CO₃²⁻+H₂O+CO₂=2HCO₃⁻

In some embodiments, there is provided a system configured to produce the bicarbonate solution and then treat the bicarbonate solution with the alkaline solution to form carbonate or carbonate and bicarbonate product. In some embodiments, the systems provided herein include a reactor system that includes a contactor configured to produce the bicarbonate solution by contacting the carbon dioxide with the carbonate brine. The carbon dioxide may be absorbed into the carbonate brine utilizing a gas mixer/gas absorber described in U.S. Patent Application Publication No. US 2010-0230293, filed on Jul. 15, 2009, titled, “CO₂ Utilization In Electrochemical Systems,” herein incorporated by reference in its entirety. In some embodiments, the gas mixer/gas absorber comprises a series of spray nozzles that produces a flat sheet or curtain of liquid into which the gas is absorbed; in another embodiment, the gas mixer/gas absorber comprises a spray absorber that creates a mist and into which the gas is absorbed; in other embodiments, other commercially available gas/liquid absorber, e.g., an absorber available from Neumann Systems, Colorado, USA is used. In some embodiments, the reactor system is operatively connected to a carbon dioxide gas/liquid contactor configured to dissolve carbon dioxide in the carbonate brine when the bicarbonate solution is produced which is further operatively contacted with an alkaline solution, such as hydroxide generated in the cathode electrolyte of the electrochemical cell.

In some embodiments, the alkalinity of the carbonate brine may not be sufficient to dissolve the CO₂ and a base may be added to increase the alkalinity. In some embodiments, the other base is a natural base. Such natural bases are well known in the art and include, without limitation, mineral, microorganism, waste stream, coal ash, and combination thereof. Examples of the bases that may be used in the methods and systems of the invention include, but not limited to, organic bases, such as, formate, acetate, propionate, butyrate, and valerate, among others; and bacteria, among others. Examples of such microorganisms are fungi that produce alkaline protease (e.g., the deep-sea fungus Aspergillus ustus with an optimal pH of 9) and bacteria that create alkaline molecules (e.g., cyanobacteria such as Lyngbya sp. from the Atlin wetland in British Columbia, which increases pH from a byproduct of photosynthesis). In some embodiments, organisms are used to produce alkalinity, wherein the organisms (e.g., Bacillus pasteurii, which hydrolyzes urea to ammonia) metabolize a contaminant (e.g. urea) to produce alkaline solutions (e.g., ammonia, ammonium hydroxide). In addition, waste streams from various industrial processes may provide alkalinity. Such waste streams include, but are not limited to, mining wastes; fossil fuel burning ash (e.g., combustion ash such as fly ash, bottom ash, boiler slag); slag (e.g. iron slag, phosphorous slag); cement kiln waste; oil refinery/petrochemical refinery waste (e.g. oil field and methane seam brines); coal seam wastes (e.g. gas production brines and coal seam brine); paper processing waste; water softening waste brine (e.g., ion exchange effluent); silicon processing wastes; agricultural waste; metal finishing waste; high pH textile waste; and caustic sludge.

The carbon dioxide used in the system may be obtained from various industrial sources that release carbon dioxide including carbon dioxide from combustion gases of fossil fuelled power plants, e.g., conventional coal, oil and gas power plants, or IGCC (Integrated Gasification Combined Cycle) power plants that generate power by burning sygas; cement manufacturing plants that convert limestone to lime; ore processing plants; fermentation plants; and the like. In some embodiments, the carbon dioxide is an industrial waste stream including, but not limited to, flue gas from combustion; a flue gas from a chemical processing plant; a flue gas from a plant that produces CO₂ as a byproduct; or combination thereof. In some embodiments, the carbon dioxide may comprise other gases, e.g., nitrogen, oxides of nitrogen (nitrous oxide, nitric oxide), sulfur and sulfur gases (sulfur dioxide, hydrogen sulfide), and vaporized materials. In some embodiments, the system includes a gas treatment system that removes constituents in the carbon dioxide gas stream before the gas is utilized in the contactor.

Examples of the carbonate brines have been provided above. The amount of carbonates present in the brines of the invention may vary. In some instances, the amount of carbonate present ranges from 50 to 100,000 ppm; or alternatively 100 to 75,000 ppm; or alternatively 500 to 50,000 ppm; or alternatively 1000 to 25,000 ppm.

As such, in certain embodiments, the carbonate present in the carbonate brines may comprise 5% by wt or more of carbonates; or 10% by wt or more of carbonates; or 15% by wt or more of carbonates; or 20% by wt or more of carbonates; or 30% by wt or more of carbonates; or 40% by wt or more of carbonates; or 50% by wt or more of carbonates; or 60% by wt or more of carbonates; or 70% by wt or more of carbonates; or 80% by wt or more of carbonates; or 90% by wt or more of carbonates; or 99% by wt or more of carbonates; or 5-99% by wt of carbonates; or 5-95% by wt of carbonates; or 5-80% by wt of carbonates; or 5-75% by wt of carbonates; or 5-70% by wt of carbonates; or 5-60% by wt of carbonates; or 5-50% by wt of carbonates; or 5-40% by wt of carbonates; or 5-30% by wt of carbonates; or 5-20% by wt of carbonates; or 5-10% by wt of carbonates; or 10-80% by wt of carbonates; or 10-50% by wt of carbonates; or 10-20% by wt of carbonates; or 20-80% by wt of carbonates; or 20-50% by wt of carbonates; or 30-75% by wt of carbonates; or 30-50% by wt of carbonates; or 40-80% by wt of carbonates; or 50-75% by wt of carbonates; or 50-90% by wt of carbonates; or 60-80% by wt of carbonates; or 60-95% by wt of carbonates; or 70-90% by wt of carbonates; or 80-90% by wt of carbonates; or 5% by wt of carbonates; or 10% by wt of carbonates or 20% by wt of carbonates; or 25% by wt of carbonates; or 30% by wt of carbonates; or 40% by wt of carbonates; or 50% by wt of carbonates; or 60% by wt of carbonates; or 70% by wt of carbonates; or 80% by wt of carbonates; or 90% by wt of carbonates.

It is to be understood that the alkaline solution that is contacted with the bicarbonate solution is illustrated as the cathode electrolyte from the electrochemical cell for illustration purposes only (in figures) and other alkaline solutions as exemplified herein may also be used for the process and the systems. As illustrated in FIG. 1B, in some embodiments, the bicarbonate solution 103 is contacted with the cathode electrolyte outside the cathode chamber (path b) and/or inside the cathode chamber (path a). For the contact of the bicarbonate solution inside the cathode chamber, the bicarbonate solution may be added to the cathode chamber. For the contact of the bicarbonate solution outside the cathode chamber, the cathode electrolyte may be removed or extracted from the cathode chamber and is contacted with the bicarbonate solution outside the cathode chamber. In some embodiments, the bicarbonate solution 103 is contacted with the cathode electrolyte 101 inside the cathode chamber (path a) when bicarbonate converts to carbonate and can be withdrawn from the cathode electrolyte as sodium carbonate (path c). In some embodiments, the bicarbonate solution 103 is contacted with the cathode electrolyte outside the cathode chamber where the sodium hydroxide from the cathode electrolyte is added to the bicarbonate solution (path b) when bicarbonate converts to carbonate. The carbonate solution then is treated with divalent cations, such as calcium, magnesium, or combination thereof, to form carbonate compositions (path d), such as, CaCO₃/Ca(HCO₃)₂/MgCO₃/Mg(HCO₃)₂/calcium magnesium carbonate. In some embodiments, the bicarbonate solution 103 is added to the cathode electrolyte 101 and the solution is withdrawn from the cathode electrolyte that includes sodium carbonate, sodium bicarbonate, and sodium hydroxide. This withdrawn solution may be circulated back to the cathode electrolyte until the bicarbonate fully converts to the carbonate. In some embodiments, the solution withdrawn from the cathode electrolyte (containing sodium carbonate, sodium bicarbonate, and sodium hydroxide) is circulated back to the bicarbonate solution before being sent to the cathode electrolyte inside the cathode chamber (not shown in FIG. 1B).

In some embodiments, there is provided a method that includes producing a bicarbonate solution by contacting carbon dioxide with an alkaline brine and treating the bicarbonate solution with an alkaline solution to produce a composition comprising carbonate or a combination of bicarbonate or carbonate. As illustrated in FIG. 1B, in some embodiments, the bicarbonate solution is produced from an alkaline brine 104 by reacting the alkaline brine with CO₂. Such reaction of the alkaline brine with CO₂ can be conducted in the gas/liquid contactor as described above. As used herein, the “alkaline brine” is any brine that possesses sufficient alkalinity or basicity to remove one or more protons from a proton-containing species in solution. The alkalinity of the alkaline brine may be sufficient to dissolve the CO₂ into the solution and generate bicarbonate solution. Some of the examples of alkaline brine include, but are not limited to, soda lakes having a pH of above 10 or 11 found in tropical or subtropical rain-shadow deserts in North America, interiors of Asia, and techtonic rifting areas in East African Rift Valley. In some embodiments, the carbonate brines may also act as alkaline brines. For example, Searles Lake in California includes carbonates and borates that add alkalinity to the brine. In some instances, the alkaline brine has a pH that is above neutral pH (i.e., pH>7), e.g., the brine has a pH ranging from 7.1 to 12, such as 8 to 12, such as 8 to 11, and including 9 to 11. In some embodiments, while being basic the pH of the alkaline brine may be insufficient to cause dissolution of the CO₂ into the solution. For example, the pH of the brine may be 9.5 or lower, such as 9.3 or lower, including 9 or lower. In such embodiments, a natural base may be added to the alkaline brine. Such natural bases are well known in the art and are as described above.

In some embodiments, alkaline brines may also be alkaline hard brines and include divalent cations, such as calcium and/or magnesium. Some examples of the soda lakes and soda deserts, typically exhibiting pH values of >11.5 and may contain divalent cations, are illustrated in Table II below. One of the largest fossil soda lakes is the Green River Formation in Wyoming and Utah. The lakes illustrated in Table II below also have large amounts of carbonate/bicarbonates deposits.

TABLE II

| Continent | Country | Location |
|---|---|---|
| Africa | Libya | Lake Fezzan |
| | Egypt | Wadi Natrum |
| | Ethiopia | Lake Aranguadi, Lake Kilotes, Lake Abiata, Lake |
| | | Shala, Lake Chilu, Lake Hertale, Lake Metahara |
| | Sudan | Dariba Lake |
| | Kenya | Lake Bogoria, Lake Nakuru, Lake Elmenteita, Lake |
| | | Magadi, Lake Simbi, Lake Sonachi, Lake Oloidien |
| | Tanzania | Lake Natron, Lake Eyasi, Lake Magad, Lake |
| | | Manyara, Lake Balangida, Bosotu Crater Lake, Lake |
| | | Kusare, Lake Tulusia, El Kekhooito, Momela Lake, |
| | | Lake Lekandiro, Lake Reshitani, Lake Lgarya, Lake |
| | | Ndutu |
| | Uganda | Lake Rukwa North, Lake Katwe, Lake Mahenga, Lake |
| | | Kikorongo, Lake Nyamunuka |
| | Chad | Lake Munyanyange, Lake Murumuli, Lake |
| | | Nunyampaka, Lake Bodu, Lake Rombou, Lake |
| | | Dijikare, Lake Monboio, Lake Yoan |
| Asia | Siberia | Kulunda Steppe, Tanatar Lakes, Karakul, Chita, |
| | | Barnaul, Slavgerod, Lake Baikal region, Lake Khatyn |
| | Armenia | Araxes plain lake |
| | Turkey | Lake Van, Lake Salda |
| | India | Lake Looner, Lake Sambhar |
| | China | Outer Mongolia, various “nors”; Sui-Yuan, Cha-Han- |
| | | Nor and Na-Lin-Nor; |
| | | Heilungkiang, Hailar and Tsitsihar; Kirin, Fu-U-Hsein |
| | | and Taboos-Nor; Liao-Ning, Tao-Nan Hsein; Jehol, |
| | | various soda lakes; Tibet, alkaline |
| | | deserts; Chahar, Lang-Chai; Shansi, U-Tsu-Hsein; |
| | | Shensi, Shen-Hsia-Hsein, Kansu, Ning-Hsia-Hsein, |
| | | Qinhgai Hu |
| Australia | | Lake Corangamite, Red Rock Lake, Lake Werowrap, |
| | | Lake Chidnup |
| Central America | Mexico | Lake Texcoco |
| Europe | Hungary | Lake Feher, Pecena Slatina |
| | Former | |
| | Yugoslavia | |
| North America | Canada | Manito |
| | USA | Alkali Valley, Albert Lake Lenore, Soap Lake, Big |
| | | Soda Lake, |
| | | Owens Lake, Borax Lake, Mono Lake, Searles Lake, |
| | | Deep Springs, |
| | | Rhodes Marsh, Harney Lake, Summer Lake, Surprise |
| | | Valley, |
| | | Pyramid Lake, Walker Lake, Union Pacific Lakes |
| | | (Green River), Ragtown Soda lake |
| South America | Venezuela | Langunilla Valley |
| | Chile | Antofagasta |

In some embodiments, the alkaline brine may also contain divalent cations (alkaline hard brine) and may be treated to remove the divalent cations before reacting with CO₂ (not shown in FIG. 1B). For example, the alkaline hard brine may be treated with sodium carbonate to precipitate out the calcium carbonate and/magnesium carbonate and the alkaline brine after filtration may be treated with CO₂ to give bicarbonate solution.

As illustrated in FIG. 1B, in some embodiments, the bicarbonate solution 105 is contacted with the cathode electrolyte outside the cathode chamber (path e) and/or inside the cathode chamber (path f). In some embodiments, the bicarbonate solution 105 is contacted with the cathode electrolyte 101 inside the cathode chamber (path') when bicarbonate converts to carbonate and can be withdrawn from the cathode electrolyte as sodium carbonate (path c). In some embodiments, the bicarbonate solution 105 is contacted with the cathode electrolyte outside the cathode chamber where the sodium hydroxide from the cathode electrolyte is added to the bicarbonate solution (path e) when bicarbonate converts to carbonate. The carbonate solution then is treated with divalent cations, such as calcium, magnesium, or combination thereof, to form carbonate compositions (path g), such as, CaCO₃/Ca(HCO₃)₂/MgCO₃/Mg(HCO₃)₂/calcium magnesium carbonate. In some embodiments, the bicarbonate solution 105 is added to the cathode electrolyte 101 and the solution is withdrawn from the cathode electrolyte that includes sodium carbonate, sodium bicarbonate, and sodium hydroxide. This withdrawn solution may be circulated back to the cathode electrolyte until the bicarbonate fully converts to the carbonate. In some embodiments, the solution withdrawn from the cathode electrolyte (containing sodium carbonate, sodium bicarbonate, and sodium hydroxide) is circulated back to the bicarbonate solution before being sent to the cathode electrolyte inside the cathode chamber (not shown in FIG. 1B).

In some embodiments, there is provided a method that includes reacting bicarbonate hard brine with sodium carbonate to form a carbonate precipitate; separating the carbonate precipitate from the bicarbonate hard brine to give a bicarbonate solution; and treating the bicarbonate solution with an alkaline solution to produce a composition comprising carbonate or a combination of bicarbonate or carbonate. As illustrated in FIG. 1B, in some embodiments, the bicarbonate solution may be produced from bicarbonate brine containing cations or bicarbonate hard brine 106. Examples of bicarbonate brines have been provided herein. The cations in the bicarbonate brine may be monovalent cations, such as Na⁺, K⁺, etc. and/or divalent cations, such as Ca²⁺, Mg²⁺, Sr²⁺, Ba²⁺, Mn²⁺, Zn²⁺, Fe²⁺, etc. In some instances, the divalent cations of the brine are alkaline earth metal cations, e.g., Ca²⁺, Mg²⁺. The brine, when serving as a source of cations, may have Ca²⁺ present in amounts that vary, ranging from 50 to 100,000 ppm, such as 100 to 75,000 ppm, including 500 to 50,000 ppm, for example 1000 to 25,000 ppm. The brines may have Mg²⁺ present in amounts that vary, ranging from 50 to 25,000 ppm, such as 100 to 15,000 ppm, including 500 to 10,000 ppm, for example 1000 to 5,000 ppm. In brines where both Ca²⁺ and Mg²⁺ are present, the molar ratio of Ca²⁺ to Mg²⁺ (i.e., Ca²⁺:Mg²⁺) in the brine may vary, and in one embodiment may range between 1:1 and 100:1. In some instance the Ca²⁺:Mg²⁺ may be between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the molar ratio of Ca²⁺ to Mg²⁺ in subterranean brines of interest may range between 1:1 and 1:10; 1:5 and 1:25; 1:10 and 1:50; 1:25 and 1:100; 1:50 and 1:500; or 1:100 and 1:1000. In some embodiments, the ratio of Mg²⁺ to Ca²⁺ (i.e., Mg²⁺:Ca²⁺) in the brine ranges between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the ratio of Mg²⁺ to Ca²⁺ in the subterranean brines of interest may range between 1:1 and 1:10; 1:5 and 1:25; 1:10 and 1:50; 1:25 and 1:100; 1:50 and 1:500; or 1:100 and 1:1000. In particular embodiments the Mg²⁺:Ca²⁺ of a brine may be lower than 1:1, such as 1:2, 1:3, 1:4, 1:10, 1:100 or lower.

As illustrated in FIG. 1B, in some embodiments, the bicarbonate hard brines 106 are treated with sodium carbonate to precipitate out the carbonate precipitate, such as, but not limited to, calcium carbonate, magnesium carbonate, or combination thereof. After removing the divalent cations from the bicarbonate hard brine 106, the remaining bicarbonate solution 107 is contacted with the cathode electrolyte 101 inside the cathode chamber (path h) when bicarbonate converts to carbonate and can be withdrawn from the cathode electrolyte as sodium carbonate (path c). In some embodiments, the bicarbonate solution 107 is contacted with the cathode electrolyte outside the cathode chamber where the sodium hydroxide from the cathode electrolyte is added to the bicarbonate solution (path i) when bicarbonate converts to carbonate. The carbonate solution then is treated with divalent cations, such as calcium, magnesium, or combination thereof, to form carbonate compositions (path j), such as, CaCO₃/Ca(HCO₃)₂/MgCO₃/Mg(HCO₃)₂/calcium magnesium carbonate. In some embodiments, the bicarbonate solution 107 is added to the cathode electrolyte 101 and the solution is withdrawn from the cathode electrolyte that includes sodium carbonate, sodium bicarbonate, and sodium hydroxide. This withdrawn solution may be circulated back to the cathode electrolyte until the bicarbonate fully converts to the carbonate. In some embodiments, the solution withdrawn from the cathode electrolyte (containing sodium carbonate, sodium bicarbonate, and sodium hydroxide) is circulated back to the bicarbonate solution before being sent to the cathode electrolyte inside the cathode chamber (not shown in FIG. 1B).

In some embodiments, there is provided a method that includes producing a bicarbonate solution from a subterranean brine, subsurface brine, or surface brine and treating the bicarbonate solution with an alkaline solution to produce a composition comprising carbonate or a combination of bicarbonate or carbonate. In some embodiments, there is provided a method that includes producing a bicarbonate solution from an evaporite and treating the bicarbonate solution with an alkaline solution to produce a composition comprising carbonate or a combination of bicarbonate or carbonate. As illustrated in FIG. 1B, in some embodiments, the bicarbonate solution may be derived from or is a naturally occurring bicarbonate brine 108. The naturally occurring bicarbonate brine may be obtained from a subterranean, subsurface, or surface location or is obtained from an evaporite or an ophiolite. Examples of some of the naturally occurring subterranean brines, subsurface brines, or surface brines are described above. The evaporite can be used in its conventional sense and includes a mineral deposit which forms when a restricted alkaline body of water (e.g., lake, pond, lagoon, etc.) is dehydrated by evaporation which results in concentration of ions from the alkaline body of water to precipitate out and form a mineral deposit, e.g., the crust along Lake Natron in Africa's Great Rift Valley. Naturally occurring evaporites may be found in evaporite basins, which can be classified into six different depositional settings: continental grabens, geosynclinals basins, artesian basins, stranded marine waters, and arid drainage basins. Ions found within evaporites may be derived from the weathering of the rocks and sediments with the watershed and from various types of source water (meteoric, phreatic, marine, etc.). As such, the composition of evaporites may vary. For example, evaporites may contain halides (e.g., halite, sylvite, fluorite, etc.), sulfates (e.g., gypsum, anhydrite, barite, etc.), nitrates (nitratine, niter, etc.), borates (e.g., borax), carbonates and bicarbonates (e.g., calcite, aragonite, dolomite, trona, etc.), or combination thereof, among others. Therefore, the brines obtained from evaporites may provide a source of carbonate, bicarbonate, as well as alkalinity.

In some embodiments, the evaporite or ophiolites may also be a source of one or more cations. In some embodiments, the cations may be monovalent cations, such as Na⁺, K⁺. In some embodiments, the cations are divalent cations, such as Ca²⁺, Mg²⁺, Sr²⁺, Ba²⁺Mn²⁺, Zn²⁺, or Fe²⁺. The source of divalent cations from evaporites may be in the form of mineral salts, such as sulfate salts (e.g., calcium sulfate), or borate salts (e.g., borax). In some instances, divalent cations of the evaporite are alkaline earth metal cations, e.g., Ca²⁺, Mg²⁺.

In certain embodiments, the evaporites contain borate. Borates present in evaporites of the invention may be any borate salt, e.g., Na₃BO₃. The amount of borate present in evaporites of the invention may vary. In some instances, the amount of borate that is present in the evaporite ranges from 1% to 95% (w/w), such as 5% to 90% (w/w), such as 10% to 90% (w/w), including about 15% to 85% (w/w), for instance about 20% to 75% (w/w), such as 25% to 75% (w/w), such as 25% to 60% (w/w), including about 25% to 50% (w/w).

Evaporites or ophiolites may be obtained using any convenient protocol. For instance, naturally forming surface or subsurface evaporites may be obtained by quarry excavation using conventional earth-moving equipment, e.g., bulldozers, front-end loaders, back hoes, etc. In these embodiments, evaporites or ophiolites may also be further processed after excavation to separate each mineral as desired, such as by rehydration followed by sequential precipitation or by density-based separation methods. In other embodiments, evaporites may be obtained by pond precipitation. In these embodiments, a source evaporite aqueous composition (e.g., surface or subsurface brine) may first be obtained, such as by a surface turbine motor pump or subsurface brine pump, and subsequently dehydrated to produce the evaporite. In some embodiments, the composition of the source evaporite aqueous composition may be adjusted (i.e., adding or removing components, as desired) prior to dehydrating the source water to produce an evaporite of a desired composition. The evaporite may be used as is or are subjecting to processes such as, but not limited to, crushing, milling, grinding, etc. to reduce the size of the rocks or to make a fine powder. The crushed or milled bicarbonate evaporite may be dissolved in water to make the bicarbonate solution. In embodiments, where the evaporite is a carbonate mineral, the carbonate may be converted to bicarbonate by treating with CO₂ before being used as the bicarbonate solution in the systems and methods of the invention.

In some embodiments, the evaporites are crushed, milled, grounded, or combination thereof, are dissolved in water and the solution is used as is for contacting with the cathode electrolyte in accordance with the methods and systems of the invention. In some embodiments, evaporites may be processed to remove other elements, such as divalent cations, borates, etc., from the bicarbonate before contacting with the cathode electrolyte.

In some embodiments, the pH of the bicarbonate solution is greater than 7; or 7-12; or 7-10; or 7-8; or greater than 10; or 8-12; or 8-10; or 9-14; or 9-12; or 9-10; or 10-14; or 10-12; or 11-14. In addition to carbonates, the bicarbonate solution may also contain other anions, such as, but are not limited to, sulfate, phosphate, chloride etc. In some embodiments, the bicarbonate solution may include large amounts of sulfur which may be present in various forms, such as, but are not limited to, hydrogen sulfide (H₂S), sulfite (SO₃²⁻), and thionates (S₄O₆²⁻). These sulfate forms may be removed before using the bicarbonate solution in the methods and systems provided herein.

In some embodiments, the bicarbonate solution includes one or more of elements including, but not limited to, aluminum, barium, cobalt, copper, iron, lanthanum, lithium, mercury, arsenic, cadmium, lead, nickel, phosphorus, scandium, titanium, zinc, zirconium, molybdenum, and/or selenium. In some embodiments, the bicarbonate solution includes one or more of elements including, but not limited to, lanthanum, mercury, arsenic, lead, and selenium. In some embodiments, the bicarbonate solution are processed to remove one or more of the elements, such as, lithium, iron, etc. and the remaining solution is used in the systems and methods provided herein, and/or the solution may be used in the systems and methods provided herein and then processed to remove one or more of these elements. The foregoing elements may be considered as markers for identifying reaction products, i.e., carbonate compositions of the invention derived from bicarbonate brines or bicarbonate solution.

As illustrated in FIG. 1B, in some embodiments, the bicarbonate solution 108 is contacted with the cathode electrolyte outside the cathode chamber (path m) and/or inside the cathode chamber (path k). In some embodiments, the bicarbonate solution 108 is contacted with the cathode electrolyte 101 inside the cathode chamber (path k) when bicarbonate converts to carbonate and can be withdrawn from the cathode electrolyte as sodium carbonate (path c). In some embodiments, the bicarbonate solution 108 is contacted with the cathode electrolyte outside the cathode chamber where the sodium hydroxide from the cathode electrolyte is added to the bicarbonate solution (path m) when bicarbonate converts to carbonate. The carbonate solution then is treated with divalent cations, such as calcium, magnesium, or combination thereof, to form carbonate compositions (path n), such as, CaCO₃/Ca(HCO₃)₂/MgCO₃/Mg(HCO₃)₂/calcium magnesium carbonate. In some embodiments, the bicarbonate solution 108 is added to the cathode electrolyte 101 and the solution is withdrawn from the cathode electrolyte that includes sodium carbonate, sodium bicarbonate, and sodium hydroxide. This withdrawn solution may be circulated back to the cathode electrolyte until the bicarbonate fully converts to the carbonate. In some embodiments, the solution withdrawn from the cathode electrolyte (containing sodium carbonate, sodium bicarbonate, and sodium hydroxide) is circulated back to the bicarbonate solution before being sent to the cathode electrolyte inside the cathode chamber (not shown in FIG. 1B).

It is to be understood that any number of variations of the addition of the bicarbonate solution to the cathode electrolyte including, but not limited to, inside the cathode chamber, and/or outside the cathode chamber, and/or recirculation of the bicarbonate solution inside the cathode chamber and back to the bicarbonate solution, etc. are well within the scope of this invention.

In some embodiments, the sodium carbonate obtained from the cathode electrolyte (path c) is treated with divalent cations, or a brine containing divalent cations (hard brine), such as calcium chloride containing brine, to precipitate out calcium carbonate, magnesium carbonate, or combination thereof. The remaining raw brine may be circulated back to the electrochemical cell (not shown in FIG. 1B). The raw brine may be circulated to any of the cathode electrolyte, anode electrolyte, or the brine compartment of the electrochemical cell depending on the design of the electrochemical cell.

The methods and systems provided herein may produce bicarbonate solution from either of the methods and systems described in FIG. 1B or a combination thereof. For example, the source of the bicarbonate solution that is contacted with the cathode electrolyte inside the cathode chamber and/or outside the cathode chamber may be the bicarbonate solution 103, 105, 107, and/or 108.

The bicarbonate solution produced by the methods and systems as described above or other brines used in the processes to produce the bicarbonate solution, may be treated, altered, or modified before the bicarbonate solution is contacted with the cathode electrolyte. The alteration or the modification of the bicarbonate solution and/or the brine may include processes, such as, but not limited to, sedimentation, centrifugation, filtration, etc. The alteration or the modification of the bicarbonate solution and/or the brine may also include treating the solution and/or the brine to remove or add components. In some embodiments, modifying the bicarbonate solution and/or the brine includes concentrating or diluting a solution and/or brine to achieve a desired ionic strength or component concentration. In some embodiments, modifying the solution and/or the brine may include heating or cooling prior to or during the reaction. The solution and/or the brine may be treated in situ. In some embodiments, modifying the solution and/or the brine includes mixing two or more different solutions and/or the brines to produce a brine mixture, where each of the two or more solutions and/or the brines is obtained from distinct sources (e.g., man-made or synthetic brine and subterranean brine or brines from separate subterranean locations). The amount of each of the solution and/or the brine in the mixture may vary as desired, ranging in some instances from 0.1% to 99.9% by volume, or 0.1-75%; or 0.1-50%; or 0.1-30%; or 5-95%; or 5-75%; or 5-50%; or 10-99%; or 10-75%; or 10-50%; 10-25%; or 25-90%; or 25-75%; or 25-50%; or 50-90%; or 50-75%; or 75-90%; or 75-80% by volume. Two or more solutions and/or the brines may be mixed by any convenient mixing protocol, such as using agitator drives, counterflow impellers, turbine impellers, anchor impellers, ribbon impellers, axial flow impellers, radial flow impellers, hydrofoil mixers, aerators, among others. The modification of the bicarbonate solution may be carried out in the reactor system.

In some embodiments, the methods of the invention further include obtaining brine from a subterranean location before processing or before using in the methods and the systems. In some embodiments, there is provided a method including obtaining a subterranean brine; producing a bicarbonate solution from the subterranean brine; and treating the bicarbonate solution to produce a product including carbonate or combination of carbonate and bicarbonate. A subterranean brine can be obtained by any convenient protocol, such as for example by pumping the subterranean brine from the subterranean location using, for example a down-well turbine motor pump, a geothermal well pump or a surface-located brine pump. In some embodiments, obtaining the subterranean brine may include pumping the subterranean brine from the underground location and storing it in an above-ground storage basin. The above-ground storage basin may be any convenient storage basin. In some embodiments, the above-ground storage basin may be a naturally-occurring geological structure, such as, a tailings pond or dried riverbed or may be a manmade structure, such as a storage tank. Where desired, the subterranean brine may be stored in the above-ground storage basin for a period of time following pumping from the subterranean location. For example, the subterranean brine may be stored for a period of time ranging from 1 to 1000 days or longer, such as 1 to 500 days or longer, and including 1 to 100 days or longer. In these embodiments, the subterranean brine may be stored at a temperature ranging from 1 to 75° C., such as 10 to 50° C. and including 10 to 25° C. In some embodiments, the subterranean brine may be left in the subterranean location (e.g., in an underground well) until needed and pumped from the underground location directly into the cathode electrolyte inside and/or outside the cathode chamber or pumped from the underground location for further processing and/or modification to form bicarbonate brine. In some embodiments, the subterranean brine may be left in the subterranean location (e.g., in an underground well) and contacting and/or other operations may be performed underground. Brines may be treated prior to, during or after storage for any length of time.

In some embodiments, the composition of the brine mixture may be determined, monitored or assessed after preparing the brine or after obtaining brine from the subterranean location or after mixing the two or more subterranean brines together. Based on the determined composition of the brine or the brine mixture, the brine may be further treated. Where desired, monitoring and modification may be performed using real-time protocols, such that these two processes are occurring continuously to provide the desired brine.

Changes in the brine that may be achieved upon treatment may vary greatly. For example, the chemical makeup of the brine may be modified, e.g., via production of new chemical species in the brine or augmentation or other modification of the concentration of a chemical species already present in the brine. In some embodiments, one or more components of the brine may be removed from the brine. The brine may also be modified to remove one or more elements, such as, lithium, iron, aluminum, etc. which find use in other applications.

In some embodiments, the elements may be added to the bicarbonate solution prior to contacting the bicarbonate solution with the cathode electrolyte. Where desired, the elements may be added to the bicarbonate solution at more than one time during methods of the invention (e.g., before, during or after contacting the bicarbonate solution with the cathode electrolyte). In some embodiments, the elements added to the bicarbonate solution range from 0.01 to 100.0 grams/liter of solution, such as from 1 to 100 grams/liter of solution, for example 5 to 80 grams/liter of solution, including 5 to 50 grams/liter of solution.

In some embodiments, if the concentration of bicarbonate in the solution is less than optimal for the formation of the sodium carbonate after contacting with the cathode electrolyte, then bicarbonate may be added to the solution to increase the concentration of the bicarbonate in the solution. In some embodiments, if the bicarbonate in the solution is an excess of bicarbonate then the solution may be diluted to reduce the concentration of the bicarbonate in the bicarbonate solution. In some embodiments, the temperature, pressure, and/or pH of the bicarbonate solution may be optimized.

In some embodiments, the composition of the brine, such as, the subterranean, subsurface or surface brine, may be considered to be less than optimal when the brine contains bacterial content, such as where the concentration of bacteria is 1×10⁵ cfu/ml or greater, such as 5×10⁵ cfu/ml or greater, such as 1×10⁶ cfu/ml or greater, such as 5×10⁶ cfu/ml or greater, including 1×10⁷ cfu/ml or greater. As such, in some embodiments, the composition of the brine may be modified to reduce or eliminate the amount of bacterial content in the brine. The bacterial concentration of the brine may be decreased by 5-fold or more, such as 10-fold or more, such as 100-fold or more, such as 1000-fold or more, such as 10.000-fold or more, such as 100.000-fold or more, including 1,000,000-fold or more. The bacterial content may be reduced or eliminated by treating the brine with any convenient protocol, such as increasing the temperature of the brine. In some embodiments, methods of the invention also include determining and assessing the composition of the brine after treating the brine with a protocol for reducing or eliminating bacterial content. In some embodiments, the bacterial concentration of the brine is reduced or eliminated by adding an amount of a bactericidal composition. Bactericidal compositions may be any convenient composition which inactivates or kills bacteria and may include, but are not limited to, bacterial disinfectants (e.g., dichloroisocyanurate, iodopovidone, isopropanol, triclosan, tricholorophenol, cetyl trimethyammonium bromide, peroxides, etc.), antibiotics (e.g., penicillin, cephalosporins, monobactams, daptomycin, fluoroquinolones, metronidazole, nitrofurantoin, etc.), antiseptics (e.g., potassium hypochlorite, sodium benzenesulfochlroamide, Lugol's solution, urea perhydrate, sorbic acid, hexachlorophene, Dibromol, etc.). The bactericidal composition may be added to the brine by any convenient protocol, such as a solid, an aqueous composition, a liquid, etc.

In some embodiments, the bacterial concentration of the brine or the bicarbonate solution is reduced or eliminated by adjusting the temperature of the brine. The temperature of the brine or the solution may be adjusted by any convenient protocol, such as by heat coils, Peltier thermoelectric devices, solar heating devices, water baths, oil baths, gas-power water boilers, etc. Adjusting the temperature of the brine to reduce or eliminate bacterial content may vary, such as increasing the temperature of the brine by 5° C. or more, such as 10° C. or more, such as 15° C. or more, such as 25° C. or more, such as 50° C. or more, such as 75° C. or more, including 100° C. or more. In other embodiments, the bacterial concentration of the brine or the bicarbonate solution is reduced or eliminated by irradiating the brine with electromagnetic radiation, e.g., UV light. The brine or the bicarbonate solution may be irradiated with electromagnetic radiation by any convenient protocol, such as by using one or more lamps or lasers. In some instances, the brine or the bicarbonate solution may be irradiated in the storage basin, with or without stirring. In other instances, the subterranean brine may be pumped through UV-transparent (e.g., quartz) pipes and irradiated by one or more lamps or laser while the subterranean brine is pumped. The duration of irradiation may vary depending on the volume of the brine or the bicarbonate solution and the desired extent of treatment. In some embodiments, the brine or the bicarbonate solution may be irradiated for 0.5 hours or more, such as 1 hour or more, such as 2 hours or more, such as 5 hours or more, such as 10 hours or more, including 24 hours or more.

In some embodiments, modifying the bicarbonate brine or the bicarbonate solution includes concentrating bicarbonate. The concentration of the bicarbonate in the brine or the solution may be accomplished using any convenient protocol, e.g., distillation, evaporation, among other protocols (e.g., so as to decrease the total volume of the brine while keeping the mass of carbonate constant). In some embodiments, the brine or the solution may be concentrated by the use of evaporation ponds to reduce the total volume of water and volatile organic substances in the brine. In some embodiments, the brine or the solution may be concentrated by using heat from a power plant in order to evaporate water and volatile organic substances. In some embodiments, bicarbonate in the brine or the solution may be concentrated by adding bicarbonate to the brine (i.e., so as to increase the mass of bicarbonate while keeping the total volume of the bicarbonate brine constant). Bicarbonate may be added to the brine or the solution by any suitable protocol. For example, sodium bicarbonate may be added to the brine or the solution as a solid or a slurry. In some instances, sodium bicarbonate may be dissolved in an aqueous solution and the aqueous solution added to the brine. In other embodiments, methods of the invention may include decreasing the bicarbonate concentration in the bicarbonate brine or the bicarbonate solution. As such, the concentration of bicarbonate in the brine may be decreased, e.g., by 0.1M or more, such as by 0.5 M or more, such as by 1 M or more, such as by 2 M or more, such as by 5 M or more, including by 10 M or more. Decreasing the concentration of bicarbonate in the brine or the solution may be accomplished using any convenient protocol for example, diluting the brine with diluent (e.g., water).

The initial temperature of the brine or the solution may vary depending on the source of the brine (e.g., subterranean brine), ranging from −5 to 110° C., such as from 0 to 100° C., such as from 10 to 80° C., and including from 20 to 60° C. In certain embodiments, the temperature of the brine or the solution may be adjusted (i.e., increased or decreased) as desired, e.g., by 5° C. or more, such as 10° C. or more, such as 15° C. or more, such as 25° C. or more, such as 50° C. or more, such as 75° C. or more, including 100° C. or more. Where desired, the temperature of the bicarbonate brine or the bicarbonate solution may be adjusted to a temperature which is equivalent to the temperature of the cathode electrolyte. The temperature of the brine or the solution may be adjusted using any convenient protocol, such as, for example, a thermal heat exchanger, electric heating coils, Peltier thermoelectric devices, gas-powered boilers, among other protocols.

In certain embodiments, the temperature of the brine or the bicarbonate solution may be raised using energy generated from low or zero carbon dioxide emission sources, e.g., solar energy source, wind energy source, hydroelectric energy source, etc. In certain embodiments, the temperature of a brine or the bicarbonate solution may be lowered and the excess heat energy used for a beneficial purpose. In some embodiments, excess thermal energy of the brine or the bicarbonate solution may be used to drive one or more processes of this invention. Heat energy may be converted to electrical energy or used as thermal energy. The thermal energy of the brine or the bicarbonate solution may be collected via a heat exchanger (e.g., a vertical or horizontal closed loop) and transferred to a process of this invention, for example dewatering the precipitate of this invention. Thermal energy of the brine or the bicarbonate solution may be used to generate electrical power (e.g., steam generator). In some embodiments, thermal energy from the brine or the bicarbonate solution may be used to heat the precipitate or the product of this invention in order to dry that precipitate or the product (e.g., dry an aggregate or the formed building material). In some embodiments, thermal energy from a geothermal source may be converted to electrical energy and is used to drive the electrochemical process.

### B. Methods and Systems Including an Electrochemical Cell

In one aspect, there is provided a system including an anode electrolyte in contact with an anode; a cathode electrolyte in contact with a cathode; and a contact system operably connected to the cathode electrolyte configured to contact a bicarbonate solution to the cathode electrolyte. In some embodiments, the bicarbonate solution may be contacted with the cathode electrolyte of any electrochemical cell that produces an alkaline solution in the cathode electrolyte. In some embodiments, the electrochemical process is a chloralkali process where chlorine is produced at the anode. The chloralkali process is well known in the art. In some embodiments, the electrochemical cell is a hydrolysis process where oxygen is produced at the anode. Some embodiments of the methods and systems using the electrochemical cell are described herein. Such electrochemical cells are in no way limiting to the scope of the invention. It is to be understood that any electrochemical cell that produces an alkali in the cathode electrolyte is well within the scope of the invention. The bicarbonate solution and the methods of producing the bicarbonate solution have been described herein.

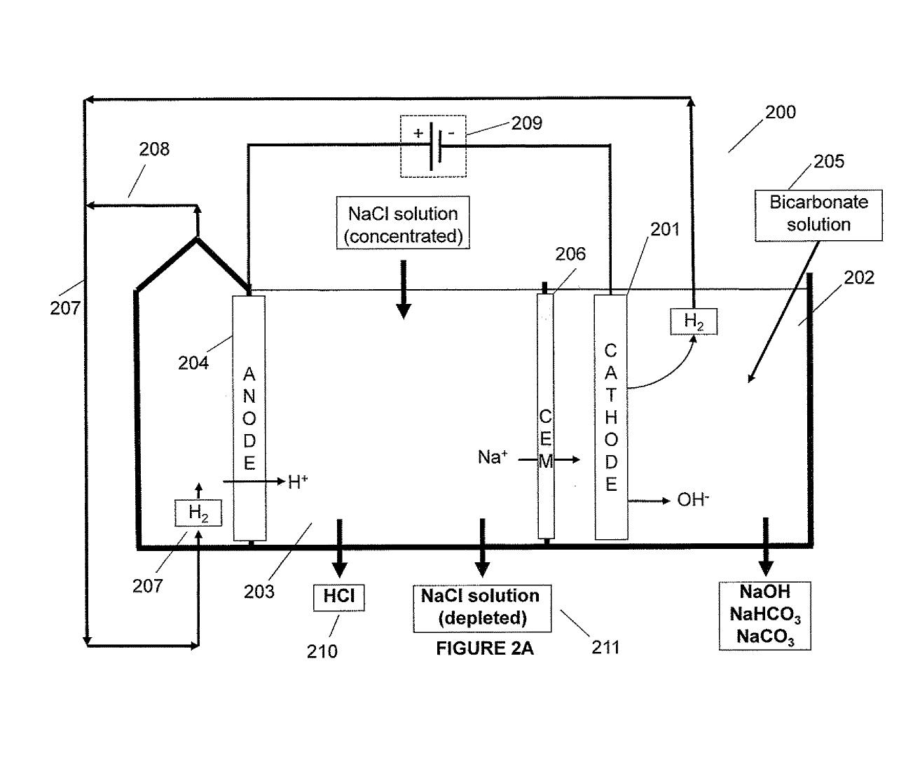

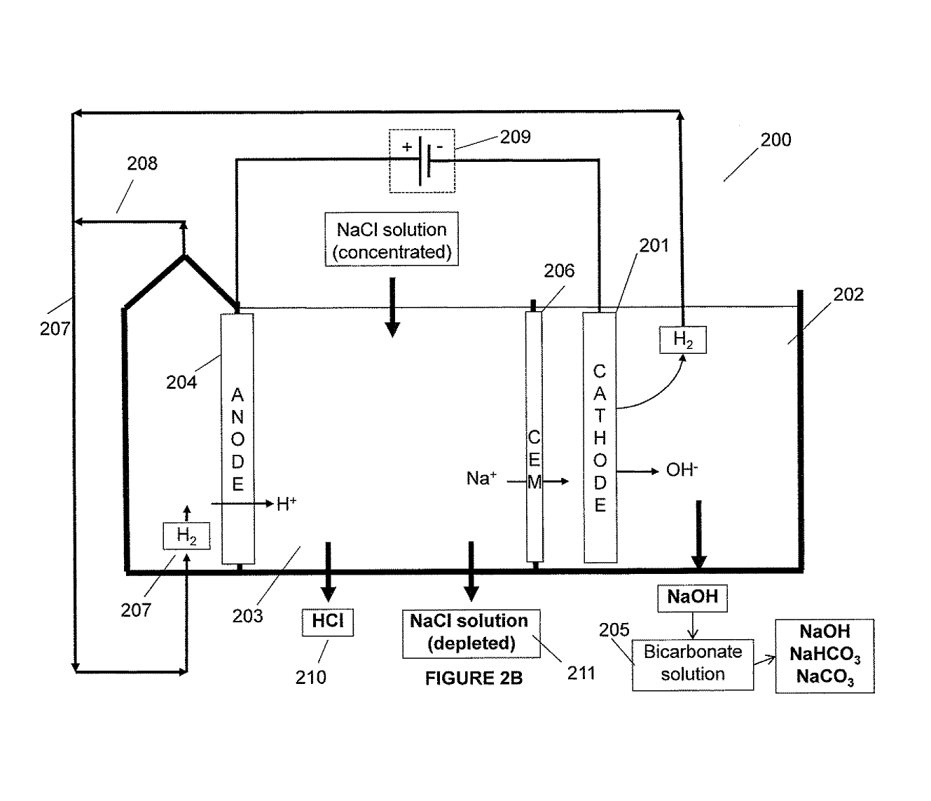

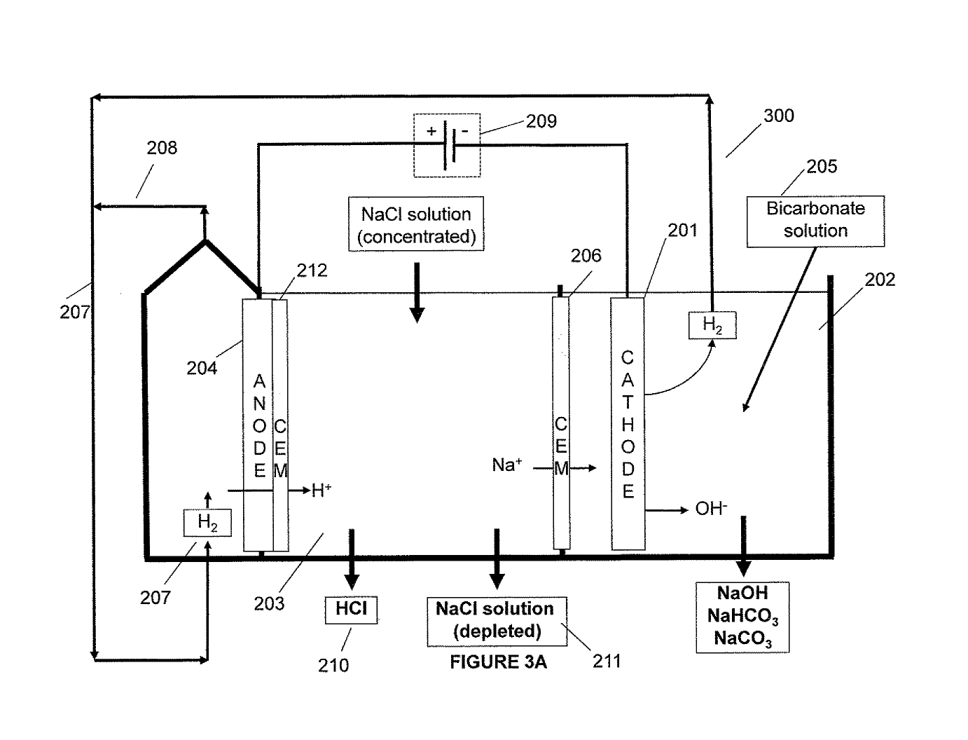

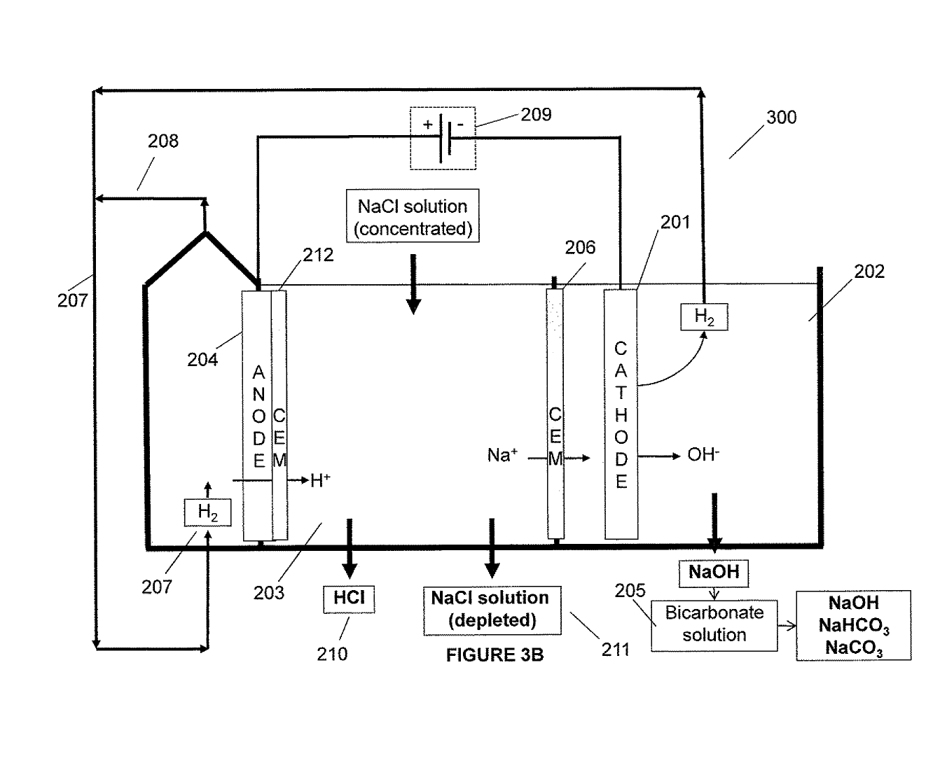

FIGS. 2A, 2B, 3A, and 3B illustrate some embodiments of the systems and methods provided herein, where the systems 200 and 300 include a cathode chamber including a cathode 201 in contact with a cathode electrolyte 202 and an anode chamber including an anode 204 and an anode electrolyte 203. In FIGS. 2A, 2B, 3A, and 3B, the cathode chamber is separated from the anode chamber by a first cation exchange membrane (CEM) 206. FIGS. 3A and 3B illustrate the system 300 including an anode 204 that is separated from the anode electrolyte 203 by a second cation exchange membrane 212 that is in contact with the anode 204. FIGS. 2A and 3A illustrate some embodiments where the bicarbonate solution 205 is added to the cathode electrolyte 202 inside the cathode chamber. FIGS. 2B and 3B illustrate some embodiments where the bicarbonate solution 205 is contacted with the hydroxide from the cathode electrolyte 202 outside the cathode chamber.

In systems 200 and 300 as illustrated in FIGS. 2A, 2B, 3A, and 3B, the first cation exchange membrane 206 is located between the cathode 201 and anode 204 such that it separates the cathode electrolyte 202 from the anode electrolyte 203. In some embodiments, the hydrogen gas produced at the cathode is directed to the anode through a hydrogen gas delivery system 207, and is oxidized to hydrogen ions at the anode. Thus, as is illustrated in FIGS. 2A, 2B, 3A, and 3B, on applying a relatively low voltage, e.g., less than 2V or less than 1V, across the anode 204 and cathode 201, hydroxide ions (OH⁻) and hydrogen gas (H₂) are produced at the cathode 201; the hydrogen gas is directed from the cathode 201 to the anode 204; and hydrogen gas is oxidized at the anode 204 to produce hydrogen ions at the anode 204, without producing a gas at the anode. In some embodiments, utilizing hydrogen gas at the anode from hydrogen generated at the cathode eliminates the need for an external supply of hydrogen. In some embodiments, utilizing hydrogen gas at the anode from hydrogen generated at the cathode reduces the utilization of energy by the system to produce the alkaline solution.

In some embodiments, as illustrated in FIGS. 2A, 2B, 3A, and 3B, under the applied voltage 209 across the anode 204 and the cathode 201, hydroxide ions are produced at the cathode 201 and migrate into the cathode electrolyte 202, and hydrogen gas is produced at the cathode. In certain embodiments, the hydrogen gas produced at the cathode 201 is collected and directed to the anode, e.g., by a hydrogen gas delivery system 207, where it is oxidized to produce hydrogen ions at the anode. Under the applied voltage 209 across the anode 204 and cathode 201, hydrogen ions produced at the anode 204 migrate from the anode 204 into the anode electrolyte 203 to produce an acid, e.g., hydrochloric acid. In some embodiments, the first cation exchange membrane 206 may be selected to allow passage of cations therethrough while restricting passage of anions therethrough. Thus, as is illustrated in FIGS. 2A, 2B, 3A, and 3B, on applying the low voltage across the anode 204 and cathode 201, cations in the anode electrolyte 203, e.g., sodium ions in the anode electrolyte migrate into the cathode electrolyte through the first cation exchange membrane 206, while anions in the cathode electrolyte 202, e.g., hydroxide ions, and/or carbonate ions, and/or bicarbonate ions, are prevented from migrating from the cathode electrolyte through the first cation exchange membrane 206 and into the anode electrolyte 203.

Thus, as is illustrated in FIGS. 2A, 2B, 3A, and 3B, where the anode electrolyte 203 includes an aqueous salt solution such as sodium chloride in water, a solution, e.g., an alkaline solution, is produced in the cathode electrolyte 202 including cations, e.g., sodium ions, that migrate from the anode electrolyte 203, and anions, e.g., hydroxide ions produced at the cathode 201. As illustrated in FIGS. 2A and 3A, in some embodiments, the bicarbonate solution 205 may be contacted with the cathode electrolyte 202 inside the cathode chamber. The bicarbonate ions upon reaction with the sodium hydroxide in the cathode electrolyte produce carbonate ions. Concurrently, in the anode electrolyte 203, an acid, e.g., hydrochloric acid is produced from hydrogen ions migrating from the anode 204 and anions, e.g., chloride ions, present from the anode electrolyte. As illustrated in FIGS. 2B and 3B, in some embodiments, the bicarbonate solution 205 may be contacted with the cathode electrolyte 202 containing sodium hydroxide outside the cathode chamber. The bicarbonate ions upon reaction with the sodium hydroxide in the cathode electrolyte produce carbonate ions. Such carbonate/bicarbonate containing solution is further processed as described herein to make carbonate compositions.

With reference to FIGS. 3A and 3B, an anode comprising a second cation exchange membrane 212 is utilized to separate the anode 204 from the anode electrolyte 203 such that on a first surface, the cation exchange membrane 212 is in contact with the anode 204, and an opposed second surface it is in contact with the anode electrolyte 203. In some embodiments, since the second cation exchange membrane 212 is permeable to cations, e.g., hydrogen ions, the anode 204 is in electrical contact with the anode electrolyte 203 through the second cation exchange membrane 212.

Thus, in some embodiments of FIGS. 3A and 3B, as with the embodiments illustrated for FIGS. 2A and 2B, on applying the low voltage across the anode 204 and cathode 201, hydrogen ions, produced at the anode 204 from oxidation of hydrogen gas at the anode, migrate through the second cation exchange membrane 212 into the anode electrolyte 203. At the same time, cations in the anode electrolyte 203, e.g., sodium ions in the anode electrolyte comprising sodium chloride, migrate from the anode electrolyte 203 into the cathode electrolyte 202 through the first cation exchange membrane 206, while anions in the cathode electrolyte 202, e.g., hydroxide ions, and/or carbonate ions, and/or bicarbonate ions, are prevented from migrating from the cathode electrolyte 202 to the anode electrolyte 203 through the first cation exchange membrane 206. Also, in some embodiments of FIGS. 3A and 3B, hydrogen ions migrating from the anode 204 through the second cation exchange membrane 212 into the anode electrolyte 203 may produce an acid, e.g., hydrochloric acid with the anions, e.g., chloride ions, present in the anode electrolyte; wherein the cathode electrolyte 202, an alkaline solution is produce from anions present in the cathode electrolyte 202 and cations, e.g., sodium ions, that migrate from the anode electrolyte 203 to the cathode electrolyte 202 through the first cation exchange membrane 206. In some embodiments, the voltage across the anode 204 and cathode 201 is adjusted to a level such that hydroxide ions and hydrogen gas are produced at the cathode 201 without producing a gas, e.g., chlorine or oxygen, at the anode 204.

As illustrated in FIGS. 2A and 3A, in some embodiments, the cathode electrolyte 202 is operatively contacted with a supply of bicarbonate solution 205. In some embodiments, the bicarbonate solution may be naturally occurring bicarbonate brine. In some embodiments, the bicarbonate solution may be processed from other natural substances to produce the bicarbonate solution. Such bicarbonate solutions have been described in detail herein.

As illustrated in FIGS. 2A, 2B, 3A, and 3B, in some embodiments, the anode electrolyte 203 comprises a salt solution that includes sodium ions and chloride ions; the system 200, 300 is configured to produce the alkaline solution in the cathode electrolyte 202 while also producing hydrogen ions at the anode 204, with less than 2V, or less than 1V, or between 0.1V-1V, or between 0.1-2V, across the anode 204 and cathode 201, without producing a gas at the anode 204; the system 200, 300 is configured to migrate hydrogen ions from the anode 204 into the anode electrolyte 203; the anode electrolyte 203 comprises an acid; the system 200, 300 is configured to produce hydroxide, and/or bicarbonate ions, and/or carbonate ions in the cathode electrolyte 202; migrate hydroxide ions from the cathode 201 into the cathode electrolyte 202; migrate cations, e.g., sodium ions, from the anode electrolyte 203 into the cathode electrolyte 202 through the first cation exchange membrane 206; hydrogen gas is provided to the anode; a hydrogen gas delivery system 207 is configured to direct hydrogen gas from the cathode to the anode; the cathode electrolyte 202 in the system 200, 300 is configured to be contacted with a bicarbonate solution 205 inside the cathode chamber to produce bicarbonate, carbonate, or mixture thereof depending on the pH of the cathode electrolyte; in some embodiments, the sodium hydroxide produced by the cathode electrolyte 202 is contacted with the bicarbonate solution 205 outside the cathode chamber to produce bicarbonate, carbonate, or mixture thereof.

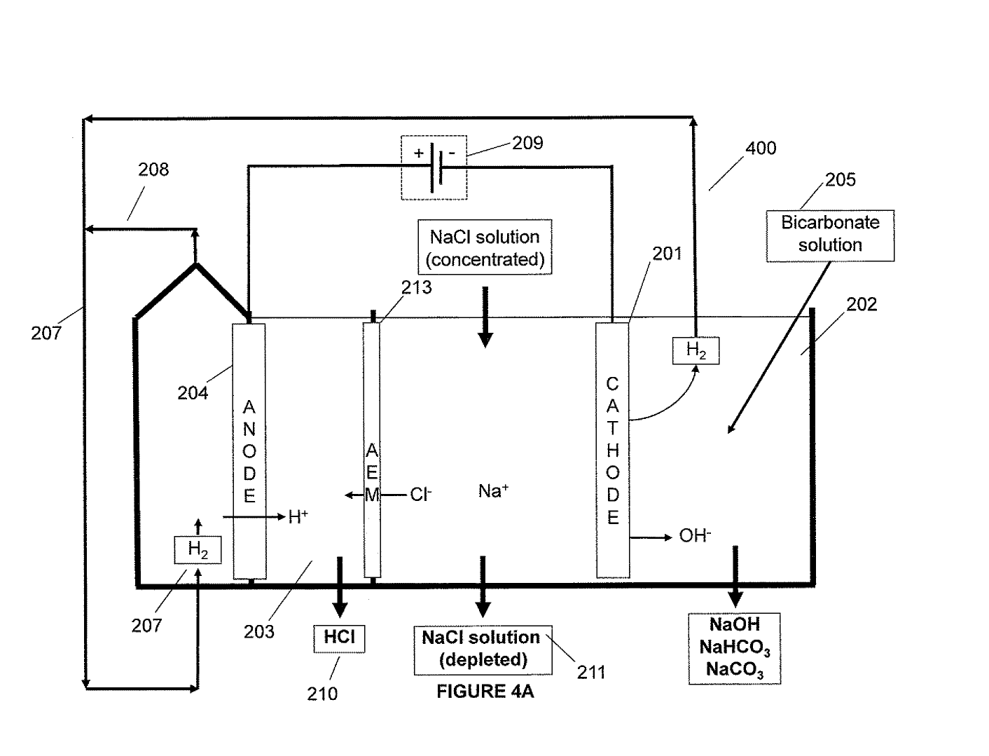

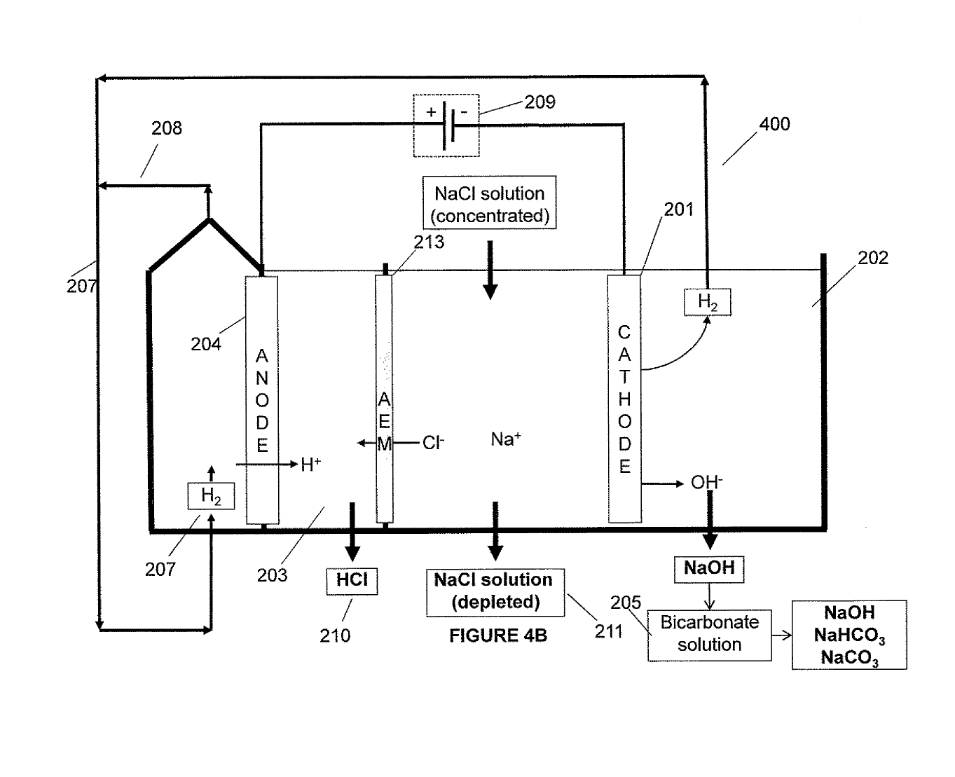

In some embodiments, as illustrated in FIGS. 4A and 4B, the system 400 comprises a cathode chamber including a cathode 201 in contact with a cathode electrolyte 202 and an anode chamber including an anode 204 in contact with an anode electrolyte 203. In this system, the cathode electrolyte 202 comprises a salt solution that functions as the cathode electrolyte as well as a source of chloride and sodium ions for the alkaline and acid solution produced in the system. In this system, the cathode electrolyte 202 is separated from the anode electrolyte 203 by an anion exchange membrane (AEM) 213 that allows migration of anions, e.g., chloride ions, from the salt solution to the anode electrolyte 203. As is illustrated in FIGS. 4A and 4B, the system includes a hydrogen gas delivery system 207 configured to provide hydrogen gas to the anode 204.

Referring to FIGS. 4A and 4B, on applying a voltage across the anode and the cathode, protons produced at the anode 204 from oxidation of hydrogen enter into the anode electrolyte 203 from where they may attempt to migrate to the cathode electrolyte 202 across the anion exchange membrane 213. However, as the anion exchange membrane 213 may block the passage of cations, the protons may accumulate in the anode electrolyte 203. At the same time, however, the anion exchange membrane 213 being pervious to anions may allow the migration of anions, e.g., chloride ions from the cathode electrolyte 202 to the anode electrolyte 203. Thus, in some embodiments, chloride ions may migrate to the anode electrolyte 203 to produce hydrochloric acid in the anode electrolyte 203. In this system, the voltage across the anode 204 and cathode 201 is adjusted to a level such that hydroxide ions and hydrogen gas are produced at the cathode 201 without producing a gas, e.g., chlorine or oxygen, at the anode 204. In some embodiments, since cations may not migrate from the cathode electrolyte across the anion exchange membrane 213, sodium ions may accumulate in the cathode electrolyte 202 to produce an alkaline solution with hydroxide ions produced at the cathode. In some embodiments where bicarbonate solution is contacted with the cathode electrolyte, sodium ions may also produce sodium bicarbonate and or sodium carbonate in the cathode electrolyte.

As illustrated in FIGS. 4A and 4B, in some embodiments, the anode electrolyte 203 comprises a salt solution that includes sodium ions and chloride ions; the system 400 is configured to produce the alkaline solution in the cathode electrolyte 202 while also producing hydrogen ions at the anode 204, with less than 1V across the anode 204 and cathode 201, without producing a gas at the anode 204; the system 400 is configured to migrate chloride ions from the cathode electrolyte 202 to the anode electrolyte 203 through the anion exchange membrane 213; hydrogen gas is provided to the anode; and a hydrogen gas delivery system 207 is configured to direct hydrogen gas from the cathode to the anode; the anode electrolyte 203 comprises an acid; migrate hydroxide ions from the cathode 201 into the cathode electrolyte 202; the system 400 is configured to produce hydroxide, and/or bicarbonate ions, and/or carbonate ions in the cathode electrolyte 202.

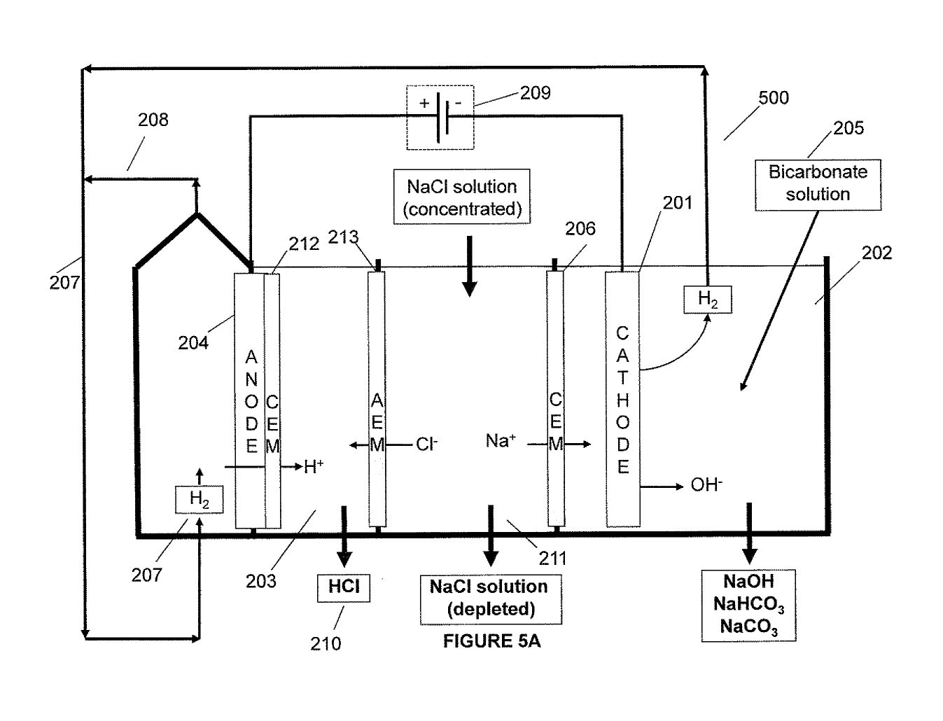

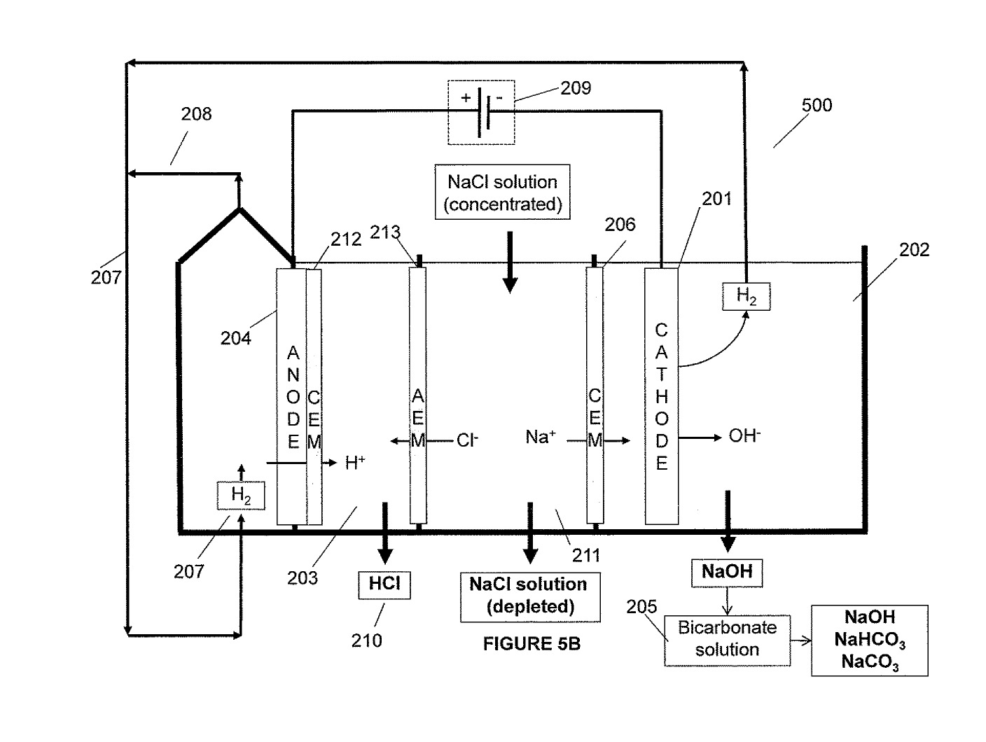

Referring to FIGS. 5A and 5B herein, the system 500 in some embodiments includes an anode chamber including an anode 204 in contact with an anode electrolyte 203 and a cathode chamber including a cathode 201 in contact with a cathode electrolyte 202. The system 500 includes a third electrolyte disposed between the anion exchange membrane 213 and the first cation exchange membrane 206. The third electrolyte is a salt solution 211. In some embodiments, the system includes a gas delivery system 207 configured to deliver hydrogen gas to the anode 204. In some embodiments, the hydrogen gas is obtained from the cathode 201. In the system, the anode 204 is configured to produce protons, and the cathode 201 is configured to produce hydroxide ions and hydrogen gas when a low voltage 209, e.g., less than 2V, is applied across the anode and the cathode. In the system, a gas is not produced at the anode 204.

In some embodiments, the system is as illustrated in FIGS. 5A and 5B, the first cation exchange membrane 206 is positioned between the cathode electrolyte 202 and the third electrolyte, the salt solution 211; and an anion exchange membrane 213 is positioned between the salt solution 211 and the anode electrolyte 203 in a configuration where the anode electrolyte 203 is separated from the anode 204 by second cation exchange membrane 212. In some embodiments, the second cation exchange membrane is optional. The second cation exchange membrane may prevent the anode from corrosion by the acid generated in the anode electrolyte. Therefore, systems where the anode does not have a second cation exchange membrane, are well within the scope of the invention. In the system, the second cation exchange membrane 212 is positioned between the anode 204 and the anode electrolyte 203 such that anions may migrate from the salt solution 211 to the anode electrolyte 203 through the anion exchange membrane 213; however, anions are prevented from contacting the anode 204 by the second cation exchange membrane 212 adjacent to the anode 204. It is to be understood that there may be more than one anion exchange membranes and cation exchange membranes in the system depending on the desired configuration of the electrochemical cell.

In some embodiments, the system is configurable to migrate anions, e.g., chloride ions, from the salt solution 211 to the anode electrolyte 203 through the anion exchange membrane 213; migrate cations, e.g., sodium ions from the salt solution 211 to the cathode electrolyte 202 through the first cation exchange membrane 206; migrate protons from the anode 204 to the anode electrolyte 203; and migrate hydroxide ions from the cathode 201 to the cathode electrolyte 202. In some embodiments, the system may be configured to contact the bicarbonate solution with the cathode electrolyte inside the cathode chamber (FIG. 5A) or outside the cathode chamber (FIG. 5B). Thus, in some embodiments, the system may be configured to produce sodium hydroxide and/or sodium bicarbonate and/or sodium carbonate in the cathode electrolyte 202; and produce an acid e.g., hydrochloric acid 210 in the anode electrolyte 203.

In some embodiments for FIGS. 5A and 5B, on applying the voltage across the anode and cathode, the system can be configured to produce hydroxide ions and hydrogen gas at the cathode 201; migrate hydroxide ions from the cathode into the cathode electrolyte 202; migrate cations from the salt solution 211 to the cathode electrolyte 202 through the first cation exchange membrane 206; migrate chloride ions from the salt solution 211 to the anode electrolyte 203 through the anion exchange membrane 213; and migrate protons from the anode 204 to the anode electrolyte 203. Hence, depending on the salt solution 211 used, the system can be configured to produce an alkaline solution, e.g., sodium hydroxide in the cathode electrolyte. The first cation exchange membrane 206 may block the migration of anions from the cathode electrolyte 202 to the salt solution 211, causing the hydroxide ions to accumulate in the cathode electrolyte. The anion exchange membrane 213 may block the migration of cations, e.g., protons from the anode electrolyte 203 to the salt solution 211 causing the protons to accumulate in the anode electrolyte. With reference to FIGS. 5A and 5B, the system in some embodiments includes a second cation exchange membrane 212, attached to the anode 204, such that it separates the anode 204 from the anode electrolyte 203. In this configuration, as the second cation exchange membrane 212 is permeable to cations, protons formed at the anode will migrate to the anode electrolyte as described herein; however, as the second cation exchange membrane 212 is impermeable to anions, e.g., chloride ions, in the anode electrolyte will be blocked from migrating to the anode 204, thereby avoiding interaction between the anode and the anions that may interact with the anode, e.g., by corrosion.

In the system as illustrated in FIGS. 5A and 5B, with the voltage across the anode and cathode, since the salt solution is separated from the cathode electrolyte by the first cation exchange membrane 206, cations in the salt solution, e.g., sodium ions, will migrate through the first cation exchange membrane 206 to the cathode electrolyte 202, and anions, e.g., chloride ions, will migrate to the anode electrolyte 203 through the anion exchange membrane 213. Consequently, in the system, as illustrated in FIGS. 5A and 5B, an acid, e.g., hydrochloric acid 210 will be produced in the anode electrolyte 203, and alkaline solution, e.g., sodium hydroxide will be produced in the cathode electrolyte. With the migration of cations and anions from the salt solution, the system in some embodiments can be configured to produce a partly de-ionized salt solution from the salt solution 211. In some embodiments, this partially de-ionized salt solution can be used as feed-water to a desalination facility (not shown) where it can be further processed to produce desalinated water as described in commonly assigned U.S. Patent Application Publication no. US 2009/0001020, filed on Jun. 27, 2008, herein incorporated by reference in its entirety. In some embodiments, the solution can be used in industrial and agricultural applications where its salinity is acceptable.

With the migration of cations and anions from the salt solution, the system in some embodiments can be configured to produce a partly or fully de-ionized salt solution from the salt solution 211. In some embodiments, this partially de-ionized salt solution can be used as feed-water to a desalination facility (not shown) where it can be further processed to produce desalinated water as described in commonly assigned U.S. Patent Application Publication no. US 2009/0001020, filed on Jun. 27, 2008, herein incorporated by reference in its entirety. In some embodiments, the solution can be used in industrial and agricultural applications where its salinity is acceptable. In some embodiments, the partly de-ionized salt solution may be circulated to the anode electrolyte 203 which may then produce a partly or fully depleted or de-ionized salt solution for further processing, as described herein. Such recirculation of the partly de-ionized salt solution to the anode electrolyte 203 may be carried out in any of the electrochemical cell described herein or any electrochemical cell that is within the scope of the invention.

With reference to figures described herein, the system is configured to direct hydrogen gas from the cathode to the anode. It is to be understood that the systems where the hydrogen gas is not directed towards the anode are well within the scope of the invention. In some embodiments, the voltage across the anode and the cathode can be adjusted such that gas may form at the anode, e.g., oxygen or chlorine gas, while hydroxide ions and hydrogen gas is generated at the cathode. In such embodiments, hydrogen gas is not supplied to the anode. However, in this embodiment, the voltage across the anode and the cathode may generally be higher compared to the embodiments where a gas does not form at the anode and the hydrogen gas is directed from the cathode to the anode.

The systems provided herein may include a hydrogen gas supply system configured to provide hydrogen gas to the anode. In some embodiments, the hydrogen may be obtained from the cathode and/or obtained from an external source, e.g., a commercial hydrogen gas supplier e.g., at start-up of operations when the hydrogen supply from the cathode is insufficient. In some embodiments, the hydrogen delivery system is configured to deliver gas to the anode where oxidation of the gas is catalyzed to protons and electrons. In some embodiments, the hydrogen gas is oxidized to protons and electrons; un-reacted hydrogen gas in the system may be recovered and re-circulated to the anode. The hydrogen delivery system includes any means suitable for directing the hydrogen gas from the cathode or from the external source to the anode. Such means for directing the hydrogen gas from the cathode or from the external source to the anode are well known in the art and include, but not limited to, pipe, duct, conduit, and the like. In some embodiments, the system or the hydrogen delivery system includes a duct that directs the hydrogen gas from the cathode to the anode. It is to be understood that the hydrogen gas may be directed to the anode from the bottom of the cell, top of the cell or sideways. In some embodiments, the hydrogen gas may be directed to the anode through multiple entry ports.

On applying a voltage across the anode and the cathode, protons form at the anode from oxidation of hydrogen gas supplied to the anode, while hydroxide ions and hydrogen gas form at the cathode electrolyte from the reduction of water, as follows:

H₂=2H⁺+2e⁻ (anode, oxidation reaction)

2H₂O+2e⁻=H₂+2OH⁻ (cathode, reduction reaction)

Since protons are formed at the anode from hydrogen gas provided to the anode; and since a gas such as oxygen does not form at the anode; and since water in the cathode electrolyte forms hydroxide ions and hydrogen gas at the cathode, the system can produce hydroxide ions in the cathode electrolyte and protons in the anode electrolyte when a voltage is applied across the anode and cathode. Further, in the systems provided herein, since a gas does not form at the anode, the system produces hydroxide ions in the cathode electrolyte and hydrogen gas at the cathode and hydrogen ions at the anode when less than 3V is applied across the anode and cathode, in contrast to the higher voltage that is required when a gas is generated at the anode, e.g., chlorine or oxygen. For example, in some embodiments, hydroxide ions, bicarbonate ions and/or carbonate ion are produced in the cathode electrolyte when a voltage of 3V or less, 2.9V or less, 2.8V or less, 2.7V or less, 2.6V or less, 2.5V or less, 2.4V or less, 2.3V or less, 2.2V or less, 2.1V or less, 2.0V or less, 1.9V or less, 1.8V or less, 1.7V or less, 1.6V or less, 1.5V or less, 1.4V or less, 1.3V or less, 1.2V or less, 1.1V or less, 1.0V or less, 0.9V or less, 0.8V or less, 0.7V or less, 0.6V or less, 0.5V or less, 0.4V or less, 0.3V or less, 0.2V or less, or 0.1V or less, or 0.05V or less, or between 0.05V-4V, or between 0.05V-3V, or between 0.05V-2.5V, or between 0.05V-2V, or between 0.05V-1.5V, or between 0.05V-1V, or between 0.05V-0.5V, or between 0.05V-0.1V, or between 0.1V-3V, or between 0.1V-2.5V, or between 0.1V-2V, or between 0.1V-1.5V, or between 0.1V-1V, or between 0.1V-0.5V, or between 0.5V-3V, or between 0.5V-2.5V, or between 0.5V-2V, or between 0.5V-1.5V, or between 0.5V-1V, or between 1V-3V, or between 1V-2.5V, or between 1V-2V, or between 1V-1.5V, or between 1.5V-3V, or between 1.5V-2.5V, or between 1.5V-2V, or between 2V-3V, or between 2V-2.5V, or 0.05V, or 0.1V, or 0.5V, or 1V, or 2V, or 3V, is applied across the anode and cathode.

In another embodiment, the voltage across the anode and cathode can be adjusted such that gas is formed at the anode, e.g., oxygen or chlorine, while hydroxide ions, carbonate ions and/or bicarbonate ions are produced in the cathode electrolyte and hydrogen gas is generated at the cathode. However, in this embodiment, hydrogen gas is not supplied to the anode. As can be appreciated by one ordinarily skilled in the art, in this embodiment, the voltage across the anode and cathode will be generally higher compared to the embodiment when a gas does not form at the anode.

In some embodiments, the bicarbonate solution, when contacted with the cathode electrolyte inside the cathode chamber, reacts with the hydroxide ions and produces water and carbonate ions, depending on the pH of the cathode electrolyte. The addition of the bicarbonate solution to the cathode electrolyte may lower the pH of the cathode electrolyte. Thus, depending on the degree of alkalinity desired in the cathode electrolyte, the pH of the cathode electrolyte may be adjusted and in some embodiments is maintained between and 7 and 14 or greater; or between 7 and 13; or between 7 and 12; or between 7 and 11; or between 7 and 10; or between 7 and 9; or between 7 and 8; or between 8 and 14 or greater; or between 8 and 13; or between 8 and 12; or between 8 and 11; or between 8 and 10; or between 8 and 9; or between 9 and 14 or greater; or between 9 and 13; or between 9 and 12; or between 9 and 11; or between 9 and 10; or between 10 and 14 or greater; or between 10 and 13; or between 10 and 12; or between 10 and 11; or between 11 and 14 or greater; or between 11 and 13; or between 11 and 12; or between 12 and 14 or greater; or between 12 and 13; or between 13 and 14 or greater. In some embodiments, the pH of the cathode electrolyte may be adjusted to any value between 7 and 14 or greater, including a pH 7.0, 7.5, 8.0, 8.5. 9.0, 9.5, 10.0, 10.5, 11.0, 11.5, 12.0, 12.5, 13.0, 13.5, 14.0, and/or greater.

Similarly, in some embodiments of the system, the pH of the anode electrolyte is adjusted and is maintained between 0-7; or between 0-6; or between 0-5; or between 0-4; or between 0-3; or between 0-2; or between 0-1, by regulating the concentration of hydrogen ions that migrate into the anode electrolyte from oxidation of hydrogen gas at the anode, and/or the withdrawal and replenishment of anode electrolyte in the system. As the voltage across the anode and cathode may be dependent on several factors including the difference in pH between the anode electrolyte and the cathode electrolyte (as can be determined by the Nernst equation well known in the art), in some embodiments, the pH of the anode electrolyte may be adjusted to a value between 0 and 7, including 0, 0.5, 1.0, 1.5, 2.0, 2.5, 3.0, 3.5, 4.0, 4.5, 5.0, 5.5, 6.0, 6.5 and 7, depending on the desired operating voltage across the anode and cathode. Thus, as can be appreciated, in equivalent systems, where it is desired to reduce the energy used and/or the voltage across the anode and cathode, e.g., as in the chloralkali process, the bicarbonate solution can be added to the cathode electrolyte as disclosed herein to achieve a desired pH difference between the anode electrolyte and cathode electrolyte. Thus, to the extent that such systems utilize the bicarbonate solution, these equivalent systems are within the scope of the present invention.

The system may be configured to produce any desired pH difference between the anode electrolyte and the cathode electrolyte by modulating the pH of the anode electrolyte, the pH of the cathode electrolyte, the concentration of sodium hydroxide in the cathode electrolyte, the concentration of hydrochloric acid in the anode electrolyte, the amount of hydrogen gas from the cathode to the anode, the withdrawal and replenishment of the anode electrolyte, the withdrawal and replenishment of the cathode electrolyte, and/or the amount of the bicarbonate solution added to the cathode electrolyte. By modulating the pH difference between the anode electrolyte and the cathode electrolyte, the operating voltage across the anode and the cathode can be modulated. In some embodiments, the system is configured to produce a pH difference of at least 4 pH units; at least 5 pH units; at least 6 pH units; at least 7 pH units; at least 8 pH units; at least 9 pH units; at least 10 pH units; at least 11 pH units; at least 12 pH units; at least 13 pH units; at least 14 pH units; or between 4-12 pH units; or between 4-11 pH units; or between 4-10 pH units; or between 4-9 pH units; or between 4-8 pH units; or between 4-7 pH units; or between 4-6 pH units; or between 4-5 pH units; or between 3-12 pH units; or between 3-11 pH units; or between 3-10 pH units; or between 3-9 pH units; or between 3-8 pH units; or between 3-7 pH units; or between 3-6 pH units; or between 3-5 pH units; or between 3-4 pH units; or between 5-12 pH units; or between 5-11 pH units; or between 5-10 pH units; or between 5-9 pH units; or between 5-8 pH units; or between 5-7 pH units; or between 5-6 pH units; or between 7-12 pH units; or between 7-11 pH units; or between 7-10 pH units; or between 7-9 pH units; or between 7-8 pH units; or between 8-12 pH units; or between 8-11 pH units; or between 8-10 pH units; or between 8-9 pH units; or between 9-12 pH units; or between 9-11 pH units; or between 9-10 pH units; or between 10-12 pH units; or between 10-11 pH units; or between 11-12 pH units; between the anode electrolyte and the cathode electrolyte. In some embodiments, the system is configured to produce a pH difference of at least 4 pH units between the anode electrolyte and the cathode electrolyte.

In some embodiments, the system is configured to produce the above recited pH difference between the anode electrolyte and the cathode electrolyte when a voltage of 3V or less, 2.9V or less, 2.8V or less, 2.7V or less, 2.6V or less, 2.5V or less, 2.4V or less, 2.3V or less, 2.2V or less, 2.1V or less, 2.0V or less, 1.9V or less, 1.8V or less, 1.7V or less, 1.6V or less, 1.5V or less, 1.4V or less, 1.3V or less, 1.2V or less, 1.1V or less, 1.0V or less, 0.9V or less, 0.8V or less, 0.7V or less, 0.6V or less, 0.5V or less, 0.4V or less, 0.3V or less, 0.2V or less, or 0.1V or less, or 0.05V or less, or between 0.05V-4V, or between 0.05V-3V, or between 0.05V-2.5V, or between 0.05V-2V, or between 0.05V-1.5V, or between 0.05V-1V, or between 0.05V-0.5V, or between 0.05V-0.1V, or between 0.1V-3V, or between 0.1V-2.5V, or between 0.1V-2V, or between 0.1V-1.5V, or between 0.1V-1V, or between 0.1V-0.5V, or between 0.1V-0.05V, or between 0.5V-3V, or between 0.5V-2.5V, or between 0.5V-2V, or between 0.5V-1.5V, or between 0.5V-1V, or between 1V-3V, or between 1V-2.5V, or between 1V-2V, or between 1V-1.5V, or between 2V-3V, or between 2V-2.5V, or 0.05V, or 0.1V, or 0.5V, or 1V, or 2V, or 3V, is applied between the anode and the cathode.

In some embodiments, the cathode electrolyte and/or the anode electrolyte in the systems and methods provided herein include, but are not limited to, saltwater or fresh water. The saltwater includes, but is not limited to, seawater, brine, and/or brackish water. In some embodiments, the cathode electrolyte in the systems and methods provided herein include, but are not limited to, seawater, freshwater, brine, brackish water, sodium hydroxide, or combination thereof. “Saltwater” is employed in its conventional sense to refer to a number of different types of aqueous fluids other than fresh water, where the term “saltwater” includes, but is not limited to, brackish water, sea water and brine (including, naturally occurring subterranean brines or anthropogenic subterranean brines and man-made brines, e.g., geothermal plant wastewaters, desalination waste waters, etc), as well as other salines having a salinity that is greater than that of freshwater. Brine is water saturated or nearly saturated with salt and has a salinity that is 50 parts per million (ppm) or 50 ppt (parts per thousand) or greater. Brackish water is water that is saltier than fresh water, but not as salty as seawater, having a salinity ranging from 0.5 to 35 ppt. Seawater is water from a sea or ocean and has a salinity ranging from 35 to 50 ppt. The saltwater source may be a naturally occurring source, such as a sea, ocean, lake, swamp, estuary, lagoon, etc., or a man-made source. In some embodiments, the cathode electrolyte and/or the anode electrolyte, such as, saltwater includes water containing more than 1% chloride content, such as, NaCl; or more than 10% NaCl; or more than 20% NaCl; or more than 30% NaCl; or more than 40% NaCl; or more than 50% NaCl; or more than 60% NaCl; or more than 70% NaCl; or more than 80% NaCl; or more than 90% NaCl; or between 1-99% NaCl; or between 1-95% NaCl; or between 1-90% NaCl; or between 1-80% NaCl; or between 1-70% NaCl; or between 1-60% NaCl; or between 1-50% NaCl; or between 1-40% NaCl; or between 1-30% NaCl; or between 1-20% NaCl; or between 1-10% NaCl; or between 10-99% NaCl; or between 10-95% NaCl; or between 10-90% NaCl; or between 10-80% NaCl; or between 10-70% NaCl; or between 10-60% NaCl; or between 10-50% NaCl; or between 10-40% NaCl; or between 10-30% NaCl; or between 10-20% NaCl; or between 20-99% NaCl; or between 20-95% NaCl; or between 20-90% NaCl; or between 20-80% NaCl; or between 20-70% NaCl; or between 20-60% NaCl; or between 20-50% NaCl; or between 20-40% NaCl; or between 20-30% NaCl; or between 30-99% NaCl; or between 30-95% NaCl; or between 30-90% NaCl; or between 30-80% NaCl; or between 30-70% NaCl; or between 30-60% NaCl; or between 30-50% NaCl; or between 30-40% NaCl; or between 40-99% NaCl; or between 40-95% NaCl; or between 40-90% NaCl; or between 40-80% NaCl; or between 40-70% NaCl; or between 40-60% NaCl; or between 40-50% NaCl; or between 50-99% NaCl; or between 50-95% NaCl; or between 50-90% NaCl; or between 50-80% NaCl; or between 50-70% NaCl; or between 50-60% NaCl; or between 60-99% NaCl; or between 60-95% NaCl; or between 60-90% NaCl; or between 60-80% NaCl; or between 60-70% NaCl; or between 70-99% NaCl; or between 70-95% NaCl; or between 70-90% NaCl; or between 70-80% NaCl; or between 80-99% NaCl; or between 80-95% NaCl; or between 80-90% NaCl; or between 90-99% NaCl; or between 90-95% NaCl.

In some embodiments, the cathode electrolyte and/or the anode electrolyte includes water containing more than 1% sulfate content or between 1-100% sulfate, such as, sodium sulfate, potassium sulfate, and the like; or more than 10% sulfate; or more than 20% sulfate; or more than 30% sulfate; or more than 40% sulfate; or more than 50% sulfate; or more than 60% sulfate; or more than 70% sulfate; or more than 80% sulfate; or more than 90% sulfate; or between 1-99% sulfate; or between 1-95% sulfate; or between 1-90% sulfate; or between 1-80% sulfate; or between 1-70% sulfate; or between 1-60% sulfate; or between 1-50% sulfate; or between 1-40% sulfate; or between 1-30% sulfate; or between 1-20% sulfate; or between 1-10% sulfate; or between 10-99% sulfate; or between 10-95% sulfate; or between 10-90% sulfate; or between 10-80% sulfate; or between 10-70% sulfate; or between 10-60% sulfate; or between 10-50% sulfate; or between 10-40% sulfate; or between 10-30% sulfate; or between 10-20% sulfate; or between 20-99% sulfate; or between 20-95% sulfate; or between 20-90% sulfate; or between 20-80% sulfate; or between 20-70% sulfate; or between 20-60% sulfate; or between 20-50% sulfate; or between 20-40% sulfate; or between 20-30% sulfate; or between 30-99% sulfate; or between 30-95% sulfate; or between 30-90% sulfate; or between 30-80% sulfate; or between 30-70% sulfate; or between 30-60% sulfate; or between 30-50% sulfate; or between 30-40% sulfate; or between 40-99% sulfate; or between 40-95% sulfate; or between 40-90% sulfate; or between 40-80% sulfate; or between 40-70% sulfate; or between 40-60% sulfate; or between 40-50% sulfate; or between 50-99% sulfate; or between 50-95% sulfate; or between 50-90% sulfate; or between 50-80% sulfate; or between 50-70% sulfate; or between 50-60% sulfate; or between 60-99% sulfate; or between 60-95% sulfate; or between 60-90% sulfate; or between 60-80% sulfate; or between 60-70% sulfate; or between 70-99% sulfate; or between 70-95% sulfate; or between 70-90% sulfate; or between 70-80% sulfate; or between 80-99% sulfate; or between 80-95% sulfate; or between 80-90% sulfate; or between 90-99% sulfate; or between 90-95% sulfate.

In some embodiments, the cathode electrolyte, such as, saltwater, fresh water, and/or sodium hydroxide do not include divalent cations. As used herein, the divalent cations include alkaline earth metal ions, such as but not limited to, calcium, magnesium, barium, strontium, radium, etc. In some embodiments, the cathode electrolyte, such as, saltwater, fresh water, and/or sodium hydroxide include less than 1% w/w divalent cations. Examples of salt water include, but not limited to, seawater, freshwater including sodium chloride, brine, or brackish water. In some embodiments, the cathode electrolyte, such as, seawater, freshwater, brine, brackish water, and/or sodium hydroxide include less than 1% w/w divalent cations. In some embodiments, the cathode electrolyte, such as, seawater, freshwater, brine, brackish water, and/or sodium hydroxide include divalent cations including, but not limited to, calcium, magnesium, and combination thereof. In some embodiments, the cathode electrolyte, such as, seawater, freshwater, brine, brackish water, and/or sodium hydroxide include less than 1% w/w divalent cations including, but not limited to, calcium, magnesium, and combination thereof. In some embodiments, the cathode electrolyte, such as, seawater, freshwater, brine, brackish water, and/or sodium hydroxide include less than 1% w/w; or less than 5% w/w; or less than 10% w/w; or less than 15% w/w; or less than 20% w/w; or less than 25% w/w; or less than 30% w/w; or less than 40% w/w; or less than 50% w/w; or less than 60% w/w; or less than 70% w/w; or less than 80% w/w; or less than 90% w/w; or less than 95% w/w; or between 0.05-1% w/w; or between 0.5-1% w/w; or between 0.5-5% w/w; or between 0.5-10% w/w; or between 0.5-20% w/w; or between 0.5-30% w/w; or between 0.5-40% w/w; or between 0.5-50% w/w; or between 0.5-60% w/w; or between 0.5-70% w/w; or between 0.5-80% w/w; or between 0.5-90% w/w; or between 5-8% w/w; or between 5-10% w/w; or between 5-20% w/w; or between 5-30% w/w; or between 5-40% w/w; or between 5-50% w/w; or between 5-60% w/w; or between 5-70% w/w; or between 5-80% w/w; or between 5-90% w/w; or between 10-20% w/w; or between 10-30% w/w; or between 10-40% w/w; or between 10-50% w/w; or between 10-60% w/w; or between 10-70% w/w; or between 10-80% w/w; or between 10-90% w/w; or between 30-40% w/w; or between 30-50% w/w; or between 30-60% w/w; or between 30-70% w/w; or between 30-80% w/w; or between 30-90% w/w; or between 50-60% w/w; or between 50-70% w/w; or between 50-80% w/w; or between 50-90% w/w; or between 75-80% w/w; or between 75-90% w/w; or between 80-90% w/w; or between 90-95% w/w; of divalent cations including, but not limited to, calcium, magnesium, and combination thereof.

In some embodiments, the cathode electrolyte includes, but not limited to, sodium hydroxide, sodium bicarbonate, sodium carbonate, or combination thereof. In some embodiments, the cathode electrolyte includes, but not limited to, sodium hydroxide. In some embodiments, the cathode electrolyte includes, but not limited to, sodium hydroxide, divalent cations, or combination thereof. In some embodiments, the cathode electrolyte includes, but not limited to, sodium hydroxide, sodium bicarbonate, sodium carbonate, divalent cations, or combination thereof. In some embodiments, the cathode electrolyte includes, but not limited to, sodium hydroxide, calcium bicarbonate, calcium carbonate, magnesium bicarbonate, magnesium carbonate, calcium magnesium carbonate, or combination thereof. In some embodiments, the cathode electrolyte includes, but not limited to, saltwater, sodium hydroxide, bicarbonate brine solution, or combination thereof. In some embodiments, the cathode electrolyte includes, but not limited to, saltwater and sodium hydroxide. In some embodiments, the cathode electrolyte includes, but not limited to, fresh water and sodium hydroxide. In some embodiments, the cathode electrolyte includes, but not limited to, fresh water, sodium hydroxide, sodium bicarbonate, sodium carbonate, divalent cations, or combination thereof.

In some embodiments, the anode electrolyte includes, but not limited to, fresh water and hydrochloric acid. In some embodiments, the anode electrolyte includes, but not limited to, saltwater and hydrochloric acid. In some embodiments, the anode electrolyte includes hydrochloric acid.

As is illustrated in FIGS. 2A, 2B, 3A, and 3B, in some embodiments, the anode electrolyte includes saltwater solution and hydrochloric acid and the cathode electrolyte includes hydroxide. As is illustrated in FIGS. 4A and 4B, in some embodiments, the cathode electrolyte includes saltwater solution and hydroxide and the anode electrolyte includes hydrochloric acid. As is illustrated in FIGS. 5A and 5B, in some embodiments, the cathode electrolyte includes hydroxide and the anode electrolyte includes hydrochloric acid. In some embodiments, the depleted saltwater from the cell may be circulated back to the anode electrolyte. In some embodiments, the cathode electrolyte includes 1-90%; 1-50%; or 1-40%; or 1-30%; or 1-15%; or 1-20%; or 1-10%; or 5-90%; or 5-50%; or 5-40%; or 5-30%; or 5-20%; or 5-10%; or 10-90%; or 10-50%; or 10-40%; or 10-30%; or 10-20%; or 15-20%; or 15-30%; or 20-30%, of the sodium hydroxide solution. In some embodiments, the anode electrolyte includes 0-5 M hydrochloric acid solution; or 0-4.5M; or 0-4M; or 0-3.5M; or 0-3M; or 0-2.5M; or 0-2M; or 0-1.5M; or 0-1M; or 1-5M; or 1-4.5M; or 1-4M; or 1-3.5M; or 1-3M; or 1-2.5M; or 1-2M; or 1-1.5M; or 2-5M; or 2-4.5M; or 2-4M; or 2-3.5M; or 2-3M; or 2-2.5M; or 3-5M; or 3-4.5M; or 3-4M; or 3-3.5M; or 4-5M; or 4.5-5M. In some embodiments, the anode does not form an oxygen gas. In some embodiments, the anode does not form a chlorine gas.

In some embodiments, the cathode electrolyte does not include carbon dioxide gas. In some embodiments, no carbon dioxide is dissolved into the cathode electrolyte of the electrochemical cell. Although carbon dioxide may be present in ordinary ambient air, in view of its very low concentration, ambient carbon dioxide will not provide sufficient carbon dioxide to achieve the formation of the bicarbonate and/or carbonate in the cathode electrolyte as is obtained when bicarbonate solution is contacted with the cathode electrolyte inside the cathode chamber. In some embodiments of the system and method, the pressure inside the electrochemical system may be greater than the ambient atmospheric pressure in the ambient air and hence ambient carbon dioxide may typically be prevented from infiltrating into the cathode electrolyte.

In some embodiments, the system is configured to produce hydroxide ions at the cathode without forming a gas at the anode on applying a voltage across the anode and the cathode. In some embodiments, the system is configured to produce hydroxide ions in the cathode electrolyte and an acid in the anode electrolyte on applying a voltage across the anode and the cathode. In some embodiments, the system is configured to produce acid, such as, but not limited to, hydrochloric acid or sulfuric acid in the anode electrolyte.

In some embodiments, the cathode electrolyte and the anode electrolyte are separated in part or in full by an ion exchange membrane. In some embodiments, the ion exchange membrane is an anion exchange membrane or a cation exchange membrane. In some embodiments, the cation exchange membranes in the electrochemical cell, as disclosed herein, are conventional and are available from, for example, Asahi Kasei of Tokyo, Japan; or from Membrane International of Glen Rock, N.J., or DuPont, in the USA. Examples of cationic exchange membranes include, but not limited to, cationic membrane consisting of a perfluorinated polymer containing anionic groups, for example sulphonic and/or carboxylic groups. However, it may be appreciated that in some embodiments, depending on the need to restrict or allow migration of a specific cation or an anion species between the electrolytes, a cation exchange membrane that is more restrictive and thus allows migration of one species of cations while restricting the migration of another species of cations may be used as, e.g., a cation exchange membrane that allows migration of sodium ions into the cathode electrolyte from the anode electrolyte while restricting migration of hydrogen ions from the anode electrolyte into the cathode electrolyte, may be used. Similarly, it may be appreciated that in some embodiments, depending on the need to restrict or allow migration of a specific anion species between the electrolytes, an anion exchange membrane that is more restrictive and thus allows migration of one species of anions while restricting the migration of another species of anions may be used as, e.g., an anion exchange membrane that allows migration of chloride ions into the anode electrolyte from the cathode electrolyte while restricting migration of hydroxide ions from the cathode electrolyte into the anode electrolyte, may be used. Such restrictive cation and/or anion exchange membranes are commercially available and can be selected by one ordinarily skilled in the art.

In some embodiments, there is provided a system comprising one or more anion exchange membrane, and cation exchange membranes located between the anode and the cathode. In some embodiments, the membranes should be selected such that they can function in an acidic and/or basic electrolytic solution as appropriate. Other desirable characteristics of the membranes include high ion selectivity, low ionic resistance, high burst strength, and high stability in an acidic electrolytic solution in a temperature range of 0° C. to 100° C. or higher, or a alkaline solution in similar temperature range may be used. In some embodiments, a membrane that is stable in the range of 0° C. to 90° C.; or 0° C. to 80° C.; or 0° C. to 70° C.; or 0° C. to 60° C.; or 0° C. to 50° C.; or 0° C. to 40° C., or 0° C. to 30° C., or 0° C. to 20° C., or 0° C. to 10° C., or higher may be used. In some embodiments, a membrane that is stable in the range of 0° C. to 90° C.; or 0° C. to 80° C.; or 0° C. to 70° C.; or 0° C. to 60° C.; or 0° C. to 50° C.; or 0° C. to 40° C., but unstable at higher temperature, may be used. For other embodiments, it may be useful to utilize an ion-specific ion exchange membranes that allows migration of one type of cation but not another; or migration of one type of anion and not another, to achieve a desired product or products in an electrolyte. In some embodiments, the membrane may be stable and functional for a desirable length of time in the system, e.g., several days, weeks or months or years at temperatures in the range of 0° C. to 90° C.; or 0° C. to 80° C.; or 0° C. to 70° C.; or 0° C. to 60° C.; or 0° C. to 50° C.; or 0° C. to 40° C.; or 0° C. to 30° C.; or 0° C. to 20° C.; or 0° C. to 10° C., and higher and/or lower. In some embodiments, for example, the membranes may be stable and functional for at least 1 day, at least 5 days, 10 days, 15 days, 20 days, 100 days, 1000 days, 5-10 years, or more in electrolyte temperatures at 100° C., 90° C., 80° C., 70° C., 60° C., 50° C., 40° C., 30° C., 20° C., 10° C., 5° C. and more or less.

The ohmic resistance of the membranes may affect the voltage drop across the anode and cathode, e.g., as the ohmic resistance of the membranes increase, the voltage across the anode and cathode may increase, and vice versa. Membranes that can be used include, but are not limited to, membranes with relatively low ohmic resistance and relatively high ionic mobility; and membranes with relatively high hydration characteristics that increase with temperatures, and thus decreasing the ohmic resistance. By selecting currently available membranes with lower ohmic resistance, the voltage drop across the anode and cathode at a specified temperature can be lowered.

Scattered through currently available membranes may be ionic channels including acid groups. These ionic channels may extend from the internal surface of the matrix to the external surface and the acid groups may readily bind water in a reversible reaction as water-of-hydration. This binding of water as water-of-hydration may follow first order reaction kinetics, such that the rate of reaction is proportional to temperature. Consequently, currently available membranes can be selected to provide a relatively low ohmic and ionic resistance while providing for improved strength and resistance in the system for a range of operating temperatures.

In some embodiments, the anode in the electrochemical cell is configured to oxidize hydrogen gas (a hydrogen oxidizing anode) to produce hydrogen ions. In some embodiments, the systems provided herein may comprise a gas diffusion anode. In some embodiments, the anode and the second cation exchange membrane may include an integral gas diffusion anode that is commercially available, or can be fabricated as described for example in co-pending and commonly assigned International Patent Application Publication no. WO 2010/093716, titled “Low-voltage alkaline production using hydrogen and electrocatalytic electrodes”, filed Feb. 10, 2010, herein fully incorporated by reference. It is to be understood that the gas diffusion anode is illustrated as an example only and any conventional anode that can be configured to oxidize hydrogen gas (a hydrogen oxidizing anode) to produce hydrogen, can be utilized.

In some embodiments, e.g. as illustrated in FIGS. 3A and 3B, the anode may be a gas diffusion anode including an ion exchange membrane, e.g., a cation exchange membrane 212 that contacts the second side 604 of the anode. In such embodiments, the ion exchange membrane can be used to allow or prevent migration of ions to or from the anode. Thus, for example, with reference to FIG. 3A, when protons are generated at the anode, a cation exchange membrane may be used to facilitate the migration of the protons from the anode and/or block the migration of ions, e.g., cations to the substrate. In the some embodiments, the ion exchange membrane may be selected to preferentially allow passage of one type of cation, e.g., hydrogen ions, while preventing the passage of another type of ions, e.g., sodium ions.

In some embodiments, the systems provided herein include the saltwater from terrestrial brine. In some embodiments, the depleted saltwater withdrawn from the electrochemical cells is replenished with sodium chloride and re-circulated back in the electrochemical cell. In some embodiments, the depleted saltwater withdrawn from the electrochemical cell is re-circulated to the anode chamber of the electrochemical cell.

In some embodiments of the electrochemical cells herein, the system is configured to produce carbonate ions by a reaction of the bicarbonate ions from the bicarbonate solution with sodium hydroxide from the cathode electrolyte. The contacting of the bicarbonate solution with the cathode electrolyte may be outside the cathode chamber and/or inside the cathode chamber. In some embodiments, the bicarbonate solution may be contacted with the cathode electrolyte inside the cathode chamber and after withdrawing or recovering the cathode electrolyte containing hydroxide and/or bicarbonate and/or carbonate, the cathode electrolyte may be again contacted with the bicarbonate solution outside the cathode chamber to react any un-reacted hydroxide with the bicarbonate to produce the carbonate.

The degree of conversion of bicarbonate to carbonate in the presence of sodium hydroxide may be dependent on the concentration of the sodium hydroxide produced by the cathode; the concentration of the bicarbonate solution reacted with the sodium hydroxide; and/or pH of the cathode electrolyte. The amount of bicarbonate converted to the carbonate in the presence of sodium hydroxide, outside the cathode chamber and/or inside the cathode chamber, may be 100%; or more than 90%; or more than 80%; or more than 70%; or more than 60%; or more than 50%; or more than 40%; or more than 30%; or more than 20%; or more than 10%; or more than 5%; or more than 1%; or between 1-99%; or between 1-90%; or between 1-80%; or between 1-70%; or between 1-60%; or between 1-50%; or between 1-40%; or between 1-30%; or between 1-20%; or between 1-10%; or between 5-99%; or between 5-90%; or between 5-80%; or between 5-70%; or between 5-60%; or between 5-50%; or between 5-40%; or between 5-30%; or between 5-20%; or between 5-10%; or between 10-99%; or between 10-90%; or between 10-80%; or between 10-70%; or between 10-60%; or between 10-50%; or between 10-40%; or between 10-30%; or between 10-20%; or between 20-99%; or between 20-90%; or between 20-80%; or between 20-70%; or between 20-60%; or between 20-50%; or between 20-40%; or between 20-30%; or between 30-99%; or between 30-90%; or between 30-80%; or between 30-70%; or between 30-60%; or between 30-50%; or between 30-40%; or between 40-99%; or between 40-90%; or between 40-80%; or between 40-70%; or between 40-60%; or between 40-50%; or between 50-99%; or between 50-90%; or between 50-80%; or between 50-70%; or between 50-60%; or between 60-99%; or between 60-90%; or between 60-80%; or between 60-70%; or between 70-99%; or between 70-90%; or between 70-80%; or between 80-99%; or between 80-90%; or between 90-100%; or between 90-99%.

The system in some embodiments includes a cathode electrolyte circulating system adapted for withdrawing and circulating cathode electrolyte in the system. In one embodiment, the cathode electrolyte circulating system includes a bicarbonate solution contactor outside the cathode chamber that is adapted for contacting the bicarbonate solution with the circulating cathode electrolyte, and for re-circulating the electrolyte in the system. As can be appreciated, since the pH of the cathode electrolyte can be adjusted by withdrawing and/or circulating cathode electrolyte/bicarbonate solution from the system, the pH of the cathode electrolyte compartment can be regulated by regulating an amount of cathode electrolyte removed from the system, passed through the bicarbonate solution contactor, and/or re-circulated back into the cathode chamber.

In some embodiments, the systems provided herein include a contact system configured to contact the bicarbonate solution to the cathode electrolyte. The system or the contact system includes any means suitable for contacting the bicarbonate solution with the cathode electrolyte inside and/or outside the cathode chamber. Such means for directing the bicarbonate solution to the cathode electrolyte inside a cathode chamber are well known in the art and include, but not limited to, injection, pipe, duct, conduit, and the like. In some embodiments, the system or the contact system in the system includes a duct or a conduit that directs the bicarbonate solution to the cathode electrolyte inside a cathode chamber. It is to be understood that when the bicarbonate solution is contacted with the cathode electrolyte inside the cathode chamber, the bicarbonate solution may be injected to the cathode electrolyte from the bottom of the cell, top of the cell, from the side inlet in the cell, and/or from a combination of such entry ports depending on the amount of bicarbonate solution desired in the cathode chamber. The amount of bicarbonate solution inside the cathode chamber may be dependent on the flow rate of the solution, desired pH of the cathode electrolyte, and/or size of the cell. Such optimization of the amount of the bicarbonate solution is well within the scope of the invention.

For the systems where the bicarbonate solution 205 is contacted with the cathode electrolyte 202 outside the cathode chamber, the sodium hydroxide containing cathode electrolyte may be withdrawn from the cathode chamber and may be added to a contact system configured to contact the bicarbonate solution with the cathode electrolyte. Such contact system can be a container, pipe, duct, tank, conduit, or the like. For example, the container may have an input for the bicarbonate solution such as a pipe or conduit, etc. or a pipeline in communication with a subterranean brine. The container may also be in fluid communication with a reactor where the bicarbonate solution may be produced, modified, and/or stored. The contact system for contacting the bicarbonate solution with the cathode electrolyte outside the cathode chamber may be equipped with inputs for other reagents for controlling the pH, stirrers, temperature sensor, and the like.

In some embodiments, the source of the bicarbonate solution may be a tanks or series of tanks containing the bicarbonate solution which is then connected to the input for the bicarbonate solution for contacting with the cathode electrolyte inside the cathode chamber and/or outside the cathode chamber.

The methods and systems of the invention may also include producing one or more bore holes (i.e., well bore) in the subterranean formation to connect the subterranean brine to the system of the invention, such as, to connect to the input for the bicarbonate brine or the bicarbonate solution. One or more bore holes can be produced in the subterranean formation by employing any suitable protocol. For instance, bore holes may be produced using conventional excavation drilling techniques, e.g., particle jet drilling, rotary mechanical drilling, rotary blasthole drilling, hole openers, rock reamers, flycutters, turbine-motor drilling, thermal spallation drilling, high power pulse laser drilling or any combination thereof. The bore holes may be drilled to any depth as desired, depending upon the thickness of the walls and porosity of the subterranean formation. In some embodiments, the bore holes may extend to a depth of 1 meter or deeper into the subterranean formation, such as 5 meters or deeper into the subterranean formation, such as 10 meters or deeper into the subterranean formation, such as 20 meters or deeper into the subterranean formation, such as 30 meters or deeper into the subterranean formation, such as 40 meters or deeper into the subterranean formation, such as 50 meters or deeper into the subterranean formation, such as 75 meters or deeper into the subterranean formation, including 100 meters or 200 m or 300 m or 500 m deeper into the subterranean formation. The diameter of the bore hole may also vary, depending upon the nature and the porosity of the subterranean formation. In some embodiments, the diameter of the bore hole ranges, e.g., from 5 to 100 cm, such as 10 to 90 cm, such as 10 to 90 cm, such as 20 to 80 cm, such as 25 to 75 cm, and including 30 to 50 cm.

After producing one or more bore holes in the subterranean formation, methods of the invention may also include inserting one or more conduits into the bore hole. The conduit includes a tube, pipeline or an analogous structure configured to convey a gas or liquid from one location to another. Conduits of the invention may vary in shape, where the cross-section of the conduit may be circular, rectangular, oblong, square, etc. The diameter of the conduit may also vary, depending on the size of the bore hole as well as the nature of the composition (e.g., viscosity), ranging from 5 to 100 cm, such as 10 to 90 cm, such as 10 to 90 cm, such as 20 to 80 cm, such as 25 to 75 cm, and including 30 to 50 cm. Depending on the depth of the subterranean formation, the wall thicknesses of the conduit may vary, ranging in some embodiments from 0.5 to 25 cm or thicker, such as 1 to 15 cm or thicker, such as 1 to 10 cm or thicker, including 1 to 5 cm or thicker. In some embodiments, conduits may be designed to support high internal pressure from the flow of the brine composition. In other embodiments, the conduit may be designed to support high external loadings (e.g., external hydrostatic pressures, earth loads, etc.). Conduits may be inserted to any depth into the subterranean formation, as desired, e.g., to a depth of 0.5 meter or deeper into the subterranean formation, such as 1 meters or deeper into the subterranean formation, such as 2 meters or deeper into the subterranean formation, such as 3 meters or deeper into the subterranean formation, such as 4 meters or deeper into the subterranean formation, such as 5 meters or deeper into the subterranean formation, including 10 meters or 100 meters, or 200 meters or 300 meters deeper into the subterranean formation. In some embodiments, conduits of the invention are two-way delivery units such that a single conduit may be employed to both introduce a fluid composition into the subterranean formation as well as withdraw a fluid composition from within the subterranean brine. For example, in some instances a conduit may be employed to introduce water into the subterranean formation. In some embodiments, the same conduit may be employed to withdraw the bicarbonate brine from within the subterranean formation at a same time or later time. In other words, conduits may be configured to both convey a fluid composition into the subterranean formation as well as withdraw a fluid composition from within the subterranean formation.

Brines disposed within the subterranean formation may be removed by any convenient protocol, such as, but not limited to, employing an oil-field pump, down-well turbine motor pump, rotary lobe pump, hydraulic pump, fluid transfer pump, geothermal well pump, a water-submersible vacuum pump, or surface-located brine pump, among other protocols. It is to be understood that the above recited methods and systems to collect a subterranean brine may be used for some embodiments of the invention where a subterranean carbonate brine, or an alkaline brine, or a hard brine, or an alkaline hard brine is desired. Brine disposed within the subterranean formation may be used in any methods of this invention, for example, as a source of alkalinity, source of carbonate brine, source of bicarbonate brine, source of cations, such as, divalent cations, and/or combinations thereof.

In some embodiments, the bicarbonate solution is contacted with the cathode electrolyte, with the flow rate of greater than 1 mL/min; or greater than 10 mL/min; or greater than 25 mL/min; or greater than 50 mL/min; or greater than 100 mL/min; or from 1 mL/min to 100 L/min; or from 1 mL/min to 75 L/min; or from 1 mL/min to 50 L/min; or from 1 mL/min to 40 L/min; or from 1 mL/min to 30 L/min; or from 1 mL/min to 20 L/min; or from 1 mL/min to 10 L/min; or from 1 mL/min to 5 L/min; or from 5 mL/min to 100 L/min; or from 5 mL/min to 50 L/min; or from 5 mL/min to 40 L/min; or from 5 mL/min to 30 L/min; or from 5 mL/min to 20 L/min; or from 5 mL/min to 10 L/min; or from 10 mL/min to 100 L/min; or from 10 mL/min to 50 L/min; or from 10 mL/min to 40 L/min; or from 10 mL/min to 30 L/min; or from 10 mL/min to 20 L/min; or from 10 mL/min to 15 L/min; or from 20 mL/min to 100 L/min; or from 20 mL/min to 50 L/min; or from 20 mL/min to 40 L/min; or from 20 mL/min to 30 L/min; or from 30 mL/min to 100 L/min; or from 30 mL/min to 50 L/min; or from 30 mL/min to 40 L/min; or from 30 mL/min to 35 L/min; or from 40 mL/min to 100 L/min; or from 40 mL/min to 50 L/min; or from 40 mL/min to 45 L/min; or from 50 mL/min to 100 L/min; or from 50 mL/min to 75 L/min. The concentration of the bicarbonate solution that is contacted with the cathode electrolyte inside and/or outside the cathode chamber is described below.

In some embodiments, the systems of the invention may include a heat exchanger to collect and utilize excess thermal energy from subterranean brines. The heat exchanger may be an open loop or closed loop configuration to collect heat from the brine. Thermal energy may be converted to electrical energy using a steam generator or any device known in the art for generating electrical energy from an aqueous geothermal source. Thermal energy may be used to run the electrochemical process at a desired temperature, dry the precipitate or the compositions provided herein.

In some embodiments, the cathode and the anode may be operatively connected to an off-peak electrical power-supply system that supplies off-peak voltage to the electrodes. Since the cost of off-peak power is lower than the cost of power supplied during peak power-supply times, the system can utilize off-peak power to produce an alkaline solution in the cathode electrolyte at a relatively lower cost.

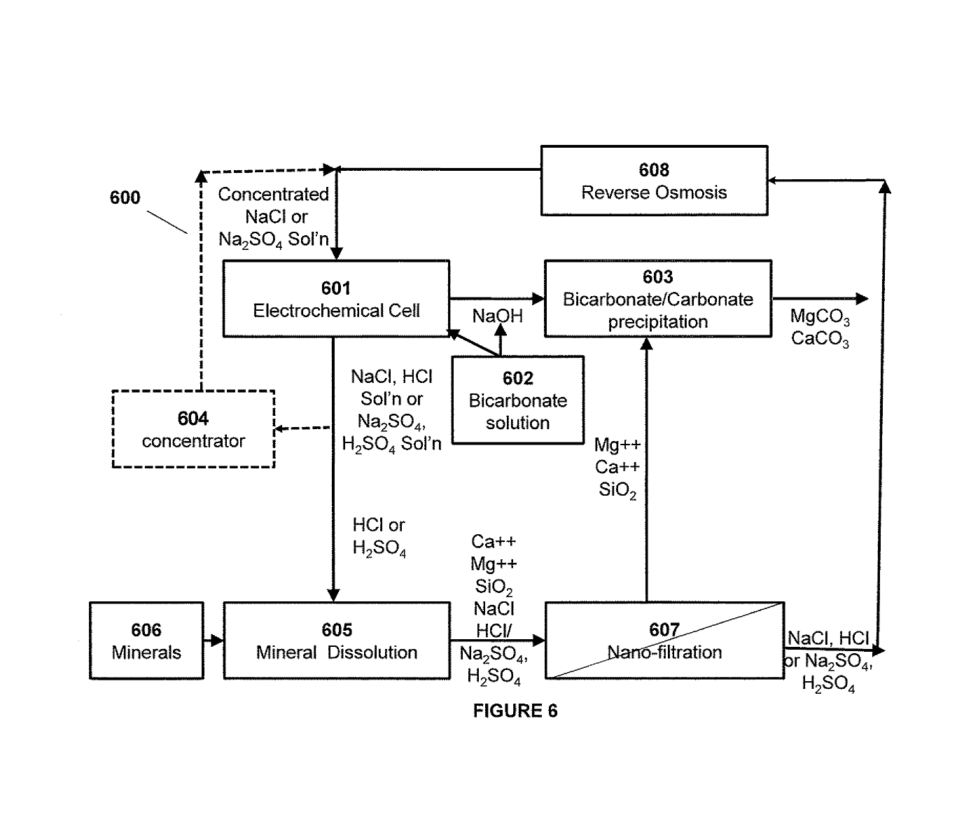

FIG. 6 illustrates a flow diagram 600 for some embodiments where the electrochemical cell is integrated with other processes to recycle the spent solutions, thereby reducing the overall energy consumption of the process. In some embodiments, the alkaline solution produced by the electrochemical cell 601 may be contacted with the bicarbonate solution 602 inside the cathode chamber and/or outside the cathode chamber to produce a bicarbonate/carbonate ion solution. The bicarbonate/carbonate ion solution or substantially carbonate ion solution 603 may be then treated with the divalent cations, e.g., calcium, magnesium, or combination thereof, to precipitate the bicarbonate and/or carbonate, e.g., calcium carbonate, magnesium carbonate, calcium bicarbonate, magnesium bicarbonate, calcium magnesium carbonate, or combination thereof. The calcium carbonate, magnesium carbonate, calcium bicarbonate, magnesium bicarbonate, calcium magnesium carbonate, or combination thereof, form cementitous compositions. The sodium chloride or the sodium sulfate solution withdrawn from the electrochemical cell 601 may optionally be concentrated in the concentrator 604 before being injected back into the electrochemical cell 601. The sodium chloride may be separated from hydrochloric acid or sodium sulfate may be separated from the sulfuric acid after being removed from the electrochemical cell. The hydrochloric acid or the sulfuric acid produced by the electrochemical cell 601 may be subjected to a mineral dissolution system 605 which may be configured to dissolve minerals 606, such as mafic and/or ultramafic minerals, e.g., serpentine, olivine, etc. and produce a mineral solution comprising divalent cations, e.g., calcium and/or magnesium and/or silica, etc. The mineral solution may then be filtered via nano filtration system 607 to separate the divalent cations, such as calcium, magnesium, silica, etc. from sodium chloride and HCl or from sodium sulfate and sulfuric acid. The divalent cations may then be treated with the bicarbonate/carbonate solution 603 to form carbonate compositions, such as, calcium carbonate, magnesium carbonate, calcium bicarbonate, magnesium bicarbonate, calcium magnesium carbonate, or combination thereof. The filtrate containing the sodium chloride and HCl or from sodium sulfate and sulfuric acid may then be subjected to reverse osmosis system 608 to concentrate the sodium chloride or sodium sulfate solution before injecting it back into the electrochemical cell 601. It is to be understood that FIG. 6 is for illustration purposes only and does not in any way limit the scope of the invention. Some of the steps of FIG. 6 may be omitted, modified, or rearranged in order, for the methods and systems provided herein.

As illustrated in FIG. 6, in some embodiments, the anode electrolyte including an acid, e.g., hydrochloric acid or sulfuric acid, and a depleted salt solution including low amount sodium ions, is operatively connected to a system for further processing of the acid, e.g., a mineral dissolution system 605 that is configured to dissolve minerals and produce a mineral solution including calcium ions and/or magnesium ions, e.g., mafic minerals such as olivine and serpentine. In some embodiments, not shown in FIG. 6, the acid may be used for other purposes in addition to or instead of mineral dissolution. Such uses include, but are not limited to, use as a reactant in production of cellulosic biofuels, use in the production of polyvinyl chloride (PVC), and the like. System appropriate to such uses may be operatively connected to the electrochemical unit, or the acid may be transported to the appropriate site for use.

In some embodiments, the system further includes a water treatment system configured for several uses, e.g., to dilute the brine, the hydrochloric acid, the sulfuric acid, the cathode electrolyte, and/or anode electrolyte. Such water treatment systems are described in U.S. Patent Application Publication No. US 2010/0200419, filed 10 Feb. 2010, which is incorporated herein by reference in its entirety.

In some embodiments, hydroxide ions, carbonate ions and/or bicarbonate ions produced in the cathode electrolyte, and hydrochloric acid or sulfuric acid produced in the anode electrolyte are removed from the system, while sodium chloride or sodium sulfate in the salt solution electrolyte is replenished to maintain continuous operation of the system. As can be appreciated, in some embodiments, the system can be configured to operate in various production modes including batch mode, semi-batch mode, continuous flow mode, with or without the option to withdraw portions of the hydroxide solution produced in the cathode electrolyte, or withdraw all or a portion of the acid produced in the anode electrolyte, or direct the hydrogen gas produced at the cathode to the anode where it may be oxidized.

Depending on the flow rate of fluids into and out of the cathode electrolyte, the concentration of the sodium hydroxide solution, and the concentration of the bicarbonate solution in the cathode electrolyte, and the pH of the cathode electrolyte may adjust, e.g., the pH may increase, decrease or remain the same. In some embodiments, the pH of the cathode electrolyte decreases after contacting with the bicarbonate solution. Depending on the pH of the cathode electrolyte, the bicarbonate solution contacted with the cathode electrolyte reacts with the sodium hydroxide in the cathode electrolyte and reversibly dissociates and equilibrates to produce water and carbonate ions in the cathode electrolyte compartment as follows:

OH⁻+HCO₃⁻<==>H₂O+CO₃²⁻

The exiting solution from the cathode electrolyte may include sodium hydroxide, bicarbonate ions, and/or carbonate ions. The overall cell potential of the system can be determined through the Gibbs energy change of the reaction by the formula:

E_{cell}=−ΔG/nF

or, at standard temperature and pressure conditions:

E°_{cell}=−ΔG°/nF

where, E_{cell} is the cell voltage, ΔG is the Gibbs energy of reaction, n is the number of electrons transferred, and F is the Faraday constant (96485 J/Vmol). The E_{cell} of each of these reactions is pH dependent based on the Nernst equestion.

Also, the overall cell potential can be determined through the combination of Nernst equations for each half cell reaction:

E=E°−RT ln(Q)/nF

where, E° is the standard reduction potential, R is the universal gas constant, (8.314 J/mol K), T is the absolute temperature, n is the number of electrons involved in the half cell reaction, F is Faraday's constant (96485 J/V mol), and Q is the reaction quotient such that:

Eₜₒₜₐₗ=E_{cathode}+E_{anode}

When hydrogen is oxidized to protons at the anode as follows:

H₂=2H⁺+2e⁻,

E° is 0.00 V, n is 2, and Q is the square of the activity of H⁺ so that:

E_{anode}=+0.059 pHₐ,

where pHₐ is the pH of the anode electrolyte.

When water is reduced to hydroxide ions and hydrogen gas at the cathode as follows:

2H₂O+2e⁻=H₂+2OH⁻,

E° is −0.83 V, n is 2, and Q is the square of the activity of OH⁻ so that:

E_{cathode}=−0.059 pH_{c},

where pH_{c} is the pH of the cathode electrolyte.

The E for the cathode and the anode reactions varies with the pH of the anode and cathode electrolytes. Thus, if the anode reaction, which is occurring in an acidic environment, is at a pH of 0, then the E of the reaction is 0V for the half cell reaction. For the cathode reaction, if the generation of bicarbonate ions occur at a pH of 7, then the theoretical E is 7×(−0.059 V)=−0.413V for the half cell reaction where a negative E means energy is needed to be input into the half cell or full cell for the reaction to proceed. Thus, if the anode pH is 0 and the cathode pH is 7 then the overall cell potential would be −0.413V, where:

Eₜₒₜₐₗ=−0.059 (pHₐ−pH_{c})=−0.059 ΔpH.

Thus, in some embodiments, directing bicarbonate solution into the cathode electrolyte may lower the pH of the cathode electrolyte by producing bicarbonate ions and/or carbonate ions in the cathode electrolyte, which consequently may lower the voltage across the anode and cathode.

Thus, as can be appreciated, if the cathode electrolyte is allowed to increase to a pH of 14 or greater, the difference between the anode half-cell potential and the cathode half cell potential will increase to 0.83V. With increased duration of cell operation without bicarbonate solution addition or other intervention, e.g., diluting with water, the required cell potential will continue to increase. The cell potential may also increase due to ohmic resistance losses across the membranes in the electrolyte and the cell's overvoltage potential. Herein, an overvoltage potential includes the voltage difference between a thermodynamically determined half-cell reduction potential, and the experimentally observed potential at which the redox reaction occurs. The overvoltage potential is related to cell voltage efficiency as the overvoltage potential requires more energy than is thermodynamically required to drive a reaction. In each case, the extra energy is lost as heat. Overvoltage potential is specific to each cell design and will vary between cells and operational conditions even for the same reaction.

In one aspect, the methods provided herein include one or more of the following steps: contacting an anode with an anode electrolyte, contacting a cathode with a cathode electrolyte, contacting a bicarbonate solution with the cathode electrolyte, and applying a voltage across the anode and the cathode. The bicarbonate solution is contacted with the cathode electrolyte inside the cathode chamber and/or outside the cathode chamber. The methods provided herein include producing an alkaline solution in the cathode electrolyte by applying a voltage of less that 3V, or less than 2V, or less than 1V, or between 0.05-1V across the cathode and an anode without producing a gas at the anode. In some embodiments of the method, a first cation exchange membrane is partitioned between the anode electrolyte and the cathode electrolyte. In some embodiments of the method, the alkaline solution in the cathode electrolyte includes hydroxide ions and/or bicarbonate ions and/or carbonate ions. In some embodiments of the method, the method further includes producing the bicarbonate solution. In some embodiments of the method, the method further includes treating the bicarbonate ions and/or carbonate ions with the divalent cations to produce carbonate compositions.

In one aspect, the methods provided herein include one or more of the following steps: contacting an anode with an anode electrolyte, contacting a cathode with a cathode electrolyte, contacting a bicarbonate solution with the cathode electrolyte, and applying a voltage across the anode and the cathode. The bicarbonate solution is contacted with the cathode electrolyte inside the cathode chamber and/or outside the cathode chamber. The methods provided herein include producing an alkaline solution in the cathode electrolyte by applying a voltage of less that 3V, or less than 2V, or less than 1V, or between 0.05-1V across the cathode and an anode without producing a gas at the anode. In some embodiments of the method, a first cation exchange membrane is partitioned between the anode electrolyte and the cathode electrolyte. In some embodiments of the method, the anode is in contact with a second cation exchange membrane that separates the anode from the anode electrolyte. In some embodiments of the method, the alkaline solution in the cathode electrolyte includes hydroxide ions and/or bicarbonate ions and/or carbonate ions. In some embodiments, the method provided herein include one or more steps: the ambient air is excluded in the cathode electrolyte; a pH of between and 7 and 14 or greater is maintained in the cathode electrolyte; a pH of from less than 0 and up to 7 is maintained in the anode electrolyte; hydrogen gas is oxidized at the anode to produce hydrogen ions and hydrogen ions are migrated from the anode through the second cation exchange membrane into the anode electrolyte; hydroxide ions and hydrogen gas are produced at the cathode; hydroxide ions are migrated from the cathode into the cathode electrolyte; hydrogen gas is directed from the cathode to the anode; cations are migrated from the anode electrolyte through the first cation exchange membrane into the cathode electrolyte wherein the cations comprise sodium ions. In some embodiments, the anions are migrated from the cathode electrolyte through the anion exchange membrane into the anode electrolyte wherein the anions include chloride ions. In some embodiments, the anions are migrated from the sodium chloride solution through the anion exchange membrane into the anode electrolyte and cations are migrated from the sodium chloride through the first cation exchange membrane into the cathode electrolyte.

In some embodiments, the methods provided herein include one or more of the following steps: applying a voltage across a cathode and a gas diffusion anode in an electrochemical system, wherein the cathode contacts a cathode electrolyte. In some embodiments, the method includes providing hydrogen to the gas diffusion anode; contacting the cathode with a cathode electrolyte; and applying a voltage across the anode and cathode; directing hydrogen gas from the cathode to the anode; interposing an anion exchange membrane between the anode electrolyte and the salt solution; interposing a first cation exchange membrane between the cathode electrolyte and the salt solution, where the salt solution is contained between the anion exchange membrane and the first cation exchange membrane; where anions migrate from the salt solution to the anode electrolyte through the anion exchange membrane, and cations migrate from the salt solution to the cathode electrolyte through the first cation exchange membrane; producing hydroxide ions and/or carbonate ions and/or bicarbonate ions in the cathode electrolyte; producing an acid in the anode electrolyte; producing sodium hydroxide and/or sodium carbonate and/or sodium bicarbonate in the cathode electrolyte; whereby protons are migrated from the anode to the anode electrolyte; whereby hydrochloric acid is produced in the anode electrolyte; producing partially desalinated water from the salt solution; withdrawing a first portion of the cathode electrolyte and contacting the portion of cathode electrolyte with bicarbonate solution; and contacting the portion of cathode electrolyte and the bicarbonate solution with a divalent cation solution; whereby protons are produced at the anode and hydroxide ions and hydrogen gas produced at the cathode; whereby a gas is not produced at the anode when the voltage is applied across the anode and cathode; where the voltage applied across the anode and cathode is less than 2V.

In some embodiments, hydroxide ions are formed at the cathode and in the cathode electrolyte by applying a voltage of less than 2V across the anode and cathode without forming a gas at the anode, while providing hydrogen gas at the anode for oxidation at the anode. In some embodiments, the methods do not form a gas at the anode when the voltage applied across the anode and cathode is less than 3V or less, 2.9V or less, 2.8V or less, 2.7V or less, 2.6V or less, 2.5V or less, 2.4V or less, 2.3V or less, 2.2V or less, 2.1V or less, 2.0V or less, 1.9V or less, 1.8V or less, 1.7V or less, 1.6V or less, 1.5V or less, 1.4V or less, 1.3V or less, 1.2V or less, 1.1V or less, 1.0V or less, 0.9V or less, 0.8V or less, 0.7V or less, 0.6V or less, 0.5V or less, 0.4V or less, 0.3V or less, 0.2V or less, or 0.1V or less, or between 0.1V-3V, or between 0.1V-2.5V, or between 0.1V-2V, or between 0.1V-1.5V, or between 0.1V-1V, or between 0.1V-0.5V, or between 0.05-1, or between 0.05-2V, while hydrogen gas is provided to the anode where it is oxidized to protons. As will be appreciated by one ordinarily skilled in the art, by not forming a gas at the anode and by providing hydrogen gas to the anode for oxidation at the anode; by adding bicarbonate solution to the cathode electrolyte inside the cathode chamber; by controlling the resistance in the system, for example, by decreasing the electrolyte path lengths; and by selecting ionic membranes with low resistance and any other method know in the art, hydroxide ions can be produced in the cathode electrolyte with the lower voltages, as described herein.

In some embodiments, hydroxide ions, bicarbonate ions and carbonate ions are produced in the cathode electrolyte where the voltage applied across the anode and cathode is less than 3V or less, 2.9V or less, 2.8V or less, 2.7V or less, 2.6V or less, 2.5V or less, 2.4V or less, 2.3V or less, 2.2V or less, 2.1V or less, 2.0V or less, 1.9V or less, 1.8V or less, 1.7V or less, 1.6V or less, 1.5V or less, 1.4V or less, 1.3V or less, 1.2V or less, 1.1V or less, 1.0V or less, 0.9V or less, 0.8V or less, 0.7V or less, 0.6V or less, 0.5V or less, 0.4V or less, 0.3V or less, 0.2V or less, or 0.1V or less, or between 0.1V-3V, or between 0.1V-2.5V, or between 0.1V-2V, or between 0.1V-1.5V, or between 0.1V-1V, or between 0.1V-0.5V, or between 0.05-1, or between 0.05-2V, without forming a gas at the anode. In some embodiments, the method may be adapted to withdraw and replenish at least a portion of the cathode electrolyte and the acid in the anode electrolyte back into the system in either a batch, semi-batch or continuous mode of operation.

In some embodiments, the method includes producing sodium hydroxide and/or sodium carbonate ions and/or sodium bicarbonate ions in the cathode electrolyte; producing an acid and a depleted salt solution in the anode electrolyte including sodium ions and chloride ions; utilizing the anode electrolyte to dissolve minerals and produce a mineral solution comprising calcium ions and/or magnesium ions, wherein the minerals comprises mafic minerals; filtering the mineral solution to produce a filtrate comprising sodium ions and chloride ions; concentrating the filtrate to produce the salt solution, wherein the concentrator comprises a reverse osmosis system; utilizing the salt solution as the anode electrolyte; precipitating a carbonate and/or bicarbonate with the cathode electrolyte; wherein the carbonate and/or bicarbonate comprises calcium and/or magnesium carbonate and/or bicarbonate. In some embodiments, the method includes disposing of the acid in an underground storage site where the acid can be stored in an un-reactive salt or rock formation and hence does not cause an environmental acidification.

With reference to figures, the method in some embodiment includes producing an acid in an electrochemical system and contacting a mineral 606 with the acid. In some embodiments, the method further produces the acid in the anode electrolyte 203, without generating a gas at the anode 204, and oxidizing hydrogen gas 207 at the anode, wherein the acid comprises hydrochloric acid 210; and wherein the hydrogen gas 207 is produced at the cathode 201; producing an alkaline solution in the cathode electrolyte 202; migrating sodium ions into the cathode electrolyte; wherein the alkaline solution comprises sodium hydroxide, sodium bicarbonate and/or sodium carbonate; wherein the voltage is less than 2V or less than 1V; wherein the anode electrolyte 203 is separated from the cathode electrolyte 202 by first cation exchange membrane 206; wherein the anode 204 includes a second cation exchange membrane 212 in contact with the anode electrolyte 203; wherein the anode electrolyte comprises a salt, e.g., sodium chloride; dissolving a mineral 106 with the acid 210 to produce a mineral solution; producing calcium ions and/or magnesium ions; wherein the mineral comprises a mafic mineral, e.g. olivine or serpentine; filtering the mineral solution to produce a filtrate comprising sodium ions and chloride ions solution; concentrating the filtrate to produce a salt solution; utilizing the salt solution as the anode electrolyte 203; precipitating a carbonate and/or bicarbonate with the cathode electrolyte 202 by contacting the divalent cations with the cathode electrolyte; wherein the carbonate and/or bicarbonate includes calcium and/or magnesium carbonate and/or bicarbonate. In some embodiments, the method includes disposing of the acid in an underground storage site where the acid can be stored in an un-reactive salt or rock formation and hence does not cause an environmental acidification.

In some embodiments, the anode electrolyte and the cathode electrolyte in the electrochemical cell, in the methods and systems provided herein, are operated at room temperature or at elevated temperatures, such as, e.g., at more than 40° C., or more than 50° C., or more than 60° C., or more than 70° C., or more than 80° C., or between 30-70° C.

In some embodiments, the method further includes producing the bicarbonate solution. In some embodiments of the method, the method further includes treating the bicarbonate ions and/or carbonate ions with the divalent cations to produce carbonate compositions. These methods have been described in detail below.

In some embodiments, depending on the ionic species desired in the cathode electrolyte and/or the anode electrolyte and/or the salt solution, alternative reactants can be utilized. Thus, for example, if a potassium salt such as potassium hydroxide or potassium carbonate is desired in the cathode electrolyte, then a potassium salt such as potassium chloride can be utilized in the salt solution. Similarly, if sulfuric acid is desired in the anode electrolyte, then a sulfate such as sodium sulfate can be utilized in the salt solution.

### C. Methods and Systems to Produce Carbonate Compositions

The methods and systems provided herein are further configured to process the sodium carbonate/sodium bicarbonate solution obtained after the alkaline solution, such as, the cathode electrolyte is contacted with the bicarbonate solution. As described herein, the bicarbonate solution after being contacted with the alkaline solution, such as, sodium hydroxide in the cathode electrolyte, results in carbonate formation. Depending on the pH of the cathode electrolyte, the bicarbonate in the bicarbonate solution may fully convert to carbonate or may partially convert to carbonate. In some embodiments, more than 5%; or more than 10%; or more than 20%; or more than 30%; or more than 40%; or more than 50%; or more than 60%; or more than 70%; or more than 80%; or more than 90%; or between 5-99%; or between 5-90%; or between 5-80%; or between 5-70%; or between 5-60%; or between 5-50%; or between 5-40%; or between 5-30%; or between 5-20%; or between 5-10%; or between 10-99%; or between 10-90%; or between 10-80%; or between 10-70%; or between 10-60%; or between 10-50%; or between 10-40%; or between 10-30%; or between 10-20%; or between 20-99%; or between 20-90%; or between 20-80%; or between 20-70%; or between 20-60%; or between 20-50%; or between 20-40%; or between 20-30%; or between 30-99%; or between 30-80%; or between 30-50%; or between 50-99%; or between 50-90%; or between 50-70%; or between 60-99%; or between 60-90%; or between 60-80%; or between 60-70%; or between 70-99%; or between 70-90%; or between 70-80%; or between 80-99%; or between 80-90%; or between 90-99%; or between 90-95%; of the bicarbonate converts to carbonate when the bicarbonate solution is contacted with the alkaline solution, such as, sodium hydroxide in the cathode electrolyte.

With reference to FIGS. 2A, 2B, 3A, 3B, 4A, 4B, 5A, and 5B, in some embodiments, the system is configured for further processing of the cathode electrolyte 202 after the cathode electrolyte is contacted with the bicarbonate solution 205 outside and/or inside the cathode chamber. As illustrated in FIG. 6, the system is configured with a precipitator 603 to precipitate carbonates and/or bicarbonates from the solution using divalent cations, e.g., calcium, magnesium, or combination thereof. In some embodiments, the solution obtained after the contacting of the alkaline solution, such as, the cathode electrolyte with the bicarbonate solution, is subjected to the precipitation conditions in the precipitator. The solution obtained after the contacting of the cathode electrolyte with the bicarbonate solution includes sodium hydroxide and/or sodium carbonate, and/or sodium bicarbonate.

The divalent cations include any solid or solution that contains divalent cations, such as, alkaline earth metal ions or any aqueous medium containing alkaline earth metals. The alkaline earth metals include calcium, magnesium, strontium, barium, etc. or combinations thereof. The divalent cations (e.g., alkaline earth metal cations such as Ca²⁺ and Mg²⁺) may be found in industrial wastes, seawater, brines, hard water, minerals, and many other suitable sources. The alkaline-earth-metal-containing water includes fresh water or saltwater, depending on the method employing the water. In some embodiments, the water employed in the process includes one or more alkaline earth metals, e.g., magnesium, calcium, etc. In some embodiments, the alkaline earth metal ions are present in an amount of 1% to 99% by wt; or 1% to 95% by wt; or 1% to 90% by wt; or 1% to 80% by wt; or 1% to 70% by wt; or 1% to 60% by wt; or 1% to 50% by wt; or 1% to 40% by wt; or 1% to 30% by wt; or 1% to 20% by wt; or 1% to 10% by wt; or 20% to 95% by wt; or 20% to 80% by wt; or 20% to 50% by wt; or 50% to 95% by wt; or 50% to 80% by wt; or 50% to 75% by wt; or 75% to 90% by wt; or 75% to 80% by wt; or 80% to 90% by wt of the solution containing the alkaline earth metal ions. In some embodiments, the alkaline earth metal ions are present in saltwater, such as, seawater. In some embodiments, the source of divalent cations is hard water or naturally occurring hard brines. In some embodiments, calcium rich waters may be combined with magnesium silicate minerals, such as olivine or serpentine.

In some locations, industrial waste streams from various industrial processes provide for convenient sources of cations (as well as in some cases other materials useful in the process, e.g., metal hydroxide). Such waste streams include, but are not limited to, mining wastes; fossil fuel burning ash (e.g., fly ash, bottom ash, boiler slag); slag (e.g., iron slag, phosphorous slag); cement kiln waste (e.g., cement kiln dust); oil refinery/petrochemical refinery waste (e.g., oil field and methane seam brines); coal seam wastes (e.g., gas production brines and coal seam brine); paper processing waste; water softening waste brine (e.g., ion exchange effluent); silicon processing wastes; agricultural waste; metal finishing waste; high pH textile waste; and caustic sludge. In some embodiments, the aqueous solution of cations comprises calcium and/or magnesium in amounts ranging from 10-50,000 ppm; or 10-10,000 ppm; or 10-5,000 ppm; or 10-1,000 ppm; or 10-100 ppm; or 50-50,000 ppm; or 50-10,000 ppm; or 50-1,000 ppm; or 50-100 ppm; or 100-50,000 ppm; or 100-10,000 ppm; or 100-1,000 ppm; or 100-500 ppm; or 1,000-50,000 ppm; or 1,000-10,000 ppm; or 5,000-50,000 ppm; or 5,000-10,000 ppm; or 10,000-50,000 ppm.

Freshwater may be a convenient source of cations (e.g., cations of alkaline earth metals such as Ca²⁺ and Mg²⁺). Any of a number of suitable freshwater sources may be used, including freshwater sources ranging from sources relatively free of minerals to sources relatively rich in minerals. Mineral-rich freshwater sources may be naturally occurring, including any of a number of hard water sources, lakes, or inland seas. Some mineral-rich freshwater sources such as alkaline lakes or inland seas (e.g., Lake Van in Turkey) also provide a source of pH-modifying agents. Mineral-rich freshwater sources may also be anthropogenic. For example, a mineral-poor (soft) water may be contacted with a source of cations such as alkaline earth metal cations (e.g., Ca²⁺, Mg²⁺, etc.) to produce a mineral-rich water that is suitable for methods and systems described herein. Cations or precursors thereof (e.g., salts, minerals) may be added to freshwater (or any other type of water described herein) using any convenient protocol (e.g., addition of solids, suspensions, or solutions). In some embodiments, divalent cations selected from Ca²⁺ and Mg²⁺ are added to freshwater. In some embodiments, freshwater comprising Ca²⁺ is combined with magnesium silicates (e.g., olivine or serpentine), or products or processed forms thereof, yielding a solution comprising calcium and magnesium cations.

In some embodiments, as illustrated in FIGS. 2A, 3A, 4A, and 5A, where the bicarbonate solution is contacted with the cathode electrolyte inside the cathode chamber, the system is configured to treat bicarbonate and/or carbonate ions in the cathode electrolyte with a divalent cation selected from the group consisting of calcium, magnesium, and combination thereof. In some embodiments, bicarbonate and/or carbonate ions in the cathode electrolyte can be treated with the divalent cations inside the cathode chamber where a solution containing the divalent cations is added to the cathode electrolyte after the addition of the bicarbonate solution to the cathode chamber. In some embodiments, bicarbonate and/or carbonate ions in the cathode electrolyte react with the divalent cations inside the cathode chamber when the cathode electrolyte already includes divalent cations, such as seawater. In some embodiments, bicarbonate and/or carbonate ions in the cathode electrolyte can be treated with the divalent cations outside the cathode chamber, e.g. in a precipitator, where the cathode electrolyte containing the hydroxide, bicarbonate and/or carbonate is withdrawn from the cathode chamber and is treated with the divalent cations outside the cathode chamber.

In some embodiments, as illustrated in FIGS. 2B, 3B, 4B, and 5B, where the bicarbonate solution is contacted with the cathode electrolyte outside the cathode chamber, the system is configured to treat bicarbonate and/or carbonate ions in the solution with a divalent cation selected from the group consisting of calcium, magnesium, and combination thereof. In embodiments where the solution is obtained after the contacting of the cathode electrolyte with the bicarbonate solution outside the cathode chamber, the solution is mixed with the divalent cations in a precipitator. In some embodiments, the cathode electrolyte, the bicarbonate solution, and the divalent cations are all mixed in the precipitator outside the cathode chamber to precipitate the carbonate materials.

The precipitator can be a tank or a series of tanks Contact protocols include, but are not limited to, direct contacting protocols, e.g., flowing the bicarbonate solution through the volume of water containing cations, e.g. alkaline earth metal ions and through the volume of cathode electrolyte containing sodium hydroxide; concurrent contacting means, e.g., contact between unidirectionally flowing liquid phase streams; and countercurrent means, e.g., contact between oppositely flowing liquid phase streams, and the like. Thus, contact may be accomplished through use of infusers, bubblers, fluidic Venturi reactor, sparger, gas filter, spray, tray, or packed column reactors, and the like, as may be convenient. In some embodiments, the contact is by spray. In some embodiments, the contact is through packed column. In some embodiments, the bicarbonate solution is added to the source of cations and the cathode electrolyte containing sodium hydroxide. In some embodiments, the source of cations and the cathode electrolyte containing sodium hydroxide is added to the bicarbonate solution. In some embodiments, both the source of cations and the bicarbonate solution are simultaneously added to the cathode electrolyte containing sodium hydroxide in the precipitator for precipitation.

In some embodiments, where the bicarbonate solution has been added to the cathode electrolyte inside the cathode chamber, the withdrawn cathode electrolyte including sodium hydroxide, sodium bicarbonate and/or sodium carbonate is administered to the precipitator for further reaction with the divalent cations. In some embodiments, where the bicarbonate solution and the divalent cations have been added to the cathode electrolyte inside the cathode chamber, the withdrawn cathode electrolyte including sodium hydroxide, calcium carbonate, magnesium carbonate, calcium bicarbonate, magnesium bicarbonate, calcium magnesium carbonate, or combination thereof, is administered to the precipitator for further processing.

The precipitate obtained after the contacting of the bicarbonate solution with the cathode electrolyte and the divalent cations includes calcium carbonate, magnesium carbonate, calcium bicarbonate, magnesium bicarbonate, calcium magnesium carbonate, or combination thereof. In some embodiments, the precipitate may be subjected to one or more of steps including, but not limited to, dewatering, washing of the precipitate, dewatering of the washed precipitate, drying, milling, storing, to make the carbonate composition of the invention.

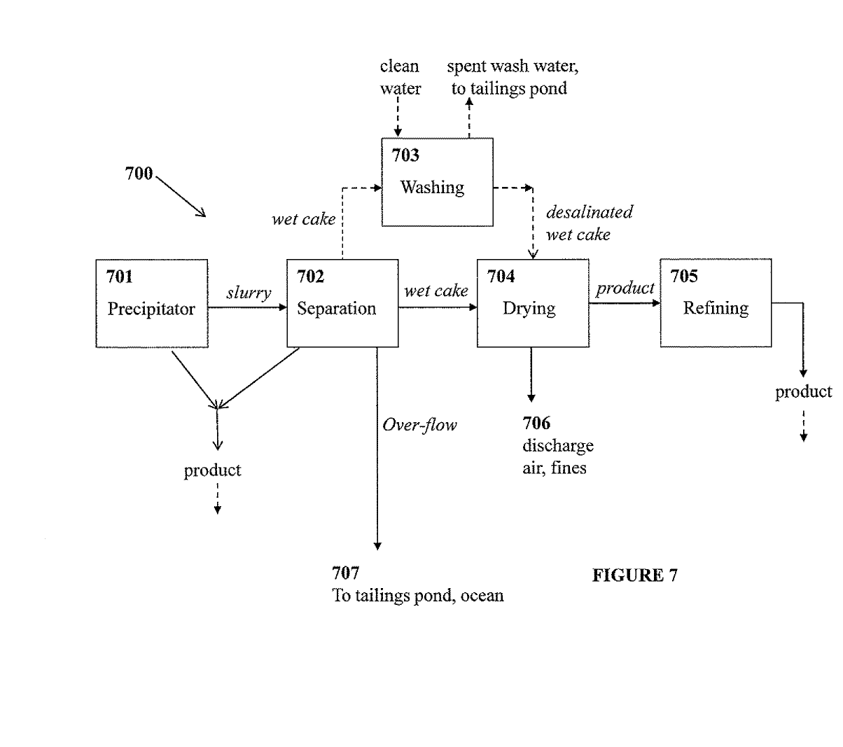

In some embodiments, the processing of the precipitate is as illustrated in FIG. 7. The precipitator containing the solution of calcium carbonate, magnesium carbonate, calcium bicarbonate, magnesium bicarbonate, calcium magnesium carbonate, or combination thereof is subjected to precipitation conditions. At precipitation step, carbonate compounds, which may be amorphous or crystalline, are precipitated. These carbonate compounds may form a reaction product comprising carbonic acid, bicarbonate, carbonate, or mixture thereof. The carbonate precipitate may be the self-cementing composition and may be stored as is in the mother liquor or may be further processed to make the cement products. Alternatively, the precipitate may be subjected to further processing to give the hydraulic cement or the supplementary cementitious materials (SCM) compositions. The self-cementing compositions, hydraulic cements, and SCM have been described in U.S. application Ser. No. 12/857,248, filed 16 Aug. 2010, which is incorporated herein by reference in its entirety.

The one or more conditions or one or more precipitation conditions of interest include those that change the physical environment of the water to produce the desired precipitate product. Such one or more conditions or precipitation conditions include, but are not limited to, one or more of temperature, pH, precipitation, dewatering or separation of the precipitate, drying, milling, and storage. For example, the temperature of the water may be within a suitable range for the precipitation of the desired composition to occur. For example, the temperature of the water may be raised to an amount suitable for precipitation of the desired carbonate compound(s) to occur. In such embodiments, the temperature of the water may be from 5 to 70° C., such as from 20 to 50° C., and including from 25 to 45° C. As such, while a given set of precipitation conditions may have a temperature ranging from 0 to 100° C., the temperature may be raised in certain embodiments to produce the desired precipitate. In certain embodiments, the temperature is raised using energy generated from low or zero carbon dioxide emission sources, e.g., solar energy source, wind energy source, hydroelectric energy source, etc.

The residence time of the precipitate in the precipitator before the precipitate is removed from the solution, may vary. In some embodiments, the residence time of the precipitate in the solution is more than 5 seconds, or between 5 seconds-1 hour, or between 5 seconds-1 minute, or between 5 seconds to 20 seconds, or between 5 seconds to 30 seconds, or between 5 seconds to 40 seconds. Without being limited by any theory, it is contemplated that the residence time of the precipitate may affect the size of the particle. For example, a shorter residence time may give smaller size particles or more disperse particles whereas longer residence time may give agglomerated or larger size particles. In some embodiments, the residence time in the process of the invention may be used to make small size as well as large size particles in a single or multiple batches which may be separated or may remain mixed for later steps of the process.

The nature of the precipitate may also be influenced by selection of appropriate major ion ratios. Major ion ratios may have influence on polymorph formation, such that the carbonate products are metastable forms, such as, but not limited to vaterite, aragonite, amorphous calcium carbonate, or combination thereof. In some embodiments, the carbonate products may also include calcite. Such polymorphic precipitates are described in U.S. application Ser. No. 12/857,248, filed 16 Aug. 2010, which is incorporated herein by reference in its entirety. For example, magnesium may stabilize the vaterite and/or amorphous calcium carbonate in the precipitate. Rate of precipitation may also influence compound polymorphic phase formation and may be controlled in a manner sufficient to produce a desired precipitate product. The most rapid precipitation can be achieved by seeding the solution with a desired polymorphic phase. Without seeding, rapid precipitation can be achieved by rapidly increasing the pH of the sea water. The higher the pH is, the more rapid the precipitation may be.

In some embodiments, a set of conditions to produce the desired precipitate from the water include, but are not limited to, the water's temperature and pH, and in some instances the concentrations of additives and ionic species in the water. Precipitation conditions may also include factors such as mixing rate, forms of agitation such as ultrasonics, and the presence of seed crystals, catalysts, membranes, or substrates. In some embodiments, precipitation conditions include supersaturated conditions, temperature, pH, and/or concentration gradients, or cycling or changing any of these parameters. The protocols employed to prepare carbonate compound precipitates according to the invention may be batch or continuous protocols. It will be appreciated that precipitation conditions may be different to produce a given precipitate in a continuous flow system compared to a batch system.

Following production of the carbonate precipitate from the water, the resultant precipitated carbonate composition may be separated from the mother liquor or dewatered to produce the precipitate product, as illustrated at step 702 of FIG. 7. Alternatively, the precipitate is left as is in the mother liquor or mother suprenate and is used as a cementing composition. Separation of the precipitate can be achieved using any convenient approach, including a mechanical approach, e.g., where bulk excess water is drained from the precipitated, e.g., either by gravity alone or with the addition of vacuum, mechanical pressing, by filtering the precipitate from the mother liquor to produce a filtrate, etc. Separation of bulk water produces a wet, dewatered precipitate. The dewatering station may be any number of dewatering stations connected to each other to dewater the slurry (e.g., parallel, in series, or combination thereof).

The above protocol results in the production of slurry of the precipitate and mother liquor. This precipitate in the mother liquor and/or in the slurry may give the self-cementing composition. In some embodiments, a portion or whole of the dewatered precipitate or the slurry is further processed to make the hydraulic cement or the SCM compositions.

Where desired, the compositions made up of the precipitate and the mother liquor may be stored for a period of time following precipitation and prior to further processing. For example, the composition may be stored for a period of time ranging from 1 to 1000 days or longer, such as 1 to 10 days or longer, at a temperature ranging from 1 to 40° C., such as 20 to 25° C.

The slurry components are then separated. Embodiments may include treatment of the mother liquor, where the mother liquor may or may not be present in the same composition as the product. The resultant mother liquor of the reaction may be disposed of using any convenient protocol. In certain embodiments, it may be sent to a tailings pond for disposal. In certain embodiments, it may be disposed of in a naturally occurring body of water, e.g., ocean, sea, lake or river. In certain embodiments, the mother liquor is returned to the source of feedwater for the methods of invention, e.g., an ocean or sea. Alternatively, the mother liquor may be further processed, e.g., subjected to desalination protocols, as described further in U.S. application Ser. No. 12/163,205, filed Jun. 27, 2008; the disclosure of which is herein incorporated by reference.

The resultant dewatered precipitate is then dried to produce the carbonate composition of the invention, as illustrated at step 704 of FIG. 7. Drying can be achieved by air drying the precipitate. Where the precipitate is air dried, air drying may be at a temperature ranging from −70 to 120° C., as desired. In certain embodiments, drying is achieved by freeze-drying (i.e., lyophilization), where the precipitate is frozen, the surrounding pressure is reduced and enough heat is added to allow the frozen water in the material to sublime directly from the frozen precipitate phase to gas. In yet another embodiment, the precipitate is spray dried to dry the precipitate, where the liquid containing the precipitate is dried by feeding it through a hot gas (such as the gaseous waste stream from the power plant), e.g., where the liquid feed is pumped through an atomizer into a main drying chamber and a hot gas is passed as a co-current or counter-current to the atomizer direction. Depending on the particular drying protocol of the system, the drying station may include a filtration element, freeze drying structure, spray drying structure, etc.

In some embodiments, the step of spray drying may include separation of different sized particles of the precipitate. Where desired, the dewatered precipitate product from 702 may be washed before drying, as illustrated at step 703 of FIG. 7. The precipitate may be washed with freshwater, e.g., to remove salts (such as NaCl) from the dewatered precipitate. Used wash water may be disposed of as convenient, e.g., by disposing of it in a tailings pond, etc. The water used for washing may contain metals, such as, iron, nickel, etc.

As illustrated in FIG. 7, at step 705, the dried precipitate is refined, milled, aged, and/or cured, e.g., to provide for desired physical characteristics, such as particle size, surface area, zeta potential, etc., or to add one or more components to the precipitate, such as admixtures, aggregate, supplementary cementitious materials, etc., to produce the carbonate composition. Refinement may include a variety of different protocols. In certain embodiments, the product is subjected to mechanical refinement, e.g., grinding, in order to obtain a product with desired physical properties, e.g., particle size, etc. The dried precipitate may be milled or ground to obtain a desired particle size.

The cementitous composition, thus formed, has elements or markers that originate from the bicarbonate solution used in the process. The composition after setting, and hardening has a compressive strength of at least 14 MPa; or at least 16 MPa; or at least 18 MPa; or at least 20 MPa; or at least 25 MPa; or at least 30 MPa; or at least 35 MPa; or at least 40 MPa; or at least 45 MPa; or at least 50 MPa; or at least 55 MPa; or at least 60 MPa; or at least 65 MPa; or at least 70 MPa; or at least 75 MPa; or at least 80 MPa; or at least 85 MPa; or at least 90 MPa; or at least 95 MPa; or at least 100 MPa; or from 14-100 MPa; or from 14-80 MPa; or from 14-75 MPa; or from 14-70 MPa; or from 14-65 MPa; or from 14-60 MPa; or from 14-55 MPa; or from 14-50 MPa; or from 14-45 MPa; or from 14-40 MPa; or from 14-35 MPa; or from 14-30 MPa; or from 14-25 MPa; or from 14-20 MPa; or from 14-18 MPa; or from 14-16 MPa; or from 17-35 MPa; or from 17-30 MPa; or from 17-25 MPa; or from 17-20 MPa; or from 17-18 MPa; or from 20-100 MPa; or from 20-90 MPa; or from 20-80 MPa; or from 20-75 MPa; or from 20-70 MPa; or from 20-65 MPa; or from 20-60 MPa; or from 20-55 MPa; or from 20-50 MPa; or from 20-45 MPa; or from 20-40 MPa; or from 20-35 MPa; or from 20-30 MPa; or from 20-25 MPa; or from 30-100 MPa; or from 30-90 MPa; or from 30-80 MPa; or from 30-75 MPa; or from 30-70 MPa; or from 30-65 MPa; or from 30-60 MPa; or from 30-55 MPa; or from 30-50 MPa; or from 30-45 MPa; or from 30-40 MPa; or from 30-35 MPa; or from 40-100 MPa; or from 40-90 MPa; or from 40-80 MPa; or from 40-75 MPa; or from 40-70 MPa; or from 40-65 MPa; or from 40-60 MPa; or from 40-55 MPa; or from 40-50 MPa; or from 40-45 MPa; or from 50-100 MPa; or from 50-90 MPa; or from 50-80 MPa; or from 50-75 MPa; or from 50-70 MPa; or from 50-65 MPa; or from 50-60 MPa; or from 50-55 MPa; or from 60-100 MPa; or from 60-90 MPa; or from 60-80 MPa; or from 60-75 MPa; or from 60-70 MPa; or from 60-65 MPa; or from 70-100 MPa; or from 70-90 MPa; or from 70-80 MPa; or from 70-75 MPa; or from 80-100 MPa; or from 80-90 MPa; or from 80-85 MPa; or from 90-100 MPa; or from 90-95 MPa; or 14 MPa; or 16 MPa; or 18 MPa; or 20 MPa; or 25 MPa; or 30 MPa; or 35 MPa; or 40 MPa; or 45 MPa. For example, in some embodiments of the foregoing aspects and the foregoing embodiments, the composition after setting, and hardening has a compressive strength of 14 MPa to 40 MPa; or 17 MPa to 40 MPa; or 20 MPa to 40 MPa; or 30 MPa to 40 MPa; or 35 MPa to 40 MPa. In some embodiments, the compressive strengths described herein are the compressive strengths after 1 day, or 3 days, or 7 days, or 28 days.

The precipitates, comprising, e.g., calcium and magnesium carbonates and bicarbonates in some embodiments may be utilized as building materials, e.g., as cements and aggregates, as described in commonly assigned U.S. patent application Ser. No. 12/126,776, filed on 23 May 2008, herein incorporated by reference in its entirety.

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### EXAMPLES

### Example 1

In an exemplary embodiment, a system configured substantially as illustrated in FIG. 2A, 2B, 3A, 3B, 4A, 4B, 5A, or 5B is operated with a constant current density applied across the electrodes at steady state conditions while bicarbonate solution is continuously dissolved into the cathode electrolyte, at various temperatures and voltages. In the system, a platinum catalyst, gas diffusion anode obtained from E-TEK Corporation, (USA) is used as the anode. A Raney nickel deposited onto a nickel gauze substrate is used as the cathode. In the system, the initial acid concentration in the anode electrolyte is 1 M; the initial sodium chloride salt solution is 5 M; and the initial concentration of the sodium hydroxide solution in the cathode compartment is 1 M. In the system, the pH of the cathode compartment is maintained at either 8 or 10 by regulating the amount of bicarbonate solution contacted with the cathode electrolyte.

TABLE III
Experimental Current Density, Temperature and Voltage Characteristics
of the System

| | | | Current density |
|---|---|---|---|
| T (° C.) | Potential (V) | pH | (mA/cm²) |
| 25 | 0.8 | 10 | 8.6 |
| | | 8 | 11.2 |
| | 1.2 | 10 | 28.3 |
| | | 8 | 29.2 |
| | 1.6 | 10 | 50.2 |
| | | 8 | 50.6 |
| 75 | 0.8 | 10 | 13.3 |
| | | 8 | 17.8 |
| | 1.2 | 10 | 45.3 |
| | | 8 | 49.8 |
| | 1.6 | 10 | 80.8 |
| | | 8 | 84.7 |

As is illustrated in Table III, a range of current densities is achieved across the electrode in the system. As can be appreciated, the current density that can be achieved with other configurations of the system may vary, depending on several factors including the cumulative electrical resistance losses in the cell, environmental test conditions, the over-potential associated with the anodic and cathodic reactions, and other factors.

The current densities achieved in the present configuration and as set forth in Table III are correlated with the production of hydroxide ions at the cathode, and thus are correlated with the production of sodium hydroxide and/or sodium carbonate and/or sodium bicarbonate in the cathode electrolyte, as follows. With reference to Table III, at 75° C., 0.8 V and a pH of 10, each cm² of electrode passes 13.3 mA of current, where current is a measure of charge passed (Coulomb) per time (second). Based on Faraday's Laws, the amount of product, e.g., hydroxide ions, produced at an electrode is proportional to the total electrical charge passed through the electrode as follows:

n=(I*t)/(F*z)

where n is moles of product, I is a current, t is time, F is Faraday's constant, and z is the electrons transferred per product ionic species (or reagent ionic species). Thus, based on the present example, 1.38×10⁻⁴ moles of hydroxide ions are produced per second per cm² of electrode, which is correlated with the production of sodium hydroxide in the cathode electrolyte. In the system, the production rate of NaOH dictates the production rate of NaHCO₃ and Na₂CO₃ through Le Chatelier's principle following the net chemical equilibria equations of

HCO₃⁻+OH⁻═H₂O+CO₃²⁻,

where an increase in concentration of one species in equilibria will change the concentration of all species so that the equilibrium product maintains the equilibrium constant.

In the system, as illustrated in FIGS. 2A, 2B, 3A, 3B, 4A, 4B, 5A, and 5B, the voltage across the cathode and the anode is dependent on several factors including the pH difference between the anode electrolyte and cathode electrolyte. Thus, in some embodiments the system can be configured to operate at a specified pH and voltage; react bicarbonate solution with the sodium hydroxide in the cathode electrolyte; and produce carbonate ions in the cathode electrolyte. In these embodiments the pH of the cathode electrolyte solution may decrease, remain the same, or increase, depending on the rate of removal of protons compared to rate of introduction of the bicarbonate solution.

The carbonate ion containing solution is recovered from the cathode electrolyte and is reacted with divalent cations to result in the carbonate composition of the invention. The carbonate composition is processed as described herein to result in the cementitious compositions of the invention which are further used to form formed building materials, aggregates, and concrete.

What is claimed is:

1. A method comprising:
contacting an anode with an anode electrolyte,
contacting a cathode with a cathode electrolyte,
deriving a bicarbonate solution from one or more of natural substances;
contacting the bicarbonate solution with the cathode electrolyte, and
applying a voltage across the anode and the cathode.

2. The method of claim 1, wherein the one or more of natural substances is selected from the group consisting of naturally occurring brines including subterranean, subsurface and surface brines, crystalline shoreline or bottom crusts, shallow lake bottom crusts, surface efflorescence, minerals, solutions obtained after the mining of the ores, evaporite, and lakes.

3. The method of claim 1, wherein the subterranean brine is selected from the group consisting of bicarbonate brine, carbonate brine, alkaline brine, and combination thereof.

4. The method of claim 1, wherein the bicarbonate solution is derived from an evaporite comprising bicarbonate, carbonate, or combination thereof.

5. The method of claim 1, wherein the bicarbonate solution is derived by contacting carbon dioxide with a carbonate brine.

6. The method of claim 5, wherein the carbonate brine comprises trona brine.

7. The method of claim 1, wherein the bicarbonate solution is derived by dissolving carbon dioxide into an alkaline brine.

8. The method of claim 1, wherein the bicarbonate solution is derived by dissolving carbon dioxide in one or more of natural substances wherein the carbon dioxide is an industrial waste stream comprising flue gas from combustion; a flue gas from a chemical processing plant; a flue gas from a plant that produces CO₂ as a byproduct; or combination thereof.

9. The method of claim 1, wherein the bicarbonate solution is derived from a naturally occurring bicarbonate brine.

10. The method of claim 1, further comprising producing hydroxide ions in the cathode electrolyte and hydrochloric acid or sulfuric acid in the anode electrolyte on applying the voltage across the anode and the cathode.

11. The method of claim 10, wherein the method produces carbonate ions by contacting the bicarbonate solution with the hydroxide in the cathode electrolyte.

12. The method of claim 1, further comprising producing a pH difference of between 4-12 pH units between the anode electrolyte and the cathode electrolyte when a voltage of 0.05-1V is applied between the anode and the cathode.

13. The method of claim 11, further comprising treating bicarbonate and/or carbonate ions with a divalent cation selected from the group consisting of calcium, magnesium, and combination thereof to form a cementitious material.

14. A system comprising:
an electrochemical system comprising an anode electrolyte in contact with an anode and a cathode electrolyte in contact with a cathode;
a reactor system configured to produce a bicarbonate solution from one or more of natural substances wherein the one or more of natural substances is selected from the group consisting of naturally occurring brines including subterranean, subsurface and surface brines, crystalline shoreline or bottom crusts, shallow lake bottom crusts, surface efflorescence, minerals, solutions obtained after the mining of the ores, evaporite, and lakes; and
a contact system operably connected to the cathode electrolyte of the electrochemical system and configured to contact the bicarbonate solution from the reactor system with the cathode electrolyte.

15. The system of claim 14, wherein the electrochemical system is configured to produce hydroxide ions and hydrogen gas in the cathode electrolyte and an acid in the anode electrolyte on applying a voltage across the anode and the cathode.

16. The system of claim 15, wherein the cathode electrolyte and the anode electrolyte are separated by an ion exchange membrane and the electrochemical system is configured to direct hydrogen gas from the cathode to the anode.

17. The system of claim 14, wherein the system is configured to produce carbonate ions by a reaction of the bicarbonate ions from the bicarbonate solution with sodium hydroxide from the cathode electrolyte.

18. The system of claim 14, further comprising a precipitator operably connected to the contact system configured to produce a carbonate or a combination of the carbonate and bicarbonate product from the bicarbonate solution.

19. The system of claim 18, wherein the carbonate product is a cementitious composition.

20. The system of claim 14, wherein the anode is a gas diffusion electrode.
